(19) United States
(12) Patent Application Publication
(10) Pub. No.: US 2012/0269774 A1
(43) Pub. Date: Oct. 25, 2012

(54) ALLOGENEIC STEM CELL TRANSPLANTS IN NON-CONDITIONED RECIPIENTS

(75) Inventors: Thomas E. Ichim, San Diego, CA (US); Neil H. Riordan, Chandler, AZ (US)

(73) Assignee: MEDISTEM LABORATORIES, INC, Tempe, AZ (US)

(21) Appl. No.: 12/442,356

(22) PCT Filed: Sep. 20, 2007
(86) PCT No.: PCT/US07/20415

§ 371 Date: Nov. 17, 2009

Related U.S. Application Data
(60) Provisional application No. 60/826,509, filed on Sep. 21, 2006.

(51) Int. Cl. A01N 63/00

(52) U.S. Cl. 424/93.7

(57) ABSTRACT

Methods, cells, and compositions of matter are disclosed for performing stem cell transplants in patients that have not been previously immunosuppressed. Specific disclosed are methods of matching, methods of treating the stem cell graft, and use of engraftment-assisting cells and agents.

### CROSS-REFERENCE TO RELATED APPLICATIONS

This application claims priority under 35 U.S.C. §119 to U.S. Provisional Application Ser. No. 60/826,509 filed Sep. 21, 2006, the entirety of which is hereby incorporated by reference.

### FIELD OF THE INVENTION

The present invention pertains to the area of stem cell therapy and immunology. Particularly the invention relates to practical implementation of allogeneic stem cell therapies with recipient conditioning. More specifically, the invention relates to methods of donor stem cell selection, engineering of the stem cell graft and methods of administering the stem cell graft.

### BACKGROUND OF THE INVENTION

Stem cell transplants are a promising methodology for treatment of not only degenerative diseases, but also for systemic rejuvenation and life extension. One of the main drawbacks of stem cell therapy has been identifying sources of stem cells that not only possess activity to regenerate various organs, but also are available in sufficient numbers. Conceptually stem cell therapy with autologous cells is preferred clinically since such cells theoretically are both accepted by the recipient, as well as do not cause graft versus host disease (GVHD). Unfortunately, autologous stem cells are limited in number, lose proliferative activity with age and degenerative conditions (1-4), and despite common belief, in some cases actually can cause graft versus host (5, 6).

Allotransplantation of stem cells has been suggested as a means of overcoming numerous drawbacks of autologous transplantation. Allogeneic cells offer the possibility of an “off the shelf” cellular product that can be used for all patient populations, as well as the ability conceptually to have an unlimited number of stem cells for use. On particular type of allotransplantation of stem cells involves the use of umbilical cord blood. Cord blood has been used successfully as an alternative stem cell source to marrow, particularly in pediatric patients with hematopoietic malignancies, bone marrow failure, or inborn errors of metabolism, and currently expanding to adults. Cord blood was known since the 1930s to be useful as a substitute for peripheral blood in transfusions (7). This may have been what prompted the original report of using cord blood as a clinical source of hematopoietic stem cells occurred in 1972 in a paper describing a pediatric acute lymphoblastic leukemia patient under 6-mercaptopurine and prednisone therapy (8). Although the treatment did not substantially affect clinical outcome, engraftment was demonstrated for 38 days by differentiation based on erythrocyte markers. Supporting the notion that cord blood may be a useful source of stem cells were laboratory reports identifying high concentration of colony forming cells within this population in vitro in the 1970s and 1980s (9, 10). The first successful use of cord blood transplants was in 1989 by Gluckman et al (11) who used sibling cord blood to treat a 5-year old patient with Fanconi anemia who at last report was still in good health 18 years later (12). After this initial success cord blood transplantation rapidly became one of the treatments of choice for pediatric patients lacking sibling donors. The limitation of stem cell number in cord blood units is overcome in pediatric patients due to lower body mass. Accordingly, more than approximately 7000-8000 transplants have been performed (13) (14), with the general consensus being that in comparison to bone marrow, cord blood possesses several unique advantages and disadvantages. The advantages include less stringent matching requirements, lower graft versus host disease, and lower risk of contamination. The disadvantages include delayed kinetics of engraftment, limited supply of stem cells, and lack of ability to perform donor-lymphocyte infusions (15).

The first widespread utilization of cord blood, and the area where it originally grew as an accepted methodology was in the treatment of hematological malignancies. Current day cord blood transplants involve administration of cord blood mononuclear cells at approximately 1.5-2.5×10⁷ cells per kilogram into patients having undergone either myeloablative conditioning, or non-myeloablative conditioning. Matching requirements are not as strict as in bone marrow or peripheral blood stem cell transplants. Typically a 4/6 HLA loci match is clinically acceptable. Typical protocols for neutralizing host hematopoiesis include components such as total body irradiation (TBI), cyclophosphamide, busulfan, etoposide, other chemotherapeutics, and/or anti-thymocyte globulin. Protocols that are non-myeloablative seek to eradicate host lymphocytes through administration of anti-thymocyte globulin/TBI/busulfan/fludarabine. Although sometimes similar agents that are used for myeloablation are also used for non-myeloablative conditioning, these agents are used at a lower concentration or reduced frequency of administration. The rationale of non-myeloablative conditioning is to allow for graft-versus-tumor effect to occur, without subjecting patient to severe physiological stress of complete myeloablation (16, 17).

In adults there have been numerous reports and publications regarding myeloablative conditioning followed by cord blood transplantation for malignancy (18-23). Herein are disclosed 2 well-cited studies that strongly supported this approach as an alternative to patients lacking an HLA matched sibling donor. The first study was by the Acute Leukemia Working Party of European Blood and Marrow Transplant Group. This study assessed outcomes of 682 patients with acute leukemia that were recipients of stem cells from unrelated donors. Of these patients, 98 had received cord blood and 584 received bone marrow transplants. Bone marrow was HLA-matched at 6/6 loci, whereas cord blood was mismatched up to 4/6 loci. Multivariate analysis revealed that cord blood recipients had a lower risk of grade II-IV GVHD. Transplant related mortality, relapse, and leukemia-free survival were similar between patients receiving cord blood. Neutrophil engraftment was significantly delayed in the group receiving cord blood. These findings led to the conclusion that unrelated cord blood transplant can be performed in patients with acute leukemia that do not have an HLA-matched bone marrow donor (24). The second study compared leukemia patients that received cord blood grafts mismatched for one or two HLA loci, with patients who received bone marrow matched at 6 loci, and with patients who received bone marrow but were mismatched at 1 loci. Of the patients who received mismatched bone marrow and mismatched cord blood there was no difference in mortality associated with transplant, nor in leukemic relapse. The authors of the study, members of the International Bone Marrow Transplant Registry, concluded, similarly to the previous study cited, that HLA-mismatched (up to 4/6 loci) cord blood transplant should be recommended as an alternative to adult patients lacking a HLA-matched adult donor (25).

### I

Non-myeloablative transplantation is also used in some situations for treatment of malignant disease. Despite the name, non-myeloablative, this procedure still causes significant immune deficiency in patients since ablation of the lymphatic system occurs. The rationale for using non-myeloablative condition is that graft versus tumor effect is preserved so the need for complete destruction of host hematopoiesis is minimized. Another possible advantage of non-myeloablative conditioning in terms of malignancy is the enhanced ability of T cells to reconstitute the host due to preservation of peripheral T cell niches (26). This may theoretically allow for an enhance graft versus tumor effect. In a typical study, 13 patients (median age 49) suffering from various advanced hematological malignancies were transplanted with partially matched cord blood with a median nucleated cell dose of 2.07×10(7)/kg following non-myeloablative conditioning. 8 of the patients converted to donor chimerism between 4 weeks to 24 weeks. Median survival was 288 days after transplant (27). Another representative study 20 patients with advanced malignant lymphoma were conditioned with low dose fludarabine, melphalan and TBI prior to infusion with an average of 2.75×10(7)/kg cord blood cells matched at 4/6 and 5/6 HLA loci. Neutrophil engraftment occurred in 15 of the patients at an average of 20 days. 10 patients achieved complete response and estimated 1-year probability of progression-free survival was 50% (28). These and numerous other studies demonstrate that although delayed in engraftment in comparison to allogeneic bone marrow transplants, cord blood is a suitable alternative for an easily accessible stem cells source for allotransplantation in patients with malignancy (29, 30).

Overall, the main obstacle to cord blood transplantation in general, and particularly after myeloablative conditioning regimens is the low number of donor cells that are available in the graft. Approximately, the number of CD34+ cells in a unit of cord blood is ten-fold less than obtained during a bone marrow graft (15, 31). It is known from several trials that the lower number of CD34+ cells in the cord blood graft correlates with extended time until hematopoietic recovery (32-34). Accordingly a variety of attempts have been made to enhance the stem cell content of cord blood grafts using ex vivo expansion. A Phase I study using the proprietary Aastrom Replicell system which includes culture in media supplemented with fetal bovine serum, horse serum, PIXY321, flt-3 ligand, and erythropoietin, demonstrated feasibility of achieving a median 2.4 expansion in overall nucleated cells, a 82 fold expansion in CFU-GM, and a 0.5 fold expansion in lineage negative CD34+ cells. Patients were administered the cells 12 days post cord blood transplant as a “booster”. No serious adverse events associated with administration of expanded cells were observed. Unfortunately the small patient number did not permit significant analysis of efficacy (35). Other attempts to increase the number of cord blood cells included administration of 2 units from different donors (36), administration of third party mobilized peripheral blood stem cells (37), as well as administration of third party mesenchymal stem cells (38).

Since cord blood is more readily available as compared to bone marrow, its use for treatment of non-malignant conditions requiring rapid intervention has been pursued. This use of cord blood can range from need to reconstitute the immune system with cells that are immunocompetent, to the need to deliver a functional enzyme to patients who are deficient in the enzyme, to use of cord blood for repair certain tissues. One example of cord blood transplantation for treatment of an abnormal immune system is a report on 8 children suffering from a variety of T cell immunodeficiencies including severe combined immunodeficiency syndrome (SCID), reticular dysgenesis, thymic dysplasia, combined immunodeficiency disease, and Wiskott-Aldrich syndrome. Following a myeloablative conditioning regimen, administration of 3/6 (2 children), 4/6 (4 children), and 5/6 (2 children) HLA mismatched cord blood was performed. Engraftment occurred in all but one patient (average time to neutrophil engraftment was 12 days). In the patient that did not engraft, a second cord blood transplant was performed and successful donor hematopoiesis was observed. Based on clinical benefit observed in the patients and similar GVHD profile to bone marrow transplantation, the authors concluded that unrelated umbilical donor cord blood is a suitable alternative source of stem cells for children with severe T-cell immune deficiency disorders that lack a suitable HLA-matched bone marrow donor (39). A similar report evaluated 12 patients who received unrelated cord blood 7×10(7) cells/kg for primary immunodeficiency. All patients engrafted with average time to neutrophil reconstitution being 22 days. 11 patients had full donor T and six full donor B-cell chimerism with normal IgG levels and specific antibody responses to tetanus and hepatitis B vaccines 1 year after transplant (40). In terms of bone marrow failure diseases, such as aplastic anemia, in a recently published report, 9 patients (average age 25.3) were subjected to unrelated cord blood transplants. Conditioning was performed in a non-myeloablative manner with cyclophosphamide and antithymocyte globulin. Successful hematopoietic engraftment was found in seven patients. At 32.2 month follow up (range: 4-69), the patients that engrafted were alive and disease free (41).

Besides immune disorders, numerous deficiencies in stem cell function can be corrected by introduction of functional cells. For example, beta-thalassemia, is a hematopoietic disorder characterized by mutation in the beta hemoglobin gene, which in the homozygous state (thalassemia major) leading to severe anemia and transfusion dependence. 5 pediatric patients with this condition received unrelated, 1 or 2 HLA mismatched cord blood grafts at an average of 8.8×10(7) cells/kg. Preconditioning was performed with busulfan, cyclophosphamide, and antithymocyte globulin. Times to neutrophil engraftment, red blood cell transfusion independence, and platelet engraftment were 12, 34, and 46 days after transplantation, respectively. At the average follow up time of 303 days after transplantation, complete donor chimerism and lack of need for transfusion was observed in all patients (42).

Congenital metabolic disorders are another area in which cord blood has been successfully used. For example, Krabbe Disease is a neurodegenerative disorder that causes death before the age of 2, in part by breakdown of myelin sheaths due to a deficiency in activity of the enzyme lysosomal hydrolase galactosylceramide beta-galactosidase (GALC). This enzyme is normally responsible for degradation of galactosylceramide and psychosine. Accumulation of both sphingolipids sets off a series of biological cascades culminating in demylination and nervous system dysfunction. Due to the hematopoietic derivation of microglia, which normally express the GALG enzyme, Escolar et al hypothesized that administration of cord blood into pediatric patients with Krabbe Disease would result in neurological improvements. The investigators treated a total of 25 patients with Krabbe Disease: 11 were asymptomatic and younger (12 to 44 days-old) and 14 were symptomatic and older (142 to 352 days old). Following myeloablative conditioning and unrelated cord blood transplantation, the asymptomatic population had 100% engraftment and 100% survival at median follow up of 3 years. Furthermore, the same population demonstrated progressive central myelination and approximately normalized gain in developmental skills. In contrast, although the population that was treated during the symptomatic phase also achieved 100% donor engraftment, minimal neurological improvement was observed and survival was only 43% at average follow-up of 3.4 years (43). The importance of this study is the demonstration that cord blood can be used as a type of cellular “gene therapy” that systemically enters the patient circulation and normalizes cellular function in the area of need. It is important to point out that ablation of the defective microglia cells most likely did not occur in the patients since these cells are long-lived and resistant to usual myeloablative protocols. Accordingly the dominance of the “healing” capacity of cord blood over the enzymatically defective wild-type cells is an interesting point to consider in light of other studies of regeneration.

### II

Numerous investigations have been performed demonstrating that stem cells found in cord blood can differentiate into a variety of tissues. For example, using a variety of chemical agents and modification of culture conditions, it was demonstrated that cord blood mesenchymal cells, as well as freshly purified cells can be differentiated into cardiomyocyte-like cells which were capable of beating in culture (44, 45). The ability of bone marrow derived cells to differentiate into cardiomyocytes has been well established that the cells within cord blood that differentiate into cardiomyocytes are of a similar phenotype to the ones in bone marrow (46, 47). In bone marrow derived cardiomyocyte experiments electromagnetic coupling and appropriate gap junction formation with cultured, freshly explanted cardiomyocytes was demonstrated (48). Furthermore it has been demonstrated that contacting bone marrow derived mesenchymal cells with cardiomyocytes induces differentiation into cardiomyocytes (49). In contrast to in vivo experiments which suggest a positive effect of bone marrow stem cells in heart disease models, some in vitro evidence suggests that bone marrow derived cardiomyocytes may be proarrhythmic (50). It remains to be seen whether cardiomyocytes derived from cord blood have similar properties, since to date, to the authors' knowledge, no side-by-side comparison has been made between bone marrow and cord blood in terms of cardiomyocyte differentiation.

The naturally residing stem cells in the liver, called “oval cells” express hematopoietic stem cell markers such as CD34 and c-kit, and can be repopulated in vivo by bone marrow derived cells, supports the notion that populations within cord blood may be capable of differentiating into hepatocytes (51). Accordingly, investigators have demonstrated that growth factors such as HGF alone, or in combination with FGF-4 are capable of inducing in vitro generation of albumin-secreting hepatic-like cells (52-54). In some experiments, it was demonstrated an enhanced rate of hepatic differentiation from cord blood can be induced by mimicking injury in an in vitro system (55). The differentiation from cord blood cell to hepatocyte-like cell is believed to occur in some systems by the cells passing through a mesenchymal state prior to differentiation (56).

Numerous studies have also demonstrated differentiation of cord blood cells into various neuronal lineages (57-62). Whether it is actually stem cells that differentiate into neurons, or other cellular intermediaries exist remains to be completely answered. Some studies suggest that, as in hepatic differentiation, cord blood cells pass through a mesenchymal phase before becoming neurons (63), whereas other studies actually describe a monocytic-like intermediary (64). It is believed that induction of differentiation can be accomplished by exposure to the local neuronal microenvironment, even in the adult brain (65). Accordingly, these studies support the notion that cord blood cells may be useful for treatment of neurodegenerative diseases.

Numerous animal models have been performed to assess the potential of cord blood transplantation for treatment of degenerative diseases. Provided herewith is an overview of some of these studies to provide a sample of the wide array of potential uses that cord blood may have when it is actually translated into a clinical approach.

Numerous genetic and acquired diseases exist in which regeneration of muscle is desired. Particularly relevant are conditions such as Duchenne Muscular Dystrophy in which one essential gene is defective causing muscular degeneration and premature death (patients rarely live beyond 30). While gene therapy would be theoretically useful, practical clinical implementation has yet to occur. An alternative treatment would be supplementing the diseased individual with stem cells containing the appropriate gene. This was originally investigated using bone marrow stem cells. It is known that bone marrow stem cells are capable of differentiating into a wide variety of muscle like cells. For example, bone marrow transplant with wild-type murine donors into a mouse model of muscular degneration (laminin-alpha2-deficient (dy) mice) is capable of extending lifespan and enhancing growth rate, muscle strength, and respiratory function as compared to controls (66). Similarly, in the mouse model of muscular dystrophy, bone marrow transplantation from wild-type donors results in mdx+ cells migrating and having beneficial function on injured muscles (67). Accordingly, the use of cord blood transplantation was assessed in the dysferlin-deficient mouse, which is a model of muscle degenerative diseases limb girdle muscular dystrophy type 2B form and Miyoshi myopathy. Systemic administration of human cord blood nucleated cells, or cord blood CD34+, lineage-negative cells under the cover of immune suppression lead to stable integration of human dysferlin positive cells into muscle. The authors did not comment on therapeutic effect, but suggested that increasing the number of cells trafficking to the muscle may be a useful therapy for development (68). Another study investigated the effect of direct intramuscular administration of nucleated human cord blood cells into immune competent mice directly into injured muscles. The authors demonstrated incorporation of the human cells into regenerating muscle (69). Unfortunately neither of the two studies demonstrated therapeutic benefit.

In contrast to the relatively early stages of stem cell research for muscular disorders, utilization of stem cells for myocardial infarction is much more advanced. Patients with myocardial infarction are usually treated with stenting and thrombolytic agents, however the death of existing myocytes, the formation of scar tissue, and pathological remodeling causes the majority of post-infarct patients to develop congestive heart failure. The rationale for stem cell therapy in the post-infarct situation is to supply cells capable of taking over the function of the cells that have died, and/or to increase local perfusion so as to allow cardiomyocytes that are hibernating to become functional. Bone marrow stem cells have demonstrated ability to reduce pathology left ventricular remodeling and restore left ventricular ejection fraction (LVEF) in numerous clinical studies (70-72). It is believed that, at least in part, the CD34+ fraction of bone marrow is responsible for this effect, since even CD34+ cells from peripheral blood are also beneficial to post-infarct cardiac function (73). Given the high content of CD34 cells in cord blood, as well as various cells with cardiomyocyte potential residing therein, numerous studies have investigated the use of cord blood in animal models of infarction. For example, Hirata et al demonstrated that systemic administration of 2×10(5) human cord blood CD34(+) cells into Wistar rats suffering from myocardial infarction lead to improvement of LVEF. Microscopic analysis demonstrated engraftment of human cells in the myocardial architecture (74). Utility of CD133 cells derived from cord blood for myocardial regeneration post infarct. Administration of 1.2-2×10(6) CD133+ cells 7 days post infarct in athymic rats lead to improvement in LV contractility by 42% in treated animals, whereas controls had a decrease in contractility of 39+/−10% at 30 days post infarct. Additionally, pathological ventricular remodeling as defined by decrease in thickness of the anterior wall was observed only in the control animals (75). In order to deal with the low number of cells attainable from cord blood, experiments were performed to investigate the possibility of expanding endothelial progenitors ex vivo and using them for post infarct repair. Culturing of cord blood in endothelium differentiation media allowed up to 40-fold expansion of cell number. These cells were capable of preserving LVEF in an animal model of infarction (76). Using a large animal model, administration of 10(8) cultured unrestricted somatic stem cells (USCC) from human cord blood was performed in pigs with artificially occluded left anterior descending 4 weeks after occlusion. Improved regional perfusion, wall motion and LVEF was observed in comparison to controls at 4 weeks post cell administration (77). These and other animal models experiments (78-82) support the potential of cord blood cells for myocardial infarction, administered systemically, or locally.

Stroke is a significant cause of morbidity and mortality being the third cause of death and disability in the United States. Although rehabilitation procedures exist and are clinically implemented, no medical intervention as been approved as of yet. One therapeutic concept is administration of growth factors to either directly stimulate neurogenesis, or to increase perfusion and thereby allow neuronal populations to exit state of cell cycle arrest. This approach was assessed by systemic administration of the growth factor FGF-2. Although some patients demonstrated improvement in the acute stroke setting, the adverse effects, including hypotension associated with this intervention lead to halting of the Phase III trial (83, 84). Other approaches have included stereotactic administration of neurons derived from the human teratocarcinoma cell line NT-2. It was reported that some patients had increased metabolic activity at the grafted site, however therapeutic results were not significant (85, 86). Given the ability of cord blood cells to secrete numerous neurotrophic factors (87), as well as to directly differentiate into a variety of neurons (88), the use of such cells in animal models of stroke was performed by numerous groups with demonstration of efficacy. For widespread clinical utilization, stereotactic implantation of cells is very difficult. Accordingly a study was performed using the established middle cerebral artery occlusion (MCAO) rat model of stroke, comparing intravenous versus intrastriatal implantation of human cord blood cells under the cover of cyclosporin immune suppression. In contrast to non-transplanted animals, rats receiving cord blood either through the intravenous or intrastriatal route performed significantly better at task learning by the passive avoidance test, as well as overall behavioral recovery. In the step test, significant improvement was observed only in animals having received cells through the intravenous route. This study demonstrated the feasibility of systemic cord blood administration for treatment of stroke (89). In order to determine whether cord blood administration induces a dose-dependent neurological recovery, the same group administered 10(4) up to 3 to 5×10(7) human cord blood cells into rats subjected to MCAO. The authors observed a dose-dependent recovery in behavioral performance as well as an inverse relationship between HUCBC dose and infarct size (90). Using a similar MCAO model, it was reported that an umbilical cord population expressing the embryonic markers Oct-4, Rex-1, and Sox-2, but not hematopoietic markers was able to significantly inhibit behavioral defects (91). Although the neuroprotective/neuroregenerative effects of cord blood cells are well established by numerous other experiments (92-96), the mechanisms of this effect is still being debated. For example, it was demonstrated that angiogenesis plays a critical role in cord blood mediated protection from stroke in a study demonstrating that treatment with angiogenic inhibitors can block beneficial effects of cell administration (97). Such indirect and/or paracrine effects are also supported by observations that it is not necessary of the transplanted cells to enter the brain to mediate beneficial effects (98).

In addition to the areas of muscular degeneration, cardiac infarction, and stroke, cord blood stem cells have demonstrated therapeutic efficacy in numerous other animal models such as enzymatic deficiencies (99, 100), autoimmune diabetes (101, 102), liver pathologies (103-108), and even cancer (109). Given these powerful preclinical observations, as well as the known multitude of stem cell activities found in cord blood, it only is natural that regenerative applications (besides in the area of hematopoiesis) would be pursued. As of yet there is one Phase I trial being performed in patients with type I diabetes involving infusion of autologous cord blood cells for restoration of islet function, however the trial is ongoing and no data have been published (110). One of the major limitations that is impeding regenerative application of cord blood transplants is the fact that in contrast to bone marrow, peripheral blood, or adipose derived stem cells, most patients do not have autologous cord blood available. This makes it necessary to use allogeneic, HLA matched cord blood. The current dogma is that in absence of immune suppression, administration of an HLA-matched cord blood graft into a non-immune suppressed host will result in rapid clearance of infused cells without therapeutic benefit. The current invention demonstrates that this notion is incorrect and provides methods of making available stem cell transplantation in general, and cord blood transplantation specifically, for regenerative uses without the need for major host preconditioning that would normally preclude patients from having access to this technology. In order to begin this part of the discussion, this discussion will start by first overviewing the basic immunology of cord blood.

Mesenchymal stem cells are classically defined as cells that are adherent to plastic and found in the non-hematopoietic CD34-, CD45-, HLA-DR-fraction of bone marrow (111), adipose tissue (112), placenta (113, 114), scalp tissue (115) and cord blood (45). Various markers have been described on mesenchymal stem cells including CD13, CD29, CD44, CD90, CD105, SH-3, and STRO-1 (116). Mesenchymal stem cells from cord blood have demonstrated the ability to differentiate into a wide variety of tissues in vitro including neuronal (63, 117, 118), hepatic (53, 119), osteoblastic (120), and cardiac (45). Bone marrow derived mesenchymal stem cells are currently in various clinical trials, most notably a Phase III trial by Osiris Therapeutics, who is using a “universal donor” cell for patients suffering from advanced GVHD (121). Since mesenchymal stem cells are known to possess the ability to home to the bone marrow and assist engraftment of hematopoietic stem cells (122), as well as possessing numerous trophic activity that supports hematopoiesis both in vitro and in vivo (123), mesenchymal stem cells are currently used experimentally to enhance bone marrow engraftment clinically (124). An important aspect of mesenchymal stem cells is their anti-inflammatory and immunomodulatory activity. These cells constitutively secrete immune inhibitory factors such as IL-10 and TGF-β while maintaining ability to present antigens to T cells (125, 126). This is believed to further allow inhibition of immunity in an antigen specific manner, as well as to allow the use of such cells in an allogeneic fashion without fear of immune-mediated rejection.

Honmou et al in U.S. Pat. No. 7,098,027 teach the use of autologous bone marrow and cord blood cells for remyelinating a patient in need thereof. However the invention is only related to autologous transplants.

U.S. Pat. No. 6,428,782 to Slavin et al describes a method of inducing donor-specific tolerance in a host. Tolerogenic treatments of the present invention may be administered to a host prior to transplantation of donor-derived materials. The tolerogenic treatment involves (1) administering an immunosuppressive agent to a host mammal in a non-myeloablative regimen sufficient to decrease, but not necessarily to eliminate, the host mammal's functional T lymphocyte population; (2) infusing donor antigens from a non-syngeneic donor into the host mammal; (3) eliminating those host T lymphocytes responding to the infused donor antigens using a non-myeloablative dose of lymphocytotoxic or tolerizing agent; and (4) administering donor hematopoietic cells to the host mammal. Donor lymphoid cells used for cell therapy of a host mammal can be depleted of host specific immunological reactivity by methods essentially similar to those used for tolerizing a host mammal prior to transplantation. This approach, however, requires the use of host conditioning. Furthermore the invention does not describe regenerative uses of the tolerated graft, only hematopoietic uses.

Ildstad in U.S. Patent Application No. 20060018885 teaches methods of enhancing engraftment of allogeneic bone marrow grafts through co-incubating prior to administration a pharmaceutical composition that stimulates TNF-alpha expression and a cellular composition comprising human hematopoietic stem cells and “facilitator cells” that have a CD8+ TCR+ or CD8+ TCR-phenotype. The use of cord blood is not described in this application. Nor are therapeutic immune modulatory aspects of the graft itself described.

Komanduri et al in U.S. Patent Application No. 2006/0057122 teach methods of depleting cellular grafts of alloreactive populations based on removal of cells expressing a combination of activation-associated T cell markers such as CD25, CD38, and CD52. These markers are upregulated on cells bearing alloreactive potential subsequent to stimulation with recipient cells. This method of depleting alloreactive cells does not decrease immunogeneicity of the graft itself, and furthermore requires ex vivo culture, which is not practically available on a large scale.

Young in U.S. Patent Application No. 2005/0026854 disclosed agents capable of destruction of CD52+ cells, including CD52+ dendritic cells, without affecting CD52 negative cells.

From the general review of the literature above, it is apparent that stem cells in general, and specifically cord blood derived stem cells possess numerous properties making them attractive for treatment of diseases. Unfortunately, to date, application of stem cells is limited by the fact that no readily available sources exist that can be implemented with ease. Although allogeneic stem cells are promising, the need for recipient preconditioning, as well as fear of graft versus host disease have limited their application.

### SUMMARY OF THE INVENTION

It is within the scope of the current invention to provide a means of transplanting allogeneic stem cells without the need for preconditioning of the host. The current invention teaches that in stark contrast to current dogma, if proper matching of stem cells is performed with the recipient, allogeneic transplantation can be performed with therapeutic benefits. The invention teaches that therapeutic benefits derived from allogeneic cells that survive in the recipient, said therapeutic benefits may come directly from stem cells that have “selected for” by the immunological pressures of the recipient immune system. Alternatively therapeutic benefit may be derived, under some circumstances, from the interaction between the allogeneic cells found in the stem cell inoculum and the immune cells of the recipient.

Given the unique regenerative capabilities of cord blood, the easy accessibility of HLA matched donors, and relative inexpensiveness as compared to other cellular therapies; it is of great interest therapeutically to expand its use into non-conditioned recipients. Another attractive feature of cord blood is that for regenerative activities administration can be systemic since in various models of tissue destruction, local administration does not significantly alter efficacy as compared to systemic (89, 127). One simple method of stem cell therapy would be administration of cord blood units in patients with degenerative diseases in the form of direct transfusions has described by Bhattacharya (128). Unfortunately, this approach has not demonstrated clinical benefits in terms of regeneration. Accordingly, the current invention provides methods for using cord blood, and other stem cell sources in an allogeneic manner, without the need for host preconditioning, through appropriate manipulation of the stem cell source, and/or matching and/or coadministration of agents and other cells. For example, in one aspect, administration of cord blood cells in combination with stem cell activators, localized chemoattractant agents, or activators of endogenous stem cells is performed to yield therapeutic benefit. Clinically used agents such as thalidomide (129), valproic acid (130), or 5-azacytidine (131, 132) all have demonstrated ability to induce proliferation of CD34+ stem cells in vitro and/or in vivo. These agents are useful in the practice of the current invention.

In one aspect of the invention, chemoattractant agents may be administered at a site in need of repair, followed by systemic administration of cord blood stem cells. Chemoattractant agents could include stromal derived growth factor-1 (133), other various agonists of CXCR-4 (134), or hepatocyte growth factor (135).

An alternative aspect of the invention is administration of stem cells at the narrow window period after tissue injury when endogenous chemoattractants are secreted by the injured tissue. For example, following myocardial infarction, as well as stroke, there is a period of time which concentration of local stem cell chemoattractants are so high that bone marrow derived progenitors are mobilized (136). Activators of endogenous stem cells may also be administered in the context of the current invention to allow localized tissue repair, while exogenous stem cells are administered to provide support to the activated endogenous cells. On example of clinically used stem cell activators are erythropoietin and human chorionic gonadotropin, which are currently in clinical trials for stroke (137).

In accordance with the above, presented herein is a method of allogeneic stem cell therapy without preconditioning of the recipient, the therapy comprising: a) matching a patient with a stem cell source; b) manipulating the stem cell source; and c) administering the stem cell source.

Also presented herein is a method of treating a disease by allogeneic stem cell therapy without preconditioning of the recipient, the therapy comprising: a) matching a patient with a stem cell source; b) manipulating the stem cell source; and c) administering the stem cell source. The disease can be selected from a group consisting of: neurological, gastrointestinal, dermatological, urological, respiratory, and cardiac diseases. The neurological disease can be selected from a group consisting of: autism, Asperger syndrome, acute stroke, chronic stroke, transient ischemic episodes, Rett syndrome, autism spectrum disorder, childhood disintegrative disorder, amyotrophic lateral sclerosis, Huntington's disease, Parkinson's disease, Alzheimer's disease, bipolar disorder, depression, disruptive behavior disorder, dyslexia, fragile X syndrome, learning disabilities, obsessive-compulsive disorder, oppositional defiant disorder, pervasive developmental disorder, reactive attachment disorder, Rett syndrome, separation anxiety disorder, Tourette's syndrome, Lewy Body dementia, AIDS dementia, mild cognitive impairments, age-associated memory impairments, cognitive impairments and/or dementia associated with neurologic and/or psychiatric conditions, including epilepsy, brain tumors, brain lesions, multiple sclerosis, Down's syndrome, progressive supranuclear palsy, frontal lobe syndrome, and schizophrenia and related psychiatric disorders, cognitive impairments caused by traumatic brain injury, post coronary artery by-pass graft surgery, electroconvulsive shock therapy, and chemotherapy; and to novel methods for treating and preventing delirium, myasthenia gravis, dyslexia, mania, depression, apathy, myopathy associated with diabetes, Juvenile Huntington's Disease, also known as the Westphal variant, cerebral palsy, Spinocerebellar ataxia, Sensory ataxia, and Friedreich's ataxia

Also presented herein is a method of treating an inflammatory disease by allogeneic stem cell therapy without preconditioning of the recipient, the therapy comprising: a) matching a patient with a stem cell source; b) manipulating the stem cell source; and c) administering the stem cell source. The inflammatory disease can be selected from a group consisting of: asthma (including allergen-induced asthmatic reactions), cystic fibrosis, bronchitis (including chronic bronchitis), chronic obstructive pulmonary disease (COPD), adult respiratory distress syndrome (ARDS), chronic pulmonary inflammation, rhinitis and upper respiratory tract inflammatory disorders (URID), ventilator induced lung injury, silicosis, pulmonary sarcoidosis, idiopathic pulmonary fibrosis, bronchopulmonary dysplasia, arthritis, e.g. rheumatoid arthritis, osteoarthritis, infectious arthritis, psoriatic arthritis, traumatic arthritis, rubella arthritis, Reiter's syndrome, valve diseases, tuberous sclerosis, scleroderma, obesity, metabolic disturbances associated with obesity, transplantation rejection, osteoarthritis, rheumatoid arthritis, neoplasm; adenocarcinoma, lymphoma, uterus cancer, fertility, glomerulonephritis, hemophilia, hypercoagulation, idiopathic thrombocytopenic purpura, graft versus host disease, AIDS, bronchial asthma, lupus, multiple sclerosis, gouty arthritis and prosthetic joint failure, gout, acute synovitis, spondylitis and non-articular inflammatory conditions, e.g. herniated/ruptured/prolapsed intervertebral disk syndrome, bursitis, tendonitis, tenosynovitic, fibromyalgic syndrome and other inflammatory conditions associated with ligamentous sprain and regional musculoskeletal strain, inflammatory disorders of the gastrointestinal tract, e.g. ulcerative colitis, diverticulitis, cardiomyopathy, atherosclerosis, stenosis, vascular calcification, fibrosis, pulmonary stenosis, subaortic stenosis, Crohn's disease; inflammatory bowel disease, ulcerative colitis, multiple sclerosis, treatment of Albright Hereditary, infectious disease, anorexia, cancer-associated cachexia, cancer, Crohn's disease, inflammatory bowel diseases, irritable bowel syndrome and gastritis, multiple sclerosis, systemic lupus erythematosus, scleroderma, autoimmune exocrinopathy, autoimmune encephalomyelitis, diabetes, tumor angiogenesis and metastasis, cancer including carcinoma of the breast, colon, rectum, lung, kidney, ovary, stomach, uterus, pancreas, liver, oral, laryngeal and prosiate, meianoma, acute and chronic leukemia, periodontal disease, neurodegenerative disease, Alzheimer's disease, Parkinson's disease, epilepsy, muscle degeneration, inguinal hernia, retinal degeneration, diabetic retinopathy, macular degeneration, ocular inflammation, bone resorption diseases, osteoporosis, osteopetrosis, graft vs. host reaction, allograft rejections, sepsis, endotoxemia, toxic shock syndrome, tuberculosis, usual interstitial and cryptogenic organizing pneumonia, bacterial meningitis, systemic cachexia, cachexia secondary to infection or malignancy, cachexia secondary to acquired immune deficiency syndrome (AIDS), malaria, leprosy, leishmaniasis, Lyme disease, glomerulonephritis, glomerulosclerosis, renal fibrosis, liver fibrosis, pancreatitis, hepatitis, endometriosis, pain, e.g. that associated with inflammation and/or trauma, inflammatory diseases of the skin, e.g. dermatitis, dermatosis, skin ulcers, psoriasis, eczema, systemic vasculitis, vascular dementia, thrombosis, atherosclerosis, restenosis, reperfusion injury, plaque calcification, myocarditis, aneurysm, stroke, pulmonary hypertension, left ventricular remodeling and heart failure.

Also presented herein is a method of treating a disease using allogeneic stem cell therapy without preconditioning of the recipient, the therapy comprising: a) selecting a patient that has not been preconditioned; and b) administering a stem cell source.

In one aspect of the invention the cells can be selected from a group comprising of stem cells, committed progenitor cells, and differentiated cells. In a further aspect, the stem cells can be selected from a group consisting of: embryonic stem cells, cord blood stem cells, placental stem cells, bone marrow stem cells, amniotic fluid stem cells, neuronal stem cells, circulating peripheral blood stem cells, mesenchymal stem cells, germinal stem cells, adipose tissue derived stem cells, exfoliated teeth derived stem cells, hair follicle stem cells, dermal stem cells, parthenogenically derived stem cells, reprogrammed stem cells and side population stem cells. In a particular aspect, the allogeneic stem cell therapy consists of cord blood. Selection of cells to be used in the practice of the invention can be performed based on a number of relevant factors to the clinical utilization, including patient characteristics, and availability of the cells for administration.

One aspect of the invention involves administration of totipotent embryonic stem cells, the totipotent embryonic stem cells express one or more antigens selected from a group consisting of stage-specific embryonic antigens (SSEA) 3, SSEA 4, Tra-1-60 and Tra-1-81, Oct-3/4, Cripto, gastrin-releasing peptide (GRP) receptor, podocalyxin-like protein (PODXL), Rex-1, GCTM-2, Nanog, and human telomerase reverse transcriptase (hTERT).

In a certain aspect, the cord blood stem cells can be multipotent and capable of differentiating into endothelial, muscle, and neuronal cells. In one aspect, patients can be treated with a therapeutically effective amount of cord blood stem cells, the cord blood stem cells may be identified by expression of markers selected from a group comprising: SSEA-3, SSEA-4, CD9, CD34, c-kit, OCT-4, Nanog, CD133 and CXCR-4, and lack of expression of markers selected from a group consisting of: CD3, CD45, and CD11b. In certain aspects, the cord blood stem cells can be unrestricted somatic stem cells. In some aspects of the invention cord blood cells are used without purification by subset.

In another aspect of the invention, patients are treated with a therapeutically effective amount of placental stem cells, the stem cells may be identified based on expression of one or more antigens selected from a group comprising: Oct-4, Rex-1, CD9, CD13, CD29, CD44, CD166, CD90, CD105, SH-3, SH-4, TRA-1-60, TRA-1-81, SSEA-4 and Sox-2. In some aspects of the invention placental stem cells are used without purification by subset.

In another aspect of the invention, patients are treated with a therapeutically effective amount of bone marrow stem cells; the bone marrow stem cells comprised of bone marrow derived mononuclear cells. The bone marrow stem cells may also be selected based upon ability to differentiate into one or more of the following cell types: endothelial cells, muscle cells, and neuronal cells. The bone marrow stem cells may also be selected based on expression of one or more of the following antigens: CD34, c-kit, flk-1, Stro-1, CD105, CD73, CD31, CD146, vascular endothelial-cadherin, CD133 and CXCR-4. In one particular aspect, the bone marrow stem cells are selectively enriched for mononuclear cells expressing the protein marker CD 133.

In another aspect of the invention, patients are treated with a therapeutically effective amount of amniotic fluid stem cells, wherein the amniotic fluid stem cells are isolated by introduction of a fluid extraction means into the amniotic cavity under ultrasound guidance. The amniotic fluid stem cells may be selected based on expression of one or more of the following antigens: SSEA3, SSEA4, Tra-1-60, Tra-1-81, Tra-2-54, HLA class I, CD13, CD44, CD49b, CD105, Oct-4, Rex-1, DAZL and Runx-1 and lack of expression of one or more of the following antigens: CD34, CD45, and HLA Class II.

In another aspect of the invention, patients are treated with a therapeutically effective amount of neuronal stem cells that are selected based on expression of one or more of the following antigens: RC-2, 3CB2, BLB, Sox-2hh, GLAST, Pax 6, nestin, Muashi-1, NCAM, A2B5 and prominin.

In another aspect of the invention, patients are treated with a therapeutically effective amount of peripheral blood derived stem cells. The peripheral blood derived stem cells may be characterized by expression of one or more markers selected from a group comprising of CD34, CXCR4, CD 117, CD 113, and c-met, and in some cases by ability to proliferate in vitro for a period of over 3 months. In some situations peripheral blood stem cells are purified based on lack of expression of differentiation associated markers, the markers selected from a group comprising of CD2, CD3, CD4, CD11, CD11a, Mac-1, CD14, CD16, CD19, CD24, CD33, CD36, CD38, CD45, CD56, CD64, CD68, CD86, CD66b, and HLA-DR.

In another aspect of the invention, patients are treated with a therapeutically effective amount of mesenchymal stem cells, the cells may be defined by expression of one or more of the following markers: STRO-1, CD105, CD54, CD106, HLA-I markers, vimentin, ASMA, collagen-1, fibronectin, LFA-3, ICAM-1, PECAM-1, P-selectin, L-selectin, CD49b/CD29, CD49c/CD29, CD49d/CD29, CD61, CD18, CD29, thrombomodulin, telomerase, CD10, CD13, STRO-2, VCAM-1, CD146, and THY-1, and in some situations lack of substantial levels of one or more of the following markers: HLA-DR, CD 117, and CD45. In some aspects the mesenchymal stem cells are derived from a group selected of: bone marrow, adipose tissue, umbilical cord blood, placental tissue, peripheral blood mononuclear cells, differentiated embryonic stem cells, and differentiated progenitor cells.

In another aspect of the invention, patients are treated with a therapeutically effective amount of germinal stem cells, wherein the germinal stem cells may express markers selected from a group consisting of: Oct4, Nanog, Dppa5 Rbm, cyclin A2, Tex18, Stra8, Daz1, beta 1- and alpha6-integrins, Vasa, Fragilis, Nobox, c-Kit, Sca-1 and Rex1.

In another aspect of the invention, patients are treated with a therapeutically effective amount of adipose tissue derived stem cells, wherein the adipose tissue derived stem cells may express markers selected from a group consisting of: CD13, CD29, CD44, CD63, CD73, CD90, CD166, Aldehyde dehydrogenase (ALDH), and ABCG2. In an alternative aspect adipose tissue derived stem cells derived as mononuclear cells extracted from adipose tissue that are capable of proliferating in culture for more than 1 month.

In another aspect of the invention, patients are treated with a therapeutically effective amount of exfoliated teeth derived stem cells, wherein the exfoliated teeth derived stem cells may express markers selected from a group consisting of STRO-1, CD 146 (MUC18), alkaline phosphatase, MEPE, and bFGF.

In another aspect of the invention, patients are treated with a therapeutically effective amount of hair follicle stem cells, wherein the hair follicle stem cells may express markers selected from a group consisting of: cytokeratin 15, Nanog, and Oct-4, in some aspects, the hair follicle stem cells are chosen based on capable of proliferating in culture for a period of at least one month. In other aspects, the hair follicle stem cell can be selected based on ability to secrete one or more of the following proteins when grown in culture: basic fibroblast growth factor (bFGF), endothelin-1 (ET-1) and stem cell factor (SCF).

In another aspect of the invention, patients are treated with a therapeutically effective amount of dermal stem cells, wherein the dermal stem cells express markers selected from a group consisting of: CD44, CD13, CD29, CD90, and CD105. In some aspects, the dermal stem cells are chosen based on ability of proliferating in culture for a period of at least one month.

In another aspect of the invention, are treated with a therapeutically effective amount parthenogenically derived stem cells, wherein the parthenogenically derived stem cells are generated by addition of a calcium flux inducing agent to activate an oocyte followed by enrichment of cells expressing markers selected from a group comprising of SSEA-4, TRA 1-60 and TRA 1-81.

In another aspect of the invention, patients are treated with a therapeutically effective amount of stem cells generated by reprogramming, the reprogramming being induced, for example, by nuclear transfer, cytoplasmic transfer, or cells treated with a DNA methyltransferase inhibitor, cells treated with a histone deacetylase inhibitor, cells treated with a GSK-3 inhibitor, cells induced to dedifferentiate by alteration of extracellular conditions, and cells treated with various combination of the mentioned treatment conditions. In certain aspects, the nuclear transfer comprises introducing nuclear material to a cell substantially enucleated, the nuclear material deriving from a host whose genetic profile is sought to be dedifferentiated. In certain aspects the cytoplasmic transfer comprises introducing cytoplasm of a cell with a dedifferentiated phenotype into a cell with a differentiated phenotype, such that the cell with a differentiated phenotype substantially reverts to a dedifferentiated phenotype. In certain aspects, the DNA demethylating agent can be selected from a group consisting of: 5-azacytidine, psammaplin A, and zebularine. The histone deacetylase inhibitor can be selected from a group consisting of: valproic acid, trichostatin-A, trapoxin A and depsipeptide.

In another aspect of the invention, patients are treated with a therapeutically effective amount of side population cells, wherein the cells are identified based on expression multidrug resistance transport protein (ABCG2) or ability to efflux intracellular dyes such as rhodamine-123 and or Hoechst 33342. The side population cells may be derived from tissues such as pancreatic tissue, liver tissue, muscle tissue, striated muscle tissue, cardiac muscle tissue, bone tissue, bone marrow tissue, bone spongy tissue, cartilage tissue, liver tissue, pancreas tissue, pancreatic ductal tissue, spleen tissue, thymus tissue, Peyer's patch tissue, lymph nodes tissue, thyroid tissue, epidermis tissue, dermis tissue, subcutaneous tissue, heart tissue, lung tissue, vascular tissue, endothelial tissue, blood cells, bladder tissue, kidney tissue, digestive tract tissue, esophagus tissue, stomach tissue, small intestine tissue, large intestine tissue, adipose tissue, uterus tissue, eye tissue, lung tissue, testicular tissue, ovarian tissue, prostate tissue, connective tissue, endocrine tissue, and mesentery tissue.

In a certain embodiment where committed progenitor cells are administered, the committed progenitor cells can be selected from a group consisting of: endothelial progenitor cells, neuronal progenitor cells, and hematopoietic progenitor cells. The committed endothelial progenitor cells can be purified from the bone marrow or peripheral blood, for example. In certain aspects, the committed endothelial progenitor cells are purified from peripheral blood of a patient whose committed endothelial progenitor cells are mobilized by administration of a mobilizing agent or therapy. In certain aspects, the mobilizing agent can be selected from a group consisting of: G-CSF, M-CSF, GM-CSF, 5-FU, IL-1, IL-3, kit-L, VEGF, Flt-3 ligand, PDGF, EGF, FGF-1, FGF-2, TPO, IL-11, IGF-1, MGDF, NGF, HMG CoA) reductase inhibitors and small molecule antagonists of SDF-1. In certain aspects, the mobilization therapy can be selected from a group consisting of: exercise, hyperbaric oxygen, autohemotherapy by ex vivo ozonation of peripheral blood, and induction of SDF-1 secretion in an anatomical area outside of the bone marrow. In certain aspects, the endothelial progenitor cells express markers selected from a group consisting of CD31, CD34, AC133, CD146 and flk1.

In certain aspects, the committed hematopoietic cells can be purified from the bone marrow or from peripheral blood. In certain aspects, the committed hematopoietic progenitor cells are purified from peripheral blood of a patient whose committed hematopoietic progenitor cells are mobilized by administration of a mobilizing agent or therapy. In certain aspects the mobilizing agent can be selected from a group consisting of: G-CSF, M-CSF, GM-CSF, 5-FU, IL-1, IL-3, kit-L, VEGF, Flt-3 ligand, PDGF, EGF, FGF-1, FGF-2, TPO, IL-11, IGF-1, MGDF, NGF, HMG CoA) reductase inhibitors and small molecule antagonists of SDF-1. In certain aspects, the mobilization therapy can be selected from a group consisting of exercise, hyperbaric oxygen, autohemotherapy by ex vivo ozonation of peripheral blood, and induction of SDF-1 secretion in an anatomical area outside of the bone marrow. In selected aspects, the mobilization therapy can be induction of SDF-1 secretion in an anatomical area outside of the bone marrow. In certain aspects, the committed hematopoietic progenitor cells express the marker CD133 and/or CD34.

In one aspect of the invention, matching of the stem cell source can be performed by assessment of the HLA disparity between the stem cells and the recipient. In certain aspects, transplantation of stem cells is performed only if the stem cell graft matches at 4 out of 6 HLA loci for HLA-A, HLA-B, and HLA-DRB 1.

In one aspect of the invention, matching of the stem cell source can be performed by coculture of the stem cells with immune cells of the recipient, wherein the stem cells that do not stimulate a significant immunological reaction from immune cells of recipient origin are chosen for transplantation. The recipient immune cells can be selected from a group consisting of: a) unseparated blood, b) peripheral blood mononuclear cells, c) T cells, d) B cells, e) NK cells, f) gamma delta T cells, and g) NKT cells. Coculture of the cells of the recipient performed for a period of time sufficient to stimulate immune reactivity in vitro in response to the stem cells of the stem cell source.

In one aspect of the invention, matching of the stem cell source can be based upon the immunological reaction of recipient immune cells as assessed by methods selected from a group consisting of: a) morphological changes; b) alternation in metabolism; c) alteration in surface marker expression; d) stimulation of proliferation; e) induction of cytotoxic activity; f) alteration of migration; g) alteration in cytokine production; and h) rosetting.

In one aspect of the invention, increase in immune reactivity of greater than 10% of the parameter assessed, as compared to control, can be considered significant so as to not allow the stem cell source to be used for transplantation into the patient whose immune cells mediated the immune reactivity.

In one aspect of the invention immune reactivity can be assessed by production of interferon gamma by lymphocytes of a recipient in response to culture with a stem cell source that is considered for transplantation.

In one aspect of the invention immune reactivity can be assessed by production of IL-2 by lymphocytes of a recipient in response to culture with a stem cell source that is considered for transplantation.

In one aspect of the invention immune reactivity can be assessed by production of TNF by lymphocytes of a recipient in response to culture with a stem cell source that is considered for transplantation.

In certain aspects, the cells are matched for both immunological parameters as well as HLA matched.

In one aspect of the invention immune reactivity can be assessed by proliferation of lymphocytes of a recipient in response to culture with a stem cell source that is considered for transplantation.

In one aspect of the invention, the stem cell source can be manipulated in order decrease potential for graft versus host disease.

In one aspect of the invention, the stem cell source can be depleted of T cells.

In one aspect of the invention, the stem cell source can be depleted of T cells with potential to cause graft versus host disease.

In one aspect of the invention, the stem cell source can be depleted of T cells through negative selection.

In one aspect of the invention, the negative selection can be performed by binding a first agent to the T cells and second agent to an immobilized substrate, whereby the first and the second agent have affinity towards each other, causing binding of the T cells to the immobilized surface wherein the first binding agent can be a protein capable of binding a marker on the T cells and the second agent can be a protein capable of binding the first agent and the substrate and wherein first binding agent can be selected from a group of monoclonal antibodies that recognize markers found on T cells.

In one aspect of the invention markers found on T cells that are useful for negative selection are chosen from a group consisting of: CD2, CD3, CD4, CD5, CD6, CD7, CD8, CD9, CD25, CD26, CD27, CD28, CD31, CD38, CD45, CD49a, CD52, CD55, CD56, CD58, CD66, CD69, CD70, CD71, CD74, CD80, CD82, CD86, CD87, CD90, CD94, CD95, CD96, CD97, CD100, CD101, CD109, CD121a, CD122, CD124, CD126, CD127, CDw128a, CD132, CD134, CD137, CD152, CD153, CD154, CD157, CD160, CD161, CD162, CD166, CD173, CD174, CD178, CD183, CD200, CDw210, CD212, CD213a1, CD223, CD227, CD229, ICOS, Thy-1, PD-1, and PD-2.

In one aspect of the invention the T cells are depleted by rosetting with agents capable of binding T cells.

In one aspect of the invention the T cells are depleted using antibody and complement, wherein the antibodies used for depletion bind with substantial affinity to epitopes of markers selected from a group consisting of: CD2, CD3, CD4, CD5, CD6, CD7, CD8, CD9, CD25, CD26, CD27, CD28, CD31, CD38, CD45, CD49a, CD52, CD55, CD56, CD58, CD66, CD69, CD70, CD71, CD74, CD80, CD82, CD86, CD87, CD90, CD94, CD95, CD96, CD97, CD100, CD101, CD109, CD121a, CD122, CD124, CD126, CD127, CDw128a, CD132, CD134, CD137, CD152, CD153, CD154, CD157, CD160, CD161, CD162, CD166, CD173, CD174, CD178, CD183, CD200, CDw210, CD212, CD213a1, CD223, CD227, CD229, ICOS, Thy-1, PD-1, and PD-2.

In one aspect of the invention the T cells are depleted by the addition of CAMPATH to the stem cells together with a composition containing complement under conditions sufficient for stimulation of complement mediated lysis.

In one aspect of the invention the T cells are depleted by means of coincubation with an immunotoxin, the immunotoxin capable of binding epitopes of markers selected from a group consisting of CD2, CD3, CD4, CD5, CD6, CD7, CD8, CD9, CD25, CD26, CD27, CD28, CD31, CD38, CD45, CD49a, CD52, CD55, CD56, CD58, CD66, CD69, CD70, CD71, CD74, CD80, CD82, CD86, CD87, CD90, CD94, CD95, CD96, CD97, CD100, CD101, CD109, CD121a, CD122, CD124, CD126, CD127, CDw128a, CD132, CD134, CD137, CD152, CD153, CD154, CD157, CD160, CD161, CD162, CD166, CD173, CD174, CD178, CD183, CD200, CDw210, CD212, CD213a1, CD223, CD227, CD229, ICOS, Thy-1, PD-1, and PD-2.

In one aspect of the invention the stem cell source can be depleted of immunogenic cells. In certain aspects, the immunogenic cells express markers capable of eliciting immune reactivity from allogeneic immune cells.

In one aspect of the invention the markers of immunogeneic cells can be selected from a group consisting of: HLA molecules, HLA-like molecules, CD80, CD86, OX-40 ligand, ICAM-1, and LFA-3.

In one aspect of the invention the immunogenic cells that are depleted are chosen from a group consisting of T cells, B cells, monocytes, macrophages, and dendritic cells.

In one aspect of the invention depletion of B cells, and/or monocytes, and/or macrophages, and/or dendritic cells can be performed using a method selected from: a) rosetting with beads capable of binding B cells and/or monocytes, and/or macrophages, and/or dendritic cells; b) complement mediated depletion through the use of a single or plurality of antibodies that bind B cells and/or monocytes, and/or macrophages, and/or dendritic cells and activate the complement cascade sufficiently to cause inactivation of cells; c) negative selection; and d) treatment with immunotoxins specific to B cells and/or monocytes, and/or macrophages, and/or dendritic cells.

In one aspect of the invention, the stem cell source can be treated with chemicals that deplete the antigen presenting cell concentration.

In one aspect of the invention, the stem cell source can be treated by alterations in oxygen concentration in order to selectively deplete the antigen presenting cell concentration.

In one aspect of the invention the stem cells source can be manipulated by positively selecting cells with regenerative and immune modulatory potential, while not selecting cells containing immunogenic and/or graft versus host inducing populations.

In one aspect of the invention the stem cell source can be treated with agents or conditions that decrease overall immunogenicity of the stem cell source wherein the agents can be selected from a group consisting of proteins, small molecules, and nucleic acids.

In one aspect of the invention the stem cell source can be treated with proteins that can be selected from a group consisting of: a) TGF-β; b) IL-4; c) IL-10; d) IL-13; e) IL-20; and f) M-CSF.

In one aspect of the invention the stem cell source can be treated with small molecules that are specific inhibitors of intracellular signal transduction pathways known to be involved in immunogenicity wherein the intracellular signal transduction pathways can be selected from a group consisting of: a) NF-kappa B; b) MyD88; c) IRAK; d) TRAF-6; and e) protein kinase C zeta.

In one aspect of the invention the stem cell source can be treated with nucleic acids can be selected from a group consisting of: a) antisense oligonucleotides; b) short interfering RNA; and c) hairpin short interfering RNA wherein the nucleic acids are designed to inhibit expression of immune stimulatory molecules from the stem cells.

In one aspect of the invention the stem cell source can be manipulated by treatment with conditions that selectively expand tolerogenic cells within the stem cell source wherein the tolerogenic cells within the stem cell source can be selected from a group comprising: a) mesenchymal stem cells; b) alternatively activated macrophages; c) dendritic cells with tolerogenic activities; d) B cell cells expressing CD5+ and/or the B1 phenotype; e) NKT cells; 0 gamma delta T cells; g) FoxP3 expressing T cells; and h) cells with veto activity. The conditions include treatment with proteins selected from a group consisting of a) TGF-β; b) IL-4; c) IL-10; d) IL-13; e) IL-20; and f) M-CSF.

In one aspect of the invention the stem cell source can be manipulated by addition of a population of cells capable of suppressing immunogenicity and graft versus host ability of the stem cells.

In one aspect of the invention the stem cell source can be administered to the matched recipient as a heterogeneous cellular population.

In one aspect of the invention the stem cell source can be administered to the matched recipient as a substantially homogeneous cellular population.

In one aspect of the invention the stem cell source can be administered together with an expanded population of cells derived from the same stem cell source, the population of cells possessing tolerogenic properties.

In one aspect of the invention the stem cell source can be administered together with an expanded population of cells derived from a different stem cell source, but matched according to HLA profile or immunogenic profile with the recipient, the population of cells possessing tolerogenic properties, wherein the tolerogenic cell population can be a population of cells capable of inhibiting immune responses. In certain aspects, the tolerogenic cell population can be selected from a single or plurality of cells from a group consisting of: a) mesenchymal stem cells; b) alternatively activated macrophages; c) dendritic cells with tolerogenic activities; d) B cell cells expressing CD5+ and/or the B1 phenotype; e) NKT cells; f) gamma delta T cells; g) FoxP3 expressing T cells; and h) cells with veto activity.

In one aspect of the invention tolerogenic cell population comprises of cells that have been endowed with tolerogenic potential through ex vivo manipulation. The cells are administered in combination with the stem cell source. The ex vivo manipulation consists of exposing cells outside of the body to agents that can be selected from a group consisting of proteins, small molecules, and nucleic acids. The proteins can be selected from a group consisting of a) TGF-β; b) IL-4; c) IL-10; d) IL-13; e) IL-20; and f) M-CSF. The small molecules are specific inhibitors of intracellular signal transduction pathways known to be involved in immunogenicity. The intracellular signal transduction pathways can be selected from a group consisting of: a) NF-kappa B; b) MyD88; c) IRAK; d) TRAF-6; and e) protein kinase C zeta. The nucleic acids can be selected from a group consisting of a) antisense oligonucleotides; b) short interfering RNA; and c) hairpin short interfering RNA. The nucleic acids are designed to inhibit expression of immune stimulatory molecules from the stem cells.

In one aspect of the invention the stem cell source can be administered in combination with one or more agents capable of increasing stem cell activity in vivo. The agents can be selected from a group comprising of stem cell factor, flt-3L, M-CSF, G-CSF, GM-CSF, erythropoietin thrombopoietin (TPO), stem cell factor (SCF), IL-1, IL-3, IL-7, FGF-1, FGF-2, FGF-4, FGF-20, IGF, EGF, NGF, LIF, PDGF, bone morphogenic proteins (BMP), activin-A, and VEGF.

In one aspect of the invention the stem cell source can be administered in combination with a locally applied agent, the agent possessing chemoattractant properties for stem cells. The agent possessing chemoattractant properties for stem cells can be selected from a group consisting of: SDF-1, VEGF, RANTES, ENA-78, platelet derived factors, various isoforms thereof and small molecule agonists of VEGFR-1, VEGFR2, and CXCR4.

In one aspect of the invention the stem cell source can be administered at a time when endogenously produced stem cell chemoattractant agents are increased in a patient suffering from a pathology. The stem cell chemoattractant can be assessed in peripheral circulation in the patient, the stem cell source can be administered based on concentration of the stem cell chemoattractant. In one aspect of the invention wherein the chemoattractant can be assessed using a biological assay. The biological assay can consist of administering a circulating fluid or a derivative thereof to a population of stem cells in vitro in a manner such that factors from the circulating fluid or derivatives thereof form a chemotactic gradient and stem cells are observed for responsiveness to the chemotactic gradient. The stem cell responses to the chemotactic gradient can be selected from a group consisting of: a) chemotactic movement; b) activation of intracellular signaling pathways; c) alteration in morphology; d) proliferation; e) alteration in gene expression; and f) alteration in protein translation.

In one aspect of the invention the chemoattractant can be assessed using an assay that detects proteins associated with stem cell chemoattractant activity. In one aspect of the invention the assay that detects proteins can be selected from a group consisting of: a) Enzyme linked immunosorbent assay; b) mass spectrometry; c) Western blot; and d) Proteomics based assay. In one aspect of the invention the proteins can be selected from a group consisting of: SDF-1, VEGF, RANTES, ENA-78, and platelet derived factors. In certain aspects, an ELISA can be performed for detection of circulating SDF-1. In certain aspects, increased concentrations of SDF-1 as compared to a healthy volunteer are considered a useful marker for determination of need of stem cell therapy.

In certain aspects of the above embodiments, exosomes derived from the stem cell source or a source matched either by HLA or mixed lymphocyte reaction matching are administered into recipient of stem cells in order to allow for immunological tolerance of the recipient to the stem cell source.

In certain aspects of the above embodiments, an allogeneic stem cell source can be administered without manipulation to a recipient that can be matched either by HLA or mixed lymphocyte reaction.

In certain aspects of the above embodiments, the stem cells are administered by a parenteral route.

In certain aspects of the above embodiments, the stem cells are administered from a route selected from a group consisting of: intravenously, intraarterially, intramuscularly, subcutaneously, transdermally, intratracheally, intraperitoneally or into spinal fluid.

In certain aspects of the above embodiments, the stem cells are administered in or proximal to a site of injury.

Also presented herein is a method of modifying a stem cell source so that the stem cell source that does not match a recipient by mixed lymphocyte reaction matching is made to match the recipient through either deimmunization of the stem cell source by depletion of immunogenic components, or by augmentation of tolerogenic components of the stem cell source.

Also presented herein is a method of treating a mother with a stem cell source either derived from an offspring of the mother, or offspring-matched cells to the mother, so as to replenish the activity of the naturally residing population of fetally derived stem cells that reside in the mother.

In certain aspects of the above embodiments, the disease treated by stem cell therapy is defective wound healing. In certain aspects, the wound is surgically induced.

In certain aspects of the above embodiments, the disease treated by stem cell therapy is damage to non-malignant tissue of a cancer patient treated with a treatment selected from a group consisting of: a) chemotherapy; b) radiotherapy; and c) immunotherapy.

Also presented herein is use of a stem cell graft, in an allogeneic setting, subsequent to matching for the purposes of enhancing immune response of a patient to cancer. In certain aspects, the matching is performed as described above.

Also presented herein is use for the manufacture of a medicament, suitable for administration in an allogeneic setting for treating a disease, of a stem cell source that has been matched to the patient and subsequently manipulated.

Also presented herein is use for the manufacture of a medicament, suitable for administration in an allogeneic setting for enhancing the immune response of a patient to cancer, of a stem cell source that has been matched to the patient and subsequently manipulated.

### DETAILED DESCRIPTION OF THE PREFERRED EMBODIMENT

Throughout the body of this application, certain terms such as “mixed lymphocyte reaction” or “immune reactivity” are used. The inventor defines the phrase “mixed lymphocyte reaction” to include any cellular mixture between a stem cell source and recipient immune cells. Accordingly “mixed lymphocyte reaction” is not used only in the strict sense that lymphocytes are admixed. Furthermore, the phrase “immune reactivity” is defined to encompass any immunological interaction in vitro used to determine whether a potential stem cells source from a potential donor may be suitable for use in a recipient. In addition, the word “deimmunization” or “deimmunize” is defined a rendering a cell or plurality of cells as decreased in immunogenicity. The word “immunogenicity” is defined as being capable of eliciting an immune response.

In one embodiment of the invention, cord blood mononuclear cells, without purging or manipulation are used as a source of cells for transplantation into a non-preconditioned recipient subsequent to matching. It is known that cord blood possesses a very high concentration of hematopoietic stem cells, which is similar to that found in bone marrow: approximately 1 CD34 cell for 100 nucleated cells. However, in contrast to marrow, CD34 cells from cord blood possess superior proliferative potential in vitro (138), superior numbers of long term culture initiating cells and SCID repopulating cells (139, 140), as well has a higher level of telomerase expression (141). Accordingly, due to these properties, allogeneic cord blood stem cells are an excellent substitute for autologous bone marrow cells in situations where a patient would benefit from infusion of CD34 cells. Said situations include patients with degenerative diseases in which CD34 cells have demonstrated therapeutic effect, the ability to differentiate into the cells that are degenerating, or the ability to enhance endogenous cells into performing appropriate physiological function. Said degenerative diseases include age-related, or disease induced abnormalities of the neurological, gastrointestinal, dermatological, urological, respiratory, or cardiac systems. For example, it is known that CD34+ cells can differentiate into cardiomyocytes, mature endothelial cells, alveolar cells, renal cells, smooth muscle, hepatocytes, and neurons (142-146). It is also known that CD34+ cells can stimulate endogenous islet precursors to compensate for pancreatic insults (147). In one specific embodiment, cord blood is administered into a recipient that has been matched using in vitro mixed lymphocyte culture assay. The assay involves admixing an aliquot of cord blood mononuclear cells extracted from a batch that is considered for donation, at a ratio of 1:100, 1:50, and 1:25, 1:17.5, and 1:1 with lymphocytes from a patient that is in need of therapy. Said cells are cultured for a period of time sufficient for stimulation of alloreactivity. Cord blood batches that stimulate alloreactivity are not used for infusion, whereas cord blood batches that do not stimulate significant alloreactivity are used. Determination of alloreactivity may be made based on morphological changes; alternation in metabolism; alteration in surface marker expression; stimulation of proliferation; induction of cytotoxic activity; alteration of migration; or rosetting. Said parameters may be assessed in the responding lymphocytes, in the stimulatory cord blood cells, or both. In some embodiments said cord blood aliquots are irradiated or chemically blocked from proliferation in order to allow detection of responding lymphocytes without interference from cord blood cells. In one specific embodiment, lymphocyte proliferation is chosen as an appropriate marker of alloreactivity. Mononuclear cells are harvested as a source of lymphocytes from the blood of a patient in need of stem cell therapy using density gradient centrifugation, by the Ficoll™ gradient. Approximately 5-20 ml of blood is layered on said Ficoll™ and centrifuged for approximately 20-60 minutes at 500-700 g. The mononuclear layer is harvested and washed in a physiological solution such as phosphate buffered saline, and cells are plated in culture media at approximately 1×10⁶ cells/well. Varying concentrations of mitomycin C treated cord blood cells are added to wells as stimulators. Seventy-two-hour mixed lymphocyte reaction is performed and the cells were pulsed with 1 μCi [3H]thymidine for the last 18 h. The cultures are harvested onto glass fiber filters (Wallac, Turku, Finland). Radioactivity is counted using a Wallac 1450 Microbeta liquid scintillation counter and the data were analyzed with UltraTerm 3 software (Microsoft, Seattle, Wash.). If lymphocyte proliferation is more than 2 fold higher as compared to lymphocytes cultured without stimulator cells, than the cord blood batch is not used for therapy and other batches are screened. In some embodiments of the invention, other types of responder cells of the patient are used for matching, said cells can include unseparated blood; substantially purified T cells, substantially purified B cells, substantially purified NK cells, substantially purified gamma delta T cells, and substantially purified NKT cells. Within the context of the current invention, the use of all stem cells, progenitor cells, and other cells with regenerative ability may be matched to said recipient in similar ways as described in the examples above for cord blood.

In other embodiments of the invention, stem cells may be matched using standard HLA matching that is currently performed clinically. The degree of matching acceptable for cord blood is 4/6 loci selected from HLA-A, HLA-B, and HLA-DRB1. HLA-A and HLA-B may be typed by means of the standard 2-stage complement-dependent microcytotoxicity assay, and antigens assigned as defined by the World Health Organization (WHO) HLA nomenclature committee. HLA-DRB1 type may be determined by hybridization of polymerase chain reaction (PCR)-amplified DNA with sequence-specific oligonucleotide probes (SSOPs), with sequencing if needed.

Cellular administration may be performed a specific timepoints during the progression of the disease pathology. For example, during stroke, key timepoints are known when the concentration of stem cell chemotactic gradients are highest. These timepoints may be selected on the basis of individual patients, or through experience with patient cohorts in order to optimize the therapeutic effect of the administered stem cells. This concept is valid also for myocardial infarction. For both stroke and myocardial infarction the potency of chemoattractant molecules secreted by injured tissue is such that stem cells residing in bone marrow are caused to enter circulation and putatively home to the site of injury (136, 148-150). Accordingly, administration of matched allogeneic cord blood cells, or populations thereof may be administered under the context of the current invention in order to assist and accelerate this endogenous repair process.

Given the previously mentioned high concentration of CD34+ cells (151), as well as the association of this cell type with stimulation of angiogenesis, cord blood appears to be a potent source of angiogenic cells. It is reported that the concentration of this potential endothelial progenitor fraction in cord blood CD34+ cells is approximately tenfold higher as compared to bone marrow CD34+ cells (1.9%+/−0.8% compared to 0.2%+/−0.1%) (152). Regardless of phenotype of the angiogenesis stimulatory cell, whole cord blood cells have been used in numerous animal models (82, 153, 154), as well as in the clinic (155), for stimulation of angiogenesis. One particularly interesting characteristic of cord blood endothelial progenitors is that they respond by proliferating and stimulating angiogenesis to agents, which would normally inhibit angiogenesis of bone marrow progenitors (154). Furthermore cord blood mesenchymal cells may indirectly contribute to angiogenesis through paracrine production of cytokines and growth factors such as VEGF (156) and numerous other pro-angiogeneic cytokines that these cells are known to produce (157). Rare reports also exist of mesenchymal cells differentiating directly into endothelial cells (158). Accordingly in one embodiment of the invention the angiogenic properties of cord blood cells are capitalized upon by administration into a properly matched allogeneic recipient in need thereof of either unfractionated cord blood, or specific cellular fractions chosen for enhanced angiogenic activity. Furthermore, in some embodiments, angiogenic activity may be augmented by in vitro culture of cord blood cells or fractions under conditions stimulatory to angiogenesis. Said conditions include culture in the presence of hypoxia, treatment of cells with angiogenesis stimulatory agents such as VEGF, HGF, FGF or angiopoietin. Alternatively cells may be transfected in vitro with genes that enhance angiogenic activity or with antisense/siRNA constructs that silence inhibitors of angiongenesis. Once a cellular population with angiogenic activity is chosen, the invention teaches administration into a patient that has been appropriately matched, either with HLA 4/6 loci matching, or matching using the mixed lymphocyte culture method. Administration is performed according to methods of the invention so that said patient does not require immune suppression prior to administration of the cellular graft. Conditions which may be treated by this invention are not only limited to classical situations of ischemia, such as peripheral vascular disease, angina, or chronic stroke, but also neurological diseases in which hypoperfusion of the central nervous system contributes to deterioration. Said conditions include cerebral palsy, various ataxias, and autism (159-161). In situations where increased angiogenic potential of said stem cells is desired, said stem cells may be transfected with genes such as VEGF (162), FGF1 (163), FGF2 (164), FGF4 (165), FrzA (166), and angiopoietin (167). Ability to induce angiogenesis may be assessed in vitro prior to administration of said transfected cells in vivo. Methods of assessing in vitro angiogenesis stimulating ability are well known in the art and include measuring proliferation of human umbilical vein derived endothelial cells.

Cord blood contains mesenchymal populations that are capable of potently expanding in vitro and in vivo. These cells are known to be of poor immunogenicity and even have tolerogenic activities. Accordingly, this population has been most clinically developed in term of administration to non-preconditioned hosts. For example, mesenchymal stem cells from the bone marrow have already been used successfully for a variety of applications without HLA matching. Administration of mesenchymal stem cells was reported in a patient suffering severe, grade IV graft versus host disease in the liver and gut subsequent to bone marrow transplant. Systemic infusion of 2×10⁶ cells/kg on day 73 after bone marrow transplant led to a long term remission of graft versus host disease, which was maintained at the time of publication, 1 year subsequent to administration of the mesenchymal stem cells (168). Phase I studies in healthy volunteers have also been performed with systemic administration of ex vivo expanded mesenchymal stem cells and no adverse events reported (169). These and similar studies were the basis for several clinical trials in Phase I-III using “universal donor” mesenchymal stem cells in non-conditioned recipients for treatment of Crohn's disease (170), GVHD (171), and myocardial infarction (172). Although results of these trials have not been published, the allowance of regulatory agencies to proceed to Phase III of clinical evaluation is indicative of clinical safety of these cells. Unfortunately, currently, the only way of using mesenchymal stem cells involves administration after an extended ex vivo culture. The administration of purified cells is not available for widespread use, and only certain limited facilities are capable of such expansion. Within the context of the current invention is the teaching that mesenchymal stem cells residing within a cord blood graft may be administered, as part of the whole cord blood population, or with certain subsets of cells residing in said cord blood, into a patient that has been properly matched as described herein, without the need for immune suppression. In contrast to the bone marrow derived stem cells used currently in clinical trials, it appears that this type of stem cells from cord blood is actually superior. A recent study compared mesenchymal stem cells from bone marrow, cord blood and adipose tissue in terms of colony formation activity, expansion potential and immunophenotype. It was demonstrated that all three sources produced mesenchymal stem cells with similar morphology and phenotype. Ability to induce colony formation was highest using stem cells from adipose tissue and interestingly in contrast to bone marrow and adipose derived mesenchymal cells, only the cord blood derived cells lacked ability to undergo adipocyte differentiation. Proliferative potential was the highest with cord blood mesenchymal stem cells which were capable of expansion to approximately 20 times, whereas cord blood cells expanded an average of 8 times and bone marrow derived cells expanded 5 times (173). This, and other studies support the important role of mesenchymal stem cell content in the biological activities of the cord blood graft. Given the potent ability of mesenchymal stem cells from cord blood to expand preferentially in comparison to mesenchymal stem cells from other sources, the invention teaches that cord blood may be administered into a non-preconditioned host so as to allow for mesenchymal stem cells to expand in vivo, in a similar manner that mesenchymal cells expand in the bone marrow of mothers who have had children. Accordingly, on embodiment of the invention involves administration of cord blood, or fractions thereof into a recipient that has been properly matched with either HLA 4/6 loci matching and/or mixed lymphocyte reaction matching, and subsequent to cellular infusion, the administration of agents that would allow an enhanced in vivo expansion of cord blood derived mesenchymal cells. Said patient may be treated with agents such as mesenchymal stem cell stimulatory growth factors such as FGF-2, which has already been used clinically and is approved in Japan (174). On particular embodiment would be treatment of patients with non-healing wounds through administration of systemic cord blood cells together with local administration of FGF-2 on the wound surface. Alternatively, the fact that FGF family members form a localized depot subsequent to administration allow for the use of cord blood transplants together with injected FGF-2 at the site of injury. The may be useful for diseases in which direct administration of FGF-2 may be not be beneficial due to fear of fibrosis, however the administration of a potent mesenchymal stem cell source would reduce the occurrence of fibrosis and promote physiological tissue remodeling. The administration of cord blood as a mesenchymal stem cell source, either alone or in combination with a chemoattractant factor, may be used for treatment of a variety of degenerative and/or inflammatory diseases. In some aspects of the invention, a chemoattractant agent or combination of agents are administered either proximally, or directly on the are of pathology where regeneration, and/or anti-inflammatory activity is desired, with the purpose of attracting therapeutic cell populations and activating said cell populations to perform the desired therapeutic activity. Said chemoattractant may be administered in the form of a depot proximally, or directly on the are of pathology where regeneration, and/or anti-inflammatory activity is desired. Said depot capable of substantially localizing said chemoattractant is may be selected from a group consisting of: fibrin glue, polymers of polyvinyl chloride, polylactic acid (PLA), poly-L-lactic acid (PLLA), poly-D-lactic acid (PDLA), polyglycolide, polyglycolic acid (PGA), polylactide-co-glycolide (PLGA), polydioxanone, polygluconate, polylactic acid-polyethylene oxide copolymers, polyethylene oxide, modified cellulose, collagen, polyhydroxybutyrate, polyhydroxpriopionic acid, polyphosphoester, poly(alpha-hydroxy acid), polycaprolactone, polycarbonates, polyamides, polyanhydrides, polyamino acids, polyorthoesters, polyacetals, polycyanoacrylates, degradable urethanes, aliphatic polyester polyacrylates, polymethacrylate, acyl substituted cellulose acetates, non-degradable polyurethanes, polystyrenes, polyvinyl flouride, polyvinyl imidazole, chlorosulphonated polyolifins, and polyvinyl alcohol. Furthermore, said chemoattractant useful for the practice of the current invention may be is selected from a group comprising: SDF-1, VEGF, RANTES, ENA-78, platelet derived factors, various isoforms thereof and small molecule agonists of VEGFR-1, VEGFR2, and CXCR4. In another aspect of the invention, the chemoattractant is administered into the area in need, through transfection of a single or plurality of nucleotide(s) encoding said chemoattractant factor.

In one specific embodiment of the invention, one or more units of cord blood that are matched by mixed lymphocyte culture with the recipient, are used in the treatment of peripheral limb ischemia. 10⁵-10⁹ allogeneic cord blood nucleated cells/kg, preferably 10⁶-10⁸/kg, more preferably, approximately 10⁷/kg are administered intravenously. Prior to administration, said patient is treated locally in the area of ischemia with a depot formulation of SDF-1. Said patient is observed for reduction in ischemic pain and neovascularization is quantified by imagining. If patient condition does not substantially improve within 2-5 weeks subsequent to treatment, treatment is repeated.

In one specific embodiment of the invention, one or more units of cord blood that are matched by mixed lymphocyte culture with the recipient, are used in the treatment of steroid refractory Crohn's disease. 10⁵-10⁹ allogeneic cord blood nucleated cells/kg, preferably 10⁶-10⁸/kg, more preferably, approximately 10⁷/kg are administered intravenously. Said patient is observed for Crohn's Disease Assessment Index or other clinically relevant markers. If patient condition does not substantially improve within 2-5 weeks subsequent to treatment, treatment is repeated.

In one embodiment stem cells subsequent to matching, and/or manipulation, are administered in combination with a pregnancy associated compound, or compounds known to induce ability of stem cells to self-renew and/or regenerate diseased and/or degenerated tissue. Said compound or compounds may be administered at a concentration that induces systemic levels similar to those observed in a pregnant woman. In other embodiments compounds may be administered to achieve higher or lower levels than those observed during pregnancy. On example of compounds that are useful for practicing of the current invention is human chorionic gonadotrophin (HCG) and prolactin. Administration may be daily at a concentration of 75-300 ·mu·g per day, or 140 ·mu·g per day for both compounds. Variations and other compounds useful for practicing the current invention are disclosed in U.S. Patent Application No. 2006/0089309 to Joseph Tucker. Said other useful agents may include combination, or singular use of follicle-stimulating hormone (FSH), gonadotropin releasing hormone (GnRH), prolactin releasing peptide (PRP), erythropoietin, pituitary adenylate cyclase activating polypeptide (PACAP), serotonin, bone morphogenic protein (BMP), epidermal growth factor (EGF), transforming growth factor alpha (TGFalpha), transforming growth factor beta (TGFbeta), fibroblast growth factor (FGF), estrogen, growth hormone, growth hormone releasing hormone, insulin-like growth factors, leukemia inhibitory factor, ciliary neurotrophic factor (CNTF), brain derived neurotrophic factor (BDNF), thyroid hormone, thyroid stimulating hormone, and/or platelet derived growth factor (PDGF).

One embodiment of the current invention capitalizes on the multi-organ regenerative capability of stem cell fractions found in cord blood. For example, cells with markers of embryonic stem cells have been found in cord blood. Zhao et al identified a population of CD34-cells expressing OCT-4, Nanog, SSEA-3 and SSEA-4 which could differentiate into cells expressing endothelial and neuronal markers. In vivo administration of these purified cells into the streptozotocin-induced murine model of diabetes was able to significantly reduce hypoglycemia (175). The existence of cells with such pluripotency in cord blood was also observed by Kogler et al who identified an Unrestricted Somatic Stem Cell (USSC) with capability of differentiation into functional osteoblasts, chondroblasts, adipocytes, and hematopoietic and neural cells. The USSC was demonstrated to be capable of >40 population doublings without spontaneous differentiation or loss of telomere length. Interestingly, administration of these cells into preimmune sheep resulted significant human hematopoiesis (up to 5%), hepatic chimerism with >20% albumin-producing human parenchymal hepatic cells, as well as detection of human cardiomyocytes. The mechanism of differentiation was not associated with fusion (176). Support for presence of such pluripotency in cord blood cells also comes from a similar experiment in which CD34+ Lineage-cells were transfected with GFP and administered in utero to goats. GFP+ cells were detected in blood, bone marrow, spleen, liver, kidney, muscle, lung, and heart of the recipient goats (1.2-36% of all cells examined) (146). The invention teaches that such regeneratively potent stem cell fractions may be administered into a recipient that has been matched with said stem cell graft based on HLA and/or mixed lymphocyte reaction without preconditioning. In some embodiments of the invention, despite HLA and/or mixed lymphocyte reaction matching, a decrease in immunogenicity is further sought. Accordingly, cells may be transfected using immune modulatory agents. Said agents include soluble factors, membrane-bound factors, and enzymes capable of causing localized immune suppression. Examples of soluble immune suppressive factors include: IL-4 (177), IL-10 (178), IL-13 (179), TGF-β (180), soluble TNF-receptor (181), and IL-1 receptor agonist (182). Membrane-bound immunoinhibitor molecules that may be transfected into stem cells for use in practicing the current invention include: HLA-G (183), FasL (184), PD-1L (185), Decay Accelerating Factor (186), and membrane-associated TGF-β (187). Enzymes which may be transfected in order to cause localized immune suppression include indolamine 2,3 dioxygenase (188) and arginase type II (189). In order to optimize desired immune suppressive ability, a wide variety of assays are known in the art, including mixed lymphocyte culture, ability to generate T regulatory cells in vitro, and ability to inhibit natural killer or CD8 cell cytotoxicity.

The current dogma that cord blood transplants require suppression of the recipient immune system is based on the fact that even immune suppressed recipients of cord blood sometimes develop graft failure. The invention is based on the novel finding that cord blood cells can actually engraft without immune suppression if appropriately matched, and under specific conditions manipulated. The low immunogenicity of cord blood as a stem cell source, and its ideal use for the practice of the current invention is based on several observations. For example, it is known that cord blood consists of similar immunological populations of blood cells as peripheral blood, with the exception of the immature status of these cells. Accordingly, there are numerous studies that suggest cord blood is less immunogenic as a whole in comparison to peripheral blood. For example, the most potent antigen presenting cell, the dendritic cell, possesses unique properties when freshly extracted from cord blood. Specifically, cord blood dendritic cells are poor stimulators of mixed lymphocyte reaction (190, 191) and weakly support mitogen induced T cell proliferation (192), possess a predominantly lymphoid phenotype and absent costimulatory molecules (193-196), and are believed to be involved in the non-inflammatory Th2 bias of the neonate (193-195). Cord blood dendritic cell progenitors also exhibit distinct properties such as enhanced susceptibility to natural and artificial immune suppressants (197, 198). When cord blood versus peripheral blood derived dendritic cells are assessed for ability to stimulate immune response to apoptotic or necrotic cells, peripheral blood derived dendritic cells upregulate costimulatory molecules and stimulate T cell proliferation, whereas cord blood derived dendritic cells do not. Given the immaturity and anti-inflammatory activity of cord blood dendritic cells, it is suggested that cord blood in general will be more poorly immunogenic as compared to other sources of nucleated cells. A comparison may be made between cord blood grafts and liver transplants in that HLA-matching for liver transplants does not seem to effect graft survival (199). Indeed dendritic cell populations with a primarily lymphoid phenotype, similar to those found in cord blood are known to predominate in the liver (199). A property of cord blood dendritic cell progenitors that is of interest in the practice of the current invention, is their propensity towards generating tolerogenic cells. It is reported that growth of cord blood progenitors in M-CSF gives rise to a potently suppressive tolerogenic dendritic cell phenotype. These dendritic cells are not only are poor allostimulators, but give rise to CD4+ CD25+ T regulatory cells that are capable of inhibiting mixed lymphocyte reactions (200). Accordingly, within the practice of the current invention is the expansion of donor-specific, or donor matched cord blood dendritic cells that have been expanded ex vivo, and used to increase graft acceptance in the recipient without the need for immune suppression. Since one of the major drawbacks of cell therapy in general is viability of the infused cells subsequent to administration, it may be desired in some forms of the invention to transfect said stem cells with genes protecting said cells from apoptosis. Anti-apoptotic genes suitable for transfection may include bcl-2 (201), bcl-x1 (202), and members of the XIAP family (203). Alternatively it may be desired to increase the proliferative lifespan of said stem cells through transfection with enzymes associated with anti-senescence activity. Said enzymes may include telomerase or histone deacetylases. Furthermore, the same concept applies to cells with tolerogenic potential, such as cord blood derived dendritic cells, in that said cells may be transfected with either anti-apoptosis, or anti-senescence genes.

Another interesting tolerogenic feature of cord blood dendritic cells is their propensity to secrete large numbers of MHC II-bearing exosomes that lack expression of costimulatory molecules (204). This type of exosome was used for prevention of autoimmune disease by other authors (205). Within the context of the current invention is the use of exosomes derived either from the cord blood of the donor, or from a donor-matched third party in order to increase tolerogenicity towards the stem cells graft. Exosomes may be purified using a variety of means known in the art. In one particular embodiment, matched cord blood cells are cultured at a concentration of 10⁴-10⁸ cells per ml, preferably at approximately 10⁶ cells per ml. Exosomes may be purified from culture supernatant using sequential ultracentrifugation: separation of cellular debris is first performed by centrifugation at approximately 10,000 g for 1 h followed by pelleting of the exosome through centrifugation at 100,000×g for 3 h. Immunoelectron microscopy can be used to confirm that it is indeed exosomes that are being purified. The protein concentration of exosomes can be assessed by the Bradford assay (Bio-Rad Laboratories, Mississauga, ON), or other means of assessing protein content known in the art. It has been reported that exosomes from activated T cells can be visualized directly by flow cytometry based on their size profile (206). Accordingly it is possible to use MACS™ beads (Milteny-Biotech, Germany) as well as Calibrite™ beads (BD Biosciences) in order to calibrate flow cytometry settings for visualization of exosomes. The ability to visualize exosomes by flow cytometry allows for identification of membrane proteins using antibody staining. Accordingly, exosome populations derived from stem cell sources, such as cord blood can be identified for enhanced tolerogenic properties and administered into a recipient of stem cells in order in enhance tolerogenicity of said stem cell graft. In some embodiments of the invention, cord blood derived exosomes are added to an ongoing mixed lymphocyte reaction with the aim of inhibiting immune reactivity. Based on amount of inhibition, the proper exosome concentration, as well as, if desired, type of exosome, may be used clinically.

As previously noted, cord blood has approximately similar concentration of CD34+ cells compared to bone marrow, that is, approximately 1:100 of the nucleated cells are CD34+. The ability of CD34+ bone marrow hematopoietic stem cells to not only be poorly recognized by allogeneic response, but actually have a veto-like effect has been previously suggested as the reason why higher dose transplants are associated with enhanced engraftment (207, 208). Induction of clinical transplantation tolerance using donor specific bone marrow has been previously demonstrated (209). Mechanistically, in a murine model it was demonstrated that the veto-like effect of donor bone marrow transplantation induced tolerance is expression of FasL on bone marrow cells (210). Furthermore, human mixed lymphocyte reaction responder cells can be specifically induced to undergo apoptosis by stimulator, but not third party CD34 cells obtained from bone marrow (211). Accordingly, one of the embodiments of the current invention is to capitalize on the veto effect of CD34 cells and to increase tolerogenicity and acceptance by administration of either expanded CD34+ cells from the same cord, or from a matched third party cord. In another embodiment, CD34+ cells from bone marrow matched to the cord blood may be used. Enhancement of veto activity may be performed through genetically transfecting genes encoding cytotoxic molecules on said CD34+. Although it is known that CD34+ express FasL, enhancement of veto activity may be performed through transfecting the FasL gene under control of a strong promoter. Additionally molecules may include TRAIL, TNF, perforin, and granzyme family members.

Mesenchymal stem cells with proliferative ability greater than bone marrow or adipose tissue are found in cord blood (173). It is likely that this cell population plays an important role in the immunogenicity of the cord blood graft, both during the immediate transplantation period, and also in the long term when these cells engraft into donor tissue. Mesenchymal stem cells have been shown to possess immune suppressive functions. For example, it was demonstrated in a murine model that flk-1+Sca-1-marrow derived mesenchymal stem cell transplantation leads to permanent donor-specific immunotolerance in allogeneic hosts and results in long-term allogeneic skin graft acceptance (212). Other studies have shown that mesenchymal stem cells are inherently immunosuppressive through production of PGE-2, interleukin-10 and expression of the tryptophan catabolizing enzyme indoleamine 2,3,-dioxygenase as well as galectin-1 (213, 214). These stem cells also have the ability to non-specifically modulate the immune response through the suppression of dendritic cell maturation and antigen presenting abilities (215, 216). Immune suppressive activity is not dependent on prolonged culture of mesenchymal stem cells since functional induction of allogeneic T cell apoptosis was also demonstrated using freshly isolated, irradiated, mesenchymal stem cells (217). Others have also demonstrated that mesenchymal stem cells have the ability to preferentially induce expansion of antigen specific T regulatory cells with the CD4+ CD25+ phenotype (218). Mesenchymal cells can antigen specifically inhibit immune responses as observed in a murine model of multiple sclerosis, experimental autoimmune encephalomyelitis, in which administration of these cells lead to inhibition of disease onset (219). Given the immune regulatory functions of mesenchymal stem cells in the cord, in one embodiment of the current invention, the mesenchymal cell content is expanded in vivo and used as a third-party cell source for suppressing a pathological inflammatory response. In one embodiment, adrenomedullin is administered in vivo in order to enhance activity of mesenchymal stem cells.

As with peripheral blood, cord blood has numerous immunological populations. The most well characterized cells in the cord blood with effector function, are the T cells, and conversely the T regulatory cells. The majority of studies examining other cord blood cell populations such as NK, NKT, and gamma delta T cells have actually used cord blood as a starting population for in vitro expansion and hence are not of relevance to the current invention (220-225). T cells from cord blood are known to have a propensity towards an anti-inflammatory phenotype. This is illustrated, for example, experiments with CD4+ T cells from cord blood were shown to produce significantly lower IFN-gamma and higher IL-10 upon activation with mature dendritic cells as opposed to control adult blood derived CD4+ T cells (226). Other experiments have demonstrated hyporesponsiveness to mitogen and MLR stimulation (227, 228), as well as reduced levels of IL-2 production and IL-2 responsiveness as opposed to adult T cells (229). This is not to say that cord blood T cells are not capable of mounting inflammatory and Th1 immunological attacks (230). For example GVHD, in some cases lethal is a clinical reality in some cord blood transplant patients. However it should be noted that cord blood transplantation in the vast majority of cases takes place following ablation of host T cells. This creation of an “empty compartment” naturally allows for homeostatic expansion, which conceptually primes T cells for aggressive immune reactions and lack of need for a second signal (231). It is known from the transplantation literature that T cells reconstituting a host that has been lymphoablated are resistant to costimulatory blockade and tolerance induction (232). Furthermore the pioneering experiments of Rosenberg's group demonstrated that infusion of tumor specific lymphocytes following ablation of the recipient T cells, using conditions similar to those used in cord blood transplant preconditioning allows for highly aggressive anti-tumor responses that otherwise would not be observed (233). Accordingly, in one embodiment of the invention T cells are not depleted from the graft due to intrinsically low possibility of GVHD. In another embodiment, only T cells, which do not possess a T regulatory phenotype, are depleted.

In addition to conventional T cells, cord blood is known to contain a population of T regulatory (Treg) cells that possess immune suppressive activity. The role of Tregs in immunological function is to control, in an antigen-specific manner, hyperimmune activation. Treg depletion in animal models is associated with autoimmunity and transplant rejection (234), whereas, augmented Treg function is found in pregnancy and cancer (220, 235). These Treg cells typically display the phenotype CD4+ CD25+, are resistant to FasL-mediated apoptosis (in contrast to adult peripheral blood Tregs which are sensitive (236)), and inhibit proliferation of CD4+ CD25-T cells with several-fold more potency than Tregs isolated from adult peripheral blood (237). Additionally, in comparison to adult peripheral blood, cord blood cells are found at a much higher frequency in cord (238). It has been demonstrated that Tregs are associated with protection from autoimmune disease in animal models, and clinical remission of autoimmunity (237, 239, 240). This suggests that the high Treg content and suppressive activity of cord blood may not only be one of the reasons for lower GVHD as compared to other stem cell sources, but also that cord blood derived cells may have therapeutic applications of immune dysregulation diseases. Accordingly, in one aspect of the invention, Treg cells are expanded from cord blood in order to allow an enhanced state of chimerism. Expansion of Treg cells in ex vivo cultures is well known and has been performed using various cocktails of anti-CD3, IL-2, TGF-β, and IL-10. In one particular embodiment of the invention cord blood mononuclear cell are extracted by centrifugation over Ficoll. CD34+ cells are collected using, for example, magnetic microbeads (Miltenyi Biotec, Auburn, Calif.), and preserved as a stem cell source. From the CD34 negative fraction, CD25+ cells are isolated using means known in the art, such as, for example, by positive selection with directly conjugated anti-CD25 magnetic microbeads (4 μL per 10⁷ cells; Miltenyi Biotec). Cells are then applied to a second magnetic column, washed, and re-eluted. After the double column procedure, an aliquot of the cells are assessed by FACS analysis and the bulk of the cells are cultured with anti-CD3/CD28 mAb-coated Dynabeads™ at a ratio of approximately 3:1 bead-to-cell. Cells are cultured at approximately 1×10⁶ total cells per milliliter in a culture vessel. IL-2 is added on day 3 at 50 IU/mL (Chiron, Emeryville, Calif.). Cell cultures are split as needed, approximately ⅓ every 3 days during the fast-growth phase. Culture media may be RPMI 1640 (Invitrogen-Gibco, Carlsbad, Calif.) supplemented with 10% recipient serum, L-glutamine, penicillin, and streptomycin. Upon sufficient expansion, Treg cells are administered into a patient in need of therapy together with stem cells. Stem cells may be from the same source as the origin of the CD4+CD25+ Treg, or may be from a source that has been matched, either by HLA or by immune reactivity. Said Treg are administered at a concentration sufficient to allow for immune regulation and to promote graft persistence in the absence of need for immune suppressive therapy. In some situations, said Treg cell may act as a inhibitor of immunity in an antigen-specific manner, whereas in other situations, direct therapeutic activity may arise from Treg inhibiting a pathological immune response, whereas the infused dose of stem cells contribute to the tissue healing. This is particularly important in autoimmune diseases, in which tissue regeneration is not sufficient to improve disease course if the underlying immunological defect will cause re-attack of the regenerated tissue.

As previously stated, the possibility of using cord blood in absence of host preconditioning would open up the door for a multitude of stem cell therapeutic applications. The currently dogma amongst cord blood transplanters is that administration of allogeneic cord blood, even if HLA-matched, would in the best case scenario lead to immunologically-mediated rejection or the graft, and in the worse case cause GVHD. The current invention provides means of clinically using cord blood administration in a non-preconditioned host without substantial risk not only of host versus graft, but also without GVHD. One of the premises of the invention is the unrecognized fact that cord blood transplantation has previously been performed not for its regenerative abilities, but for the high oxygen carrying capacity of fetal hemoglobin. In the 1930s it was reported that cord blood could be safely used as a substitute for peripheral blood for performing transfusions (7). Since HLA-matching was not available at that time and no adverse effects were noted, feasibility of cord blood administration to a non-preconditioned host was suggested. A more recent Lancet publication described the use of cord blood as a source of blood donation for malaria infested regions in Africa. 128 pediatric patients with severe anemia needing transfusions were transplanted with an average of 85 ml of ABO matched cord blood with no HLA matching. No report of graft versus host was noted, and cord blood was proposed as a transfusion source when peripheral blood is not available due to economical or social reasons (241). An extensive review of 129 patients transplanted with a total of 413 Units of cord blood (average 86 ml) for the purposes of treating anemia, with no preconditioning or HLA matching between 1999 to 2004 was published by Bhattacharya (242). Of these patients, aged 2-86 years old and suffering from advanced cancer (56.58%) and other diseases (43.42%) such as ankylosing spondylitis, lupus erythematosus, rheumatoid arthritis, aplastic anemia, and thalassemia major, no immunological reactions were noted with followed for some patients of 1-4 years. The same author reported several other patient cohorts that have been similarly treated and had no GVHD or other immune reactions (243-246). Furthermore, transfusion of cord blood in non-HLA matched recipients was also associated with transient increases in peripheral CD34 counts, without evidence of GVHD in patients with cancer and HIV (128, 247). An extreme case of mega-dose cord blood administration for transfusion purposes was reported where as many as 32 units of cord blood were administered without HLA matching and no evidence of GVHD was observed (128). Unfortunately in these studies the regenerative ability of cord blood were not examined, nor were methods used to enhance the stem cell activity of cord blood, as is thought in the current invention.

Further support for the premise of the current invention is that GVHD does not occur in women receiving using paternal lymphocyte immunotherapy for treatment of spontaneous abortions. Since paternal lymphocytes are from adults, and therefore relatively more mature and immunologically reactive as compared to cord blood lymphocytes, the fear of GVHD would be higher in this particular situation. Numerous trials have been performed administering doses of up to 2×10⁹ paternal lymphocytes into pregnant mothers who have had recurrent miscarriages (248, 249). These doses are higher than the 1.5-3×10⁷ nucleated cells/kg administered during a conventional cord blood transplant, and also higher than the doses of donor lymphocytes administered to CML patients after post transplant leukemic relapse but also cause GVHD (250). Interestingly in pregnant women administered these high doses of completely allogeneic cells, no GVHD has ever been observed in mothers subjected to this procedure, although Th2 immune deviation has been reported by some groups (251, 252). Thus the safety of practicing the current invention is supported by the established lack of GVHD in allogeneic transfusions.

Support for the current invention from the aspect of matched stem cells not being rejected by an immunocompetent allogeneic host comes from established examples of such mismatched cells co-existing in the long-term in absence of immune suppression. One example that suggests cells can exist in a state of chimerism after initial immune suppression is in the area of liver transplantation. It is known that the liver contains various populations of hematopoietic stem cells (253). In fact, liver transplant into irradiated rat recipients leads to full donor-derived hematopoietic reconstitution (169). Patients who have received liver transplants are known to contain donor-derived CD34+ cells in the bone marrow even years after transplantation (254). This suggests that either the CD34 cells may have a type of veto function that allows them to escape immune attack, or conversely it may be argued that microchimerism in this case is the result of host conditioning and immune suppression during the liver transplant, which allows of initial tolerance induction to occur, and therefore the host does not clear the liver-derived CD34 cells in the same manner that it does not reject the liver. This discussion now turns to the observations of fetal cell engraftment in pregnant mothers. It is well established that during pregnancy fetal cells enter maternal circulation (255). While circulating CD34+ cells of fetal origin are found a percentage of women who have had children (256), in the bone marrow 100% of women who have had children were found to contain male mesenchymal cells in their bone marrow (257). Although some studies have correlated autoimmunity with residual lymphocytes causing a GVHD-like reaction in the mother, more careful analysis of these studies show that immune cells of fetal origin are largely outnumbered by cells of maternal origin. This is the basis for the proposition of Khosrotehrani et al that the fetal cells are actually “pregnancy associated progenitor cells” that act as allogeneic “repair cells” (258). The authors of this hypothesis believe that these repair cells are actually migrating to the site of autoimmune damage in order to control injury and cause regeneration. The authors cite numerous examples in support of their idea, more notably, a case report of a hepatitis C patient who stopped treatment but disease relapse was not observed. Biopsy analysis demonstrated the liver parenchyma was heavily populated with cells of male origin that based on DNA polymorphism analysis were derived from a previous pregnancy more than a decade earlier (259). Additionally, they cite reports of maternal cells differentiating into thyroid, cervix, gallbladder and intestinal epithelial cells (260-263). Data from animal models, although scarce, supports the notion that fetal cells trafficking into the mother may play some reparative function. For example, it was reported that EGFP expressing fetal cells would selectively home into damaged maternal renal and hepatic tissues after gentamycin and ethanol induced injury (264). Furthermore, another study demonstrated that subsequent to excitotoxic injury in the maternal brain, fetal-derived EFGP postive cells can be identified which express morphology and markers of neurons, astrocytes, and oligodendrocytes (265). Accordingly, one embodiment of the current invention is to replicate the phenomena of fetal to maternal trafficking through administration of cells that are matched to the recipient. Furthermore, another embodiment of the current invention is administration of offspring, or offspring-matched cells to a mother, so as to replenish a population similar to the “pregnancy associated progenitor cells”. Advantages of this embodiment of the current invention include the fact that the mother already has some immune deviation to the haplotype, based on fetal-maternal chimerism.

Clinical entry of a cord blood therapeutic in patients who are not preconditioned would require a high margin of safety to be met. Accordingly, one in one embodiment of the current invention, an approach for initiating cord blood clinical trials is made through cord blood grafts that are depleted of T cells, B cells, and dendritic cells. In this manner, even the remote possibility of GVHD would be negated, as well, the removal of antigenicity by depletion of the B cells and dendritic cells would further reduce the possibility of immune mediated rejection of the stem cells. A method of accomplishing this would be the pretreatment of cord blood units with the clinically used anti-CD52 monoclonal antibody CAMPATH™ (alemtuzumab; Genzyme, Cambridge, Mass.). It has been previously demonstrated that this agent can be used in substantially “cleaning” grafts of T cells without effecting hematopoietic activity both in vitro (266) and in the clinic (267). Furthermore, CAMPATH™ has been shown to deplete B cells (267), as well as circulating blood dendritic cells (268, 269). In one embodiment of the invention, cord blood mononuclear cells are concentrated in a balanced salt solution (containing Ca2+) that is substantially free from plasma and depleted of red blood cells and granulocytes. The volume of the mononuclear cell suspension is adjusted so that the cell density did not exceed 5×10⁷/mL, and CAMPATH-1M is added to give a final concentration of 0.1 mg/mL. The mixture is incubated for 10 to 20 minutes at room temperature, and then recipient serum was added to a final concentration of 25% (vol/vol). It mixture is subsequently incubated for a further 20 to 45 minutes at 37° C. The treated cord blood cells are washed once, assessed for viability, and infused into a patient in need of therapy. Assessment of residual T cells, B cells, and dendritic cells may be performed by flow cytometry. Additionally, “de-immunization” of the cord blood graft may be verified by assessing ability to stimulate immune reactivity in vitro using the various matching techniques known in the art, some of which are described in this application. In another aspect of the invention, bone marrow, or mobilized peripheral blood mononuclear cells may be used as the starting material for “de-immunization” by treatment with CAMPATH.

The current invention provides other methods for deimmunization of a stem cell graft. For example, exposure of cells to an environment of high oxygen content may be used to selectively deplete antigen-presenting cells without damaging the stem cell compartment. Similar methods of used in islet transplantation for “deimmunization” (270). In one particular embodiment of the invention, a population of stem cells, for example a cord blood mononuclear cell population, a bone marrow mononuclear population, or a population of mobilized peripheral blood mononuclear cells is subjected to culture in approximately 95% oxygen and 5% carbon dioxide for a period of approximately 1-13 days, more preferably approximately for 3-10 days, and more preferably for approximately 7 days. Subsequent to culture, assess of content of antigen presenting cells is performed by means known in the art, one such means including flow cytometry, immunoflourescent microscopy, or mixed lymphocyte reactions with allogeneic cells. Additionally, content of stem cells may also be assessed by the first two mentioned methods. Cells are subsequently infused into a recipient in need of therapy. In some particular embodiments, HLA mismatch between donor stem cell source may be higher that 4/6 for HLA-A, HLA-B, and HLA-DR, however through depleting antigen presenting cell content of said donor stem cell source, compatibility for matching using nixed lymphocyte reaction may be met, thus allowing for use of said stem cell source in recipients that otherwise would have been excluded.

In one embodiment of the invention, allogeneic stem cells are collected from amniotic fluid. Said amniotic fluid mononuclear cells may be utilized therapeutically in an unpurified manner subsequent to matching. Said amniotic fluid stem cells are administered either locally or systemically in a patient suffering from a degenerative condition. In other embodiments amniotic fluid stem cells are substantially purified based on expression of markers such as SSEA-3, SSEA4, Tra-1-60, Tra-1-81 and Tra-2-54, and subsequently administered. In other embodiments cells are cultured, as described in U.S. Patent Application No. 2005/0054093, expanded, and subsequently infused into the patient. Amniotic stem cells are described in the following references (271-273). One particular aspect of amniotic stem cells that makes them amenable for use in practicing certain aspects of the current invention is their bi-phenotypic profile as being both mesenchymal and endothelial progenitors (272, 274). This property is useful for treatment of patients with degenerative diseases that would benefit from angiogenesis, but also from the effects of mesenchymal stem cells. The use of amniotic fluid stem cells is particularly useful in situations such as ischemia associated pathologies and/or inflammatory states, in which hypoxia is known to perpetuate degenerative processes. The various embodiments of the invention for other stem cells described in this disclosure can also be applied for amniotic fluid stem cells. In some embodiments, said amniotic fluid stem cells may be administered with a population of matched tolerogenic cells into the allogeneic recipient so as not to be rejected by said recipient.

In another embodiment, allogeneic donors that have been matched with HLA or mixed lymphocyte reaction are mobilized by administration of G-CSF (filgrastim: neupogen) at a concentration of 10 ug/kg/day by subcutaneous injection for 2-7 days, more preferably 4-5 days. Peripheral blood mononuclear cells are collected using an apheresis device such as the AS104 cell separator (Fresenius Medical). 1-40×10⁹ mononuclear cells are collected, concentrated and administered locally, injected systemically, or in an area proximal to the region pathology associated with the given degenerative disease. In situations where ischemia is identified as causative to the disease localized cellular administration may be performed within the context of the current invention. Methods of identification of such areas of ischemia are routinely known in the art and includes the use of techniques such as nuclear or MRI imagining. Variations of this procedure may include steps such as subsequent culture of cells to enrich for various populations known to possess angiogenic and/or anti-inflammatory, and/or anti-remodeling, and/or regenerative properties. Additionally cells may be purified for specific subtypes before and/or after culture. Treatments can be made to the cells during culture or at specific timepoints during ex vivo culture but before infusion in order to generate and/or expand specific subtypes and/or functional properties. The various embodiments of the invention for other stem cells described in this disclosure can also be applied for circulating peripheral blood stem cells.

In another embodiment of the invention, allogeneic adipose tissue derived stem cells are used as a stem cell source. Said adipose tissue derived stem cells express markers such as CD9; CD29 (integrin beta 1); CD44 (hyaluronate receptor); CD49d,e (integrin alpha 4, 5); CD55 (decay accelerating factor); CD105 (endoglin); CD106 (VCAM-1); CD 166 (ALCAM). These markers are useful not only for identification but may be used as a means of positive selection, before and/or after culture in order to increase purity of the desired cell population. In terms of purification and isolation, devices are known to those skilled in the art for rapid extraction and purification of cells adipose tissues. U.S. Pat. No. 6,316,247 describes a device which purifies mononuclear adipose derived stem cells in an enclosed environment without the need for setting up a GMP/GTP cell processing laboratory so that patients may be treated in a wide variety of settings. One embodiment of the invention involves attaining 10-200 ml of raw lipoaspirate, washing said lipoaspirate in phosphate buffered saline, digesting said lipoaspirate with 0.075% collagenase type I for 30-60 min at 37° C. with gentle agitation, neutralizing said collagenase with DMEM or other medium containing autologous serum, preferably at a concentration of 10% v/v, centrifuging the treated lipoaspirate at approximately 700-2000 g for 5-15 minutes, followed by resuspension of said cells in an appropriate medium such as DMEM. Cells are subsequently filtered using a cell strainer, for example a 100 μm nylon cell strainer in order to remove debris. Filtered cells are subsequently centrifuged again at approximately 700-2000 g for 5-15 minutes and resuspended at a concentration of approximately 1x10⁶/cm² into culture flasks or similar vessels. After 10-20 hours of culture non-adherent cells are removed by washing with PBS and remaining cells are cultured at similar conditions as described for culture of cord blood derived mesenchymal stem cells. Upon reaching a concentration desired for clinical use, cells are harvested, assessed for purity and administered in a patient in need thereof as described above. The various embodiments of the invention for other stem cells described in this disclosure can also be applied for adipose derived stem cells.

In one embodiment of the invention, allogeneic pluripotent stem cells derived from deciduous teeth (baby teeth) are used. Said stem cells have been recently identified as a source of stem cells with ability to differentiate into endothelial, neural, and bone structures. Said pluripotent stem cells have been termed “stem cells from human exfoliated deciduous teeth” (SHED). One of the embodiments of the current invention involves utilization of this novel source of stem cells for the treatment of various degenerative conditions without need for immune suppression. In one embodiment of the invention, SHED cells are administered systemically or locally into a patient with a degenerative condition at a concentration and frequency sufficient for induction of therapeutic effect. SHED cells can be purified and used directly, certain sub-populations may be concentrated, or cells may be expanded ex vivo under distinct culture conditions in order to generate phenotypes desired for maximum therapeutic effect. Growth and expansion of SHED has been previously described by others. In one particular method, exfoliated human deciduous teeth are collected from 7- to 8-year-old children, with the pulp extracted and digested with a digestive enzyme such as collagenase type I. Concentrations necessary for digestion are known and may be, for example 1-5 mg/ml, or preferable around 3 mg/ml. Additionally dispase may also be used alone or in combination, concentrations of dispase may be 1-10 mg/ml, preferably around 4 mg/ml. Said digestion is allowed to occur for approximately 1 h at 37° C. Cells are subsequently washed and may be used directly, purified, or expanded in tissue culture. Recently, the commercial business of tooth stem cell banking has been announced at the website www dot bioeden dot corn. The various embodiments of the invention for other stem cells described in this disclosure can also be applied for exfoliated teeth stem cells.

One embodiment of the current invention is the use of allogeneic hair follicle derived stem cells for treatment of degenerative conditions. Said cells may be used therapeutically once freshly isolated, or may be purified for particular sub-populations, or may be expanded ex vivo prior to use. Purification of hair follicle stem cells may be performed from cadavers, from healthy volunteers, or from patients undergoing plastic surgery. Upon extraction, scalp specimens are rinsed in a wash solution such as phosphate buffered saline or Hanks and cut into sections 0.2-0.8 cm. Subcutaneous tissue is de-aggregated into a single cell suspension by use of enzymes such as dispase and/or collagenase. In one variant, scalp samples are incubated with 0.5% dispase for a period of 15 hours. Subsequently, the dermal sheath is further enzymatically de-aggregated with enzymes such as collagenase D. Digestion of the stalk of the dermal papilla, the source of stem cells is confirmed by visual microscopy. Single cell suspensions are then treated with media containing fetal calf serum, and concentrated by pelletting using centrifugation. Cells may be further purified for expression of markers such as CD34, which are associated with enhanced proliferative ability. In one embodiment of the invention, collected hair follicle stem cells are induced to differentiate in vitro into neural-like cells through culture in media containing factors such as FGF-1, FGF-2, NGF, neurotrophin-2, and/or BDNF. Confirmation of neural differentiation may be performed by assessment of markers such as Muhashi, polysialyated N-CAM, N-CAM, A2B5, nestin, vimentin glutamate, synaptophysin, glutamic acid decarboxylase, serotonin, tyrosine hydroxylase, and GABA. Said neuronal cells may be administered systemically, or locally in a patient with degenerative disease. Differentiation towards other phenotypes may also be performed within the context of the current invention. The various embodiments of the invention for other stem cells described in this disclosure can also be applied for hair follicle stem cells.

In one embodiment of the invention, very early, immature stem cells are used in an allogeneic manner. Said stem cells being parthenogenically derived stem cells that can be generated by addition of a calcium flux inducing agent to activate oocytes, followed by purifying and expanding cells expressing embryonic stem cell markers such as SSEA-4, TRA 1-60 and/or TRA 1-81. Said parthenogenically derived stem cells are totipotent and can be used in a manner similar to that described other stem cells in the practice of the current invention. One specific methodology for generation of parthenogenically derived stem cells involves maturing oocytes by culture 36 hour in CMRL-1066 media supplemented with 20% FCS, 10 units/ml pregnant mare serum, 10 units/ml HCG, 0.05 mg/ml penicillin, and 0.075 mg/ml streptomycin. Mature metaphase II eggs are subsequently activated with calcium flux by incubation with 10 uM ionomycin for 8 minutes, followed by culture with 2 mM 6-dimethylaminopurine for 4 hours. The inner cell mass is subsequently isolated by immunosurgical technique and cells are cultured on a feeder layer in a manner similar to culture of embryonic stem cells (275). The various embodiments of the invention for other stem cells described in this disclosure can also be applied for parthenogenically derived stem cells.

Unique, tissue-specific stem cells may also be used in the allogeneic setting for the practice of the current invention. Cells expressing the ability to efflux certain dyes, including but not limited to rhodamin-123 are associated with stem cell-like properties (276). Said cells can be purified from tissue subsequent to cell dissociation, based on efflux properties. Accordingly, in one embodiment of the current invention, tissue derived side population cells may be utilized either freshly isolated, sorted into subpopulations, or subsequent to ex vivo culture, for the treatment of degenerative conditions. For use in the invention, side population cells may be derived from tissues such as pancreatic tissue, liver tissue, smooth muscle tissue, striated muscle tissue, cardiac muscle tissue, bone tissue, bone marrow tissue, bone spongy tissue, cartilage tissue, liver tissue, pancreas tissue, pancreatic ductal tissue, spleen tissue, thymus tissue, Peyer's patch tissue, lymph nodes tissue, thyroid tissue, epidermis tissue, dermis tissue, subcutaneous tissue, heart tissue, lung tissue, vascular tissue, endothelial tissue, blood cells, bladder tissue, kidney tissue, digestive tract tissue, esophagus tissue, stomach tissue, small intestine tissue, large intestine tissue, adipose tissue, uterus tissue, eye tissue, lung tissue, testicular tissue, ovarian tissue, prostate tissue, connective tissue, endocrine tissue, and mesentery tissue. Purification of side population cells can be performed, in one embodiment, by resuspending dissociated cardiac valve cells at 10⁶ cells/ml, and staining with 6.0 μg/ml of Hoechst 33342 in calcium- and magnesium-free HBSS+ (supplemented with 2% FCS, 10 mM Hepes, and 1% penicillin/streptomycin) medium for 90 min at 37° C. Cells are then run on a flow cytometer and assessed for efflux of Hoechst 33342. Purified cells may be assessed for ability to form cardiac spheres, this may be performed by suspending said side population cells at a density of 1-2×10⁶ cells/ml in 10-cm uncoated dishes in DME/M199 (1:1) serum-free growth medium containing insulin (25 μg/ml), transferin (100 μg/ml), progesterone (20 nM), sodium selenate (30 nM), putrescine (60 nM), recombinant murine EGF (20 ng/ml), and recombinant human FGF2. Half of the medium is changed every 3 d. Passaging may be performed using 0.05% trypsin and 0.53 mM EDTA-4Na every 7-14 d. Cardiospheres are then dissociated into a single-cell suspension then used either for therapeutic purposes, or for evaluating therapeutic ability in vitro or in animal models before clinical use. These methods have been described in other publications to which the practitioner of the invention is referred to (277-279). The various embodiments of the invention for other stem cells described in this disclosure can also be applied for side population stem cells.

### EXAMPLES

### Example 1

### Matching of Stem Cell Source with Recipient for Non-Preconditioned Allogeneic Transplant: Cord Blood

Umbilical cord blood is purified according to routine methods (280). Briefly, a 16-gauge needle from a standard Baxter 450-ml blood donor set containing CPD A anticoagulant (citrate/phosphate/dextrose/adenine) (Baxter Health Care, Deerfield, Ill.) is inserted and used to puncture the umbilical vein of a placenta obtained from healthy delivery from a mother tested for viral and bacterial infections according to international donor standards. Cord blood is allowed to drain by gravity so as to drip into the blood bag. The placenta is placed in a plastic-lined, absorbent cotton pad suspended from a specially constructed support frame in order to allow collection and reduce the contamination with maternal blood and other secretions, The 63 ml of CPD A used in the standard blood transfusion bag, calculated for 450 ml of blood, is reduced to 23 ml by draining 40 ml into a graduated cylinder just prior to collection. An aliquot of the cord blood is removed for safety testing according to the standards of the National Marrow Donor Program (NMDP) guidelines. Safety testing includes routine laboratory detection of human immunodeficiency virus 1 and 2, human T-cell lymphotropic virus I and II, Hepatitis B virus, Hepatitis C virus, Cytomegalovirus and Syphilis. Subsequently, 6% (wt/vol) hydroxyethyl starch is added to the anticoagulated cord blood to a final concentration of 1.2%. The leukocyte rich supernatant is then separated by centrifuging the cord blood hydroxyethyl starch mixture in the original collection blood bag (50×g for 5 min at 10° C.). The leukocyte-rich supernatant is transferred from the bag into a 150-ml Plasma Transfer bag (Baxter Health Care) and centrifuged (400×g for 10 min) to sediment the cells. Surplus supernatant plasma is transferred into a second plasma transfer bag without severing the connecting tube. Finally, the sedimented leukocytes are resuspended in supernatant plasma to a total volume of 20 ml. Approximately 5×10⁸-7×10⁹ nucleated cells are obtained per cord. Cells are cryopreserved according to the method described by Rubinstein et al (280).

A group of 25 cord blood stem cell sources, purified and cryopreserved as described above, is available for treatment of a patient in need of stem cell therapy. An aliquot of mononuclear cells from each of said 25 cord blood stem cell source is taken, said aliquot comprising approximately 10⁵ cells. Said cells are plated in Nunc 96-well plates at a concentration of 10⁴ cells per well in 9 wells in a volume of 100 uL per well. Prior to plating, said cells are washed and reconstituted in DMEM-LG media (Life Technologies), supplemented with 10% heat-inactivated fetal calf serum. Said cord blood cells are considered “stimulators” for the purpose of the matching procedure. In order to generate “responder” cells, 20 ml of peripheral blood is extracted from the patient in need of stem cell therapy through venipuncture. Said 20 ml of peripheral blood is heparinized by drawing in a heparinized Vacutainer™, is layered on Ficoll™ density gradient and centrifuged for approximately 60 minutes at 500 g. The mononuclear layer is harvested and washed in phosphate buffered saline supplemented with 3% fetal calf serum. For every 9 wells of stimulator cells, to 3 wells, a concentration of 10⁴ responder cells are added, to 3 wells a concentration of 10⁵ responder cells are added, and to 3 wells, media with no cells are added in order to have a control for spontaneous activity of stimulator cells. Responder cells are reconstituted in DMEM-LG media, supplemented with 10% heat-inactivated fetal calf serum before being added to stimulator cells. Responder cells and media comprise a volume of 100 uL before being added to stimulator cells. Additionally, in order to have a control for spontaneous activity of responder cells, 10⁴ and 10⁵ responder cells in a volume of 100 uL are added in triplicate to 100 uL of media without stimulator cells. To have a control for background or other contaminations, 3 wells are plated with 200 uL of media alone. Accordingly, the total culture consists of 25 stem cell sources×9 wells=225 wells, that is, a total of three 96-well plates are used. Additionally, 9 wells are used for the responder controls in which no stimulator cells, or no cells at all are added. Seventy-two-hour mixed lymphocyte reaction is performed and the cells were pulsed with 1 μCi [3H]thymidine for the last 18 h. The cultures are harvested onto glass fiber filters (Wallac, Turku, Finland). Radioactivity is counted using a Wallac 1450 Microbeta liquid scintillation counter and the data were analyzed with UltraTerm 3 software (Microsoft, Seattle, Wash.). If lymphocyte proliferation is more than 2 fold higher as compared to lymphocytes cultured without stimulator cells, when subtracting the background proliferation of stimulators alone, then the cord blood batch is not used for therapy. According to these criteria, 2 of the 25 batches of stem cell sources are chosen for administration into said patient. Interestingly, one of the 2 batches was a 3/6 mismatch for HLA with the recipient when matched for HLA-A, HLA-B, and HLA-DR.

### Example 2

### Decreasing Immunogenicity of Cord Blood Stem Cell Source

Cord blood is collected as described in the previous example. In order to further decrease immunogeneic components of said cord blood, as well as to significantly deplete T cells, which may be causative of GVHD, the following procedure is performed: cord blood mononuclear cells are concentrated in Good Manufacturing Practices (GMP) grade-Hanks balanced salt solution (containing Ca2+). Cells are washed previously to concentration so that said cells are substantially free from plasma and depleted of red blood cells and granulocytes. The volume of the mononuclear cell suspension is adjusted so that the cell density is approximately 3×10⁷/mL, and CAMPATH-1M is added to give a final concentration of 0.1 mg/mL. The mixture is incubated for 15 minutes at room temperature, and then recipient serum is added to achieve final concentration of 25% (vol/vol). The mixture is subsequently incubated for a further 30 minutes at 37° C. The treated cord blood cells are washed once, assessed for viability, and infused into a patient in need of therapy.

### Example 3

### Decreasing Immunogenicity of a Bone Marrow Derived Allogeneic Stem Cell Source

Bone marrow donors are chosen based on matching with a recipient in need of therapy through mixed lymphocyte culture as described in EXAMPLE I, with the exception that stimulator cells are lymphocytes derived from potential bone marrow donors. Bone marrow stem cell source is collected as follows: Patients are positioned face down on a horizontal platform and provided analgesics as per standard medical procedures. All personnel involved in the procedure are dressed in sterile surgical gowning and masks. The harvesting field comprising of both iliac crests is prepared by topically applying standard disinfectant solution. Iliac crests are anaesthetized and the harvesting needle is inserted in order to puncture the iliac crest. The cap and stylet of the harvesting needle is removed and 3-ml of marrow is harvested into the 15-ml harvesting syringe containing heparin solution. The process is repeated and the contents of the harvesting syringe are transferred into a 500-ml collecting bag. Approximately 75-125 ml of bone marrow is harvested in total. Isolation of mononuclear cells is performed by gradient separation using the Hetastarch method, which is clinically applicable and reported to remove not only erythrocytes but also granulocytic cells. The previously published method of Montuoro et al is used (281). Briefly, six-percent (wt/vol) Hetastarch (HES40, Hishiyama Pharmaceutical Co., Osaka, Japan) is added to the collected bone marrow sample to achieve a final concentration of 1.2 percent Hetastarch, (1:5 volume ratio of added Hetastarch to bone marrow). Centrifugation at 50 g for 5 min at 10° C. is performed in order to generate a leukocyte rich supernatant. Sedimentation of bone marrow takes place at a cell concentration of no more than 15×10⁶ cells/ml in a total volume of 850 ml per Hetastarch bag. The supernatant is transferred into a plasma transfer bag and centrifuged (400 g for 10 min) to sediment the cells. The sedimented cells are subsequently washed in phosphate buffered saline in the presence of 5% penicillin/streptomycin mixture (Gibco, Mississauga, Canada) and 5% autologous serum. Cellular viability and lack of potential contamination with other cells is assessed by microscopy. Bone marrow mononuclear cells are subsequently concentrated in Good Manufacturing Practices (GMP) grade-Hanks balanced salt solution (containing Ca2+). Cells are washed previously to concentration so that said cells are substantially free from plasma and depleted of red blood cells and granulocytes. The volume of the mononuclear cell suspension is adjusted so that the cell density is approximately 3×10⁷/mL, and CAMPATH-1M is added to give a final concentration of 0.1 mg/mL. The mixture is incubated for 15 minutes at room temperature, and then recipient serum is added to achieve final concentration of 25% (vol/vol). The mixture is subsequently incubated for a further 30 minutes at 37° C. The treated cord blood cells are washed once, assessed for viability, and infused into a patient in need of therapy.

### Example 4

### Treatment of Acute Stroke Patients

A clinical trial is performed using allogeneic cord blood stem cells that have been matched to recipients. Both purification of allogeneic cord blood stem cells and matching is performed as described in EXAMPLE 1. Furthermore stem cells are depleted significantly of T cells, B cells, and circulating dendritic cells as described in EXAMPLE 2.

A group of 50 patients in chosen. 25 patients serve as controls and 25 are placed in the treatment group. Patients in the control group and in the treatment group all receive typical standard of care. Inclusion criteria for participation in the trial are:
1. Subjects considered eligible to enter the study must sign an informed consent form prior to the initiation of any study procedures. In the event that the subject must be withdrawn and is re-screened for study participation at a later date, a new informed consent form must be signed.
2. Age 18-80 yrs.
3. Stroke is radiologically confirmed as ischemic no earlier than 24 hours and no later than 72 hours.
4. Infarct within the middle cerebral arterial territory
5. No significant pre-stroke disability
6. No other stroke in previous 3 months, Absence of major depression
7. Fugl-Meyer (FM) motor score of 23-83 out of 100
8. Functional Independence Measure (FIM) ambulation-subscore of 3 or more, and 50 foot walk takes longer than 15 seconds
9. Female subjects must be post-menopausal or sterilized, or if she is of childbearing potential, she is not breast feeding and she has no intention to become pregnant during the course of the study.
10. Ability to complete the study in compliance with the protocol.

Exclusion criteria for entry into the trial is:
1. Patients with malignancies, or a history of malignancies (with the exception of basal cell carcinoma (BCC) of the skin,) will be excluded from the study. Those patients with a history of BCC are eligible for enrollment, and will be monitored by a qualified dermatologist every 8 weeks for a period of 6 months for evaluation of their skin condition. Patients with existing BCC will be excluded from the study.
2. Acute infection
3. Significant daytime somnolence or any substantial decrease in alertness, language reception, or attention.
4. Renal insufficiency requiring dialysis or laboratory evidence of a serum creatinine greater than 2.0 mg/dl.
5. ALT or AST greater than 2 times the upper limit of the normal range.
6. Positive pregnancy test.
7. History of coagulation disorders including heparin-induced thrombocytopenia.
8. History of blood cell diseases.
9. Uncontrolled insulin-dependent diabetes mellitus.
10. Subjects having a concomitant life-threatening disease in which their life expectancy is estimated to be less than 2 years.
11. Any condition which in the opinion of investigator would interfere with the participant's ability to provide informed consent, comply with study instructions, possibly confound interpretation of study results, or endanger the participant if he/she took part in the trial.
12. Use of an investigational drug, device or product, or participation in another clinical trial.

Newly diagnosed stroke patients are immediately referred to a screening for inclusion into the trial. During the screening visit, patients are evaluated for general medical history, physical examination, vital signs (pulse, BP, respiratory rate, temperature), a 12-lead electrocardiogram, chest x-ray, and clinical laboratory tests (chemistry, hematology, urinalysis, HIV and hepatitis viral screening. Gait Velocity, Stroke Impact Scale-16 (SIS-16), National Institutes of Health Stroke Scale (NIHSS), Barthel index, modified Rankin score, as well as MRI neuroimaging will be performed as screening.

Following the screening, eligible patients are randomized into either the treatment or the control group. Randomization is performed using alteration between groups based on the sequence of entry. Determination if the first person enrolled into the trial is treated or untreated is performed by use of a coin toss. For example, the first patient enrolled enters the treatment group, the second the control group, the third the treatment group etc.

A stem cell dose of 5×10⁷ nucleated cord blood cells per kilogram (post CAMPATH depletion) is administered into patients in the treatment group. Cells are administered intravenously. Patients are follow-up at visits that occur at 4, 8, and 12 weeks post-initial cell dosing. At 4, 8, and 12 weeks post-initial cell dosing, patients are be assessed for safety by the following parameters: physical examination, routine laboratory assessments (including chemistry and hematology panel), and adverse event assessment. Efficacy assessment is performed by: Gait Velocity, Stroke Impact Scale-16 (SIS-16), National Institutes of Health Stroke Scale (NIHSS), Barthel index, and Modified Rankin score. MRI neuroimaging is performed both at study entry and at 12 weeks post initial cell dosing.

A statistically significant improvement in: Gait Velocity, Stroke Impact Scale-16 (SIS-16), National Institutes of Health Stroke Scale (NIHSS), Barthel index, and Modified Rankin score is observed in the treatment group as compared to the control group. Furthermore, MRI neuroimaging reveals that the area of neurological damage is substantially smaller than at onset in the treatment group but not the control group.

### Example 5

### Treatment of Chronic Stroke Patients

50 patients are selected for allogeneic stem cell therapy that have suffered from a major stroke more than 2 years prior to treatment. Cord blood stem cells are administered based on mixed lymphocyte matching, as described in EXAMPLE 1, but not depleted of T cells, B cells, or dendritic cells using CAMPATH. Cells are administered on a twice a month for the period of 2 months. Average cell concentration infused is 1×10⁷ nucleated cord blood cells per kilogram/per infusion. Cognitive function, Gait Velocity, and Barthel Index performance improve significantly in 43 of the 50 patients that are treated.

### Example 6

### Treatment of Multiple Sclerosis

20 patients with rapidly progressive multiple sclerosis by Proser criteria and at high risk for a fatal outcome who had no response to interferon, with patients being on interferon for at least 4 months, with Kurtzke Expanded Disability Status Scale (EDSS) score of 2-6 are chosen for treatment with allogeneic stem cell therapy. Cord blood stem cells are purified and matched as described in EXAMPLE 1, depleted significantly of T cells, B cells, and dendritic cells as described in EXAMPLE 2, and administered on a twice a month for the period of 2 months. Average cell concentration infused is 1×10⁷ nucleated cord blood cells per kilogram/per infusion. At 3 and 6 months after initiating stem cell therapy, gadolinium MRI scans and EDSS is evaluated and compared to baseline values prior to initiation of stem cell therapy. Significant improvement is observed in 17 of the 20 patients.

### Example 7

### Treatment of Amyotrophic Lateral Sclerosis

Currently no treatment exists for amyotrophic lateral sclerosis (ALS) that significantly alters disease progression. Given the previously described role of genetic abnormalities, for example deficiencies in Superoxide Dismutase (SOD) activity, as well as abnormal function of the Survival Motor Neuron (SMN) gene in ALS, a study is performed to treat confirmed ALS patients with allogeneic stem cell therapy. Within the context of the present invention, stem cell therapy is distinct than that used for other genetic diseases, such as for Krabbe disease since no immune suppressive conditioning is performed. A group of 20 patients are selected for treatment and 20 selected as controls, both groups administered standard of care. Eligibility for entry into the study includes: Definite-laboratory supported ALS according to the revised E1 Escorial World Federation of Neurology criteria, disease duration of more than 6 months and less than 36 months,

Vital capacity ≧70% of normal value (slow expiration, best of a minimum of three and a maximum of five measurements, with a respiratory function validly assessable and a spontaneous, non-assisted ventilation), Ages 18-85 years (inclusive), and no concomitant trial participation or serious illness. Patients are treated with allogeneic cord blood cells as described in EXAMPLE 6 with the exception that therapy is administered for 2 months followed by a 2 month rest, and repeated a total of 3 cycles. At 6, 12, 18, and 24 months patients are assessed for respiratory function by the ALS Functional Rating Scale-Respiratory, and for survival. At 24 months, 4 of the patients in the control group are alive, whereas 19 in the treated group are alive. A sustained increase in respiratory function is observed in 15 of the 20 treated patients but in none of the control patients.

One skilled in the art will appreciate that these methods, compositions, and cells are and may be adapted to carry out the objects and obtain the ends and advantages mentioned, as well as those inherent therein. The methods, procedures, and devices described herein are presently representative of preferred embodiments and are exemplary and are not intended as limitations on the scope of the invention. Changes therein and other uses will occur to those skilled in the art which are encompassed within the spirit of the invention and are defined by the scope of the disclosure. It will be apparent to one skilled in the art that varying substitutions and modifications may be made to the invention disclosed herein without departing from the scope and spirit of the invention. Those skilled in the art recognize that the aspects and embodiments of the invention set forth herein may be practiced separate from each other or in conjunction with each other. Therefore, combinations of separate embodiments are within the scope of the invention as disclosed herein. All patents and publications mentioned in the specification are indicative of the levels of those skilled in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations which is not specifically disclosed herein. Thus, for example, in each instance herein any of the terms “comprising,” “consisting essentially of” and “consisting of” may be replaced with either of the other two terms. The terms and expressions which have been employed are used as terms of description and not of limitation, and there is no intention that in the use of such terms and expressions indicates the exclusion of equivalents of the features shown and described or portions thereof. It is recognized that various modifications are possible within the scope of the invention disclosed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the disclosure.

### REFERENCES

1. Zhu, J., Wang, X., Chen, J., Sun, J., and Zhang, F. 2006. Reduced number and activity of circulating endothelial progenitor cells from patients with hyperhomocysteinemia. Arch Med Res 37:484-489.
2. Fulle, S., Di Donna, S., Puglielli, C., Pietrangelo, T., Beccafico, S., Bellomo, R., Protasi, F., and Fano, G. 2005. Age-dependent imbalance of the antioxidative system in human satellite cells. Exp Gerontol 40:189-197.
3. Porta, C., Caporali, R., Epis, O., Ramaioli, I., Invernizzi, R., Rovati, B., Comolli, G., Danova, M., and Montecucco, C. 2004. Impaired bone marrow hematopoietic progenitor cell function in rheumatoid arthritis patients candidated to autologous hematopoietic stem cell transplantation. Bone Marrow Transplant 33:721-728.
4. D'Ippolito, G., Schiller, P. C., Ricordi, C., Roos, B. A., and Howard, G. A. 1999. Age-related osteogenic potential of mesenchymal stromal stem cells from human vertebral bone marrow. J Bone Miner Res 14:1115-1122.
5. Hess, A. D., Bright, E. C., Thoburn, C., Vogelsang, G. B., Jones, R. J., and Kennedy, M. J. 1997. Specificity of effector T lymphocytes in autologous graft-versus-host disease: role of the major histocompatibility complex class II invariant chain peptide. Blood 89:2203-2209.
6. Miura, Y., Thoburn, C. J., Bright, E. C., Sommer, M., Lefell, S., Ueda, M., Nakao, S., and Hess, A. D. 2001. Characterization of the T-cell repertoire in autologous graft-versus-host disease (GVHD): evidence for the involvement of antigen-driven T-cell response in the development of autologous GVHD. Blood 98:868-876.
7. Halbrecht, J. 1939. Fresh and stored placental blood. Lancet 2:1263.
8. Ende, M., and Ende, N. 1972. Hematopoietic transplantation by means of fetal (cord) blood. A new method. Va Med Mon (1918) 99:276-280.
9. Fauser, A. A., and Messner, H. A. 1978. Granuloerythropoietic colonies in human bone marrow, peripheral blood, and cord blood. Blood 52:1243-1248.
10. Broxmeyer, H. E., Douglas, G. W., Hangoc, G., Cooper, S., Bard, J., English, D., Arny, M., Thomas, L., and Boyse, E. A. 1989. Human umbilical cord blood as a potential source of transplantable hematopoietic stem/progenitor cells. Proc Natl Acad Sci U S A 86:3828-3832.
11. Gluckman, E., Broxmeyer, H. A., Auerbach, A. D., Friedman, H. S., Douglas, G. W., Devergie, A., Esperou, H., Thierry, D., Socie, G., Lehn, P., et al. 1989. Hematopoietic reconstitution in a patient with Fanconi's anemia by means of umbilical-cord blood from an HLA-identical sibling. N Engl J Med 321:1174-1178.
12. O'Brien, T. A., Tiedemann, K., and Vowels, M. R. 2006. No longer a biological waste product: umbilical cord blood. Med J Aust 184:407-410.
13. Tse, W., and Laughlin, M. J. 2005. Umbilical cord blood transplantation: a new alternative option. Hematology (Am Soc Hematol Educ Program):377-383.
14. Rubinstein, P. 2006. Why cord blood? Hum Immunol 67:398-404.
15. Schoemans, H., Theunissen, K., Maertens, J., Boogaerts, M., Verfullie, C., and Wagner, J. 2006. Adult umbilical cord blood transplantation: a comprehensive review. Bone Marrow Transplant 38:83-93.
16. Bradley, M. B., and Cairo, M. S. 2005. Cord blood immunology and stem cell transplantation. Hum Immunol 66:431-446.
17. Koh, L. P. 2004. Unrelated umbilical cord blood transplantation in children and adults. Ann Acad Med Singapore 33:559-569.
18. Cornetta, K., Laughlin, M., Carter, S., Wall, D., Weinthal, J., Delaney, C., Wagner, J., Sweetman, R., McCarthy, P., and Chao, N. 2005. Umbilical cord blood transplantation in adults: results of the prospective Cord Blood Transplantation (COBLT). Biol Blood Marrow Transplant 11:149-160.
19. Schonberger, S., Niehues, T., Meisel, R., Bernbeck, B., Laws, H. J., Kogler, G., Enzmann, J., Wernet, P., Gobel, U., and Dilloo, D. 2004. Transplantation of haematopoietic stem cells derived from cord blood, bone marrow or peripheral blood: a single centre matched-pair analysis in a heterogeneous risk population. Klin Padiatr 216:356-363.
20. Lekakis, L., Giralt, S., Couriel, D., Shpall, E. J., Hosing, C., Khouri, I. F., Anderlini, P., Korbling, M., Martin, T., Champlin, R. E., et al. 2006. Phase II study of unrelated cord blood transplantation for adults with high-risk hematologic malignancies. Bone Marrow Transplant 38:421-426.
21. Tomonari, A., Takahashi, S., Ooi, J., Nakaoka, T., Takasugi, K., Uchiyama, M., Tsukada, N., Konuma, T., Iseki, T., Tojo, A., et al. 2006. Cord blood transplantation for acute myelogenous leukemia using a conditioning regimen consisting of granulocyte colony-stimulating factor-combined high-dose cytarabine, fludarabine, and total body irradiation. Eur J Haematol 77:46-50.
22. Laporte, J. P., Lesage, S., Portnoi, M. F., Landman, J., Rubinstein, P., Najman, A., and Gorin, N. C. 1998. Unrelated mismatched cord blood transplantation in patients with hematological malignancies: a single institution experience. Bone Marrow Transplant 22 Suppl 1:S76-77.
23. Sanz, G. F., Saavedra, S., Jimenez, C., Senent, L., Cervera, J., Planelles, D., Bolufer, P., Larrea, L., Martin, G., Martinez, J., et al. 2001. Unrelated donor cord blood transplantation in adults with chronic myelogenous leukemia: results in nine patients from a single institution. Bone Marrow Transplant 27:693-701.
24. Rocha, V., Labopin, M., Sanz, G., Arcese, W., Schwerdtfeger, R., Bosi, A., Jacobsen, N., Ruutu, T., de Lima, M., Finke, J., et al. 2004. Transplants of umbilical-cord blood or bone marrow from unrelated donors in adults with acute leukemia. N Engl J Med 351:2276-2285.
25. Laughlin, M. J., Barker, J., Bambach, B., Koc, O. N., Rizzieri, D. A., Wagner, J. E., Gerson, S. L., Lazarus, H. M., Cairo, M., Stevens, C. E., et al. 2001. Hematopoietic engraftment and survival in adult recipients of umbilical-cord blood from unrelated donors. N Engl J Med 344:1815-1822.
26. Chao, N. J., Liu, C. X., Rooney, B., Chen, B. J., Long, G. D., Vredenburgh, J. J., Morris, A., Gasparetto, C., and Rizzieri, D. A. 2002. Nonmyeloablative regimen preserves “niches” allowing for peripheral expansion of donor T-cells. Biol Blood Marrow Transplant 8:249-256.
27. Chao, N. J., Koh, L. P., Long, G. D., Gasparetto, C., Horwitz, M., Morris, A., Lassiter, M., Sullivan, K. M., and Rizzieri, D. A. 2004. Adult recipients of umbilical cord blood transplants after nonmyeloablative preparative regimens. Biol Blood Marrow Transplant 10:569-575.
28. Yuji, K., Miyakoshi, S., Kato, D., Miura, Y., Myojo, T., Murashige, N., Kishi, Y., Kobayashi, K., Kusumi, E., Narimatsu, H., et al. 2005. Reduced-intensity unrelated cord blood transplantation for patients with advanced malignant lymphoma. Biol Blood Marrow Transplant 11:314-318.
29. Perillo, A., Ferrandina, G., Pierelli, L., Bonanno, G., Scambia, G., and Mancuso, S. 2005. Stem cell-based treatments for gynecological solid tumors. Eur Rev Med Pharmacol Sci 9:93-102.
30. Archuleta, T. D., Devetten, M. P., and Armitage, J. O. 2004. Hematopoietic stem cell transplantation in hematologic malignancy. Panminerva Med 46:61-74.
31. Gluckman, E., Rocha, V., Arcese, W., Michel, G., Sanz, G., Chan, K. W., Takahashi, T. A., Ortega, J., Filipovich, A., Locatelli, F., et al. 2004. Factors associated with outcomes of unrelated cord blood transplant: guidelines for donor choice. Exp Hematol 32:397-407.
32. Wagner, J. E. 1998. Umbilical cord transplantation. Leukemia 12 Suppl 1:S30-32.
33. Styczynski, J., Cheung, Y. K., Garvin, J., Savage, D. G., Billote, G. B., Harrison, L., Skerrett, D., Wolownik, K., Wischhover, C., Hawks, R., et al. 2004. Outcomes of unrelated cord blood transplantation in pediatric recipients. Bone Marrow Transplant 34:129-136.
34. Wagner, J. E., Barker, J. N., DeFor, T. E., Baker, K. S., Blazar, B. R., Eide, C., Goldman, A., Kersey, J., Krivit, W., MacMillan, M. L., et al. 2002. Transplantation of unrelated donor umbilical cord blood in 102 patients with malignant and nonmalignant diseases: influence of CD34 cell dose and HLA disparity on treatment-related mortality and survival. Blood 100:1611-1618.
35. Jaroscak, J., Goltry, K., Smith, A., Waters-Pick, B., Martin, P. L., Driscoll, T. A., Howrey, R., Chao, N., Douville, J., Burhop, S., et al. 2003. Augmentation of umbilical cord blood (UCB) transplantation with ex vivo-expanded UCB cells: results of a phase 1 trial using the AastromReplicell System. Blood 101:5061-5067.
36. Barker, J. N., Weisdorf, D. J., DeFor, T. E., Blazar, B. R., McGlave, P. B., Miller, J. S., Verfullie, C. M., and Wagner, J. E. 2005. Transplantation of 2 partially HLA-matched umbilical cord blood units to enhance engraftment in adults with hematologic malignancy. Blood 105:1343-1347.
37. Magro, E., Regidor, C., Cabrera, R., Sanjuan, I., Fores, R., Garcia-Marco, J. A., Ruiz, E., Gil, S., Bautista, G., Millan, I., et al. 2006. Early hematopoietic recovery after single unit unrelated cord blood transplantation in adults supported by co-infusion of mobilized stem cells from a third party donor. Haematologica 91:640-648.
38. Kim, D. W., Chung, Y. J., Kim, T. G., Kim, Y. L., and Oh, I. H. 2004. Cotransplantation of third-party mesenchymal stromal cells can alleviate single-donor predominance and increase engraftment from double cord transplantation. Blood 103:1941-1948.
39. Knutsen, A. P., and Wall, D. A. 2000. Umbilical cord blood transplantation in severe T-cell immunodeficiency disorders: two-year experience. J Clin Immunol 20:466-476.
40. Bhattacharya, A., Slatter, M. A., Chapman, C. E., Barge, D., Jackson, A., Flood, T. J., Abinun, M., Cant, A. J., and Gennery, A. R. 2005. Single centre experience of umbilical cord stem cell transplantation for primary immunodeficiency. Bone Marrow Transplant 36:295-299.
41. Mao, P., Zhu, Z., Wang, H., Wang, S., Mo, W., Ying, Y., Li, Q., and Xu, Y. 2005. Sustained and stable hematopoietic donor-recipient mixed chimerism after unrelated cord blood transplantation for adult patients with severe aplastic anemia. Eur J Haematol 75:430-435.
42. Jaing, T. H., Hung, I. J., Yang, C. P., Chen, S. H., Sun, C. F., and Chow, R. 2005. Rapid and complete donor chimerism after unrelated mismatched cord blood transplantation in 5 children with beta-thalassemia major. Biol Blood Marrow Transplant 11:349-353.
43. Escolar, M. L., Poe, M. D., Provenzale, J. M., Richards, K. C., Allison, J., Wood, S., Wenger, D. A., Pietryga, D., Wall, D., Champagne, M., et al. 2005. Transplantation of umbilical-cord blood in babies with infantile Krabbe's disease. N Engl J Med 352:2069-2081.
44. Vanelli, P., Beltrami, S., Cesana, E., Cicero, D., Zaza, A., Rossi, E., Cicirata, F., Antona, C., and Clivio, A. 2004. Cardiac precursors in human bone marrow and cord blood: in vitro cell cardiogenesis. Ital Heart J 5:384-388.
45. Kadivar, M., Khatami, S., Mortazavi, Y., Shokrgozar, M. A., Taghikhani, M., and Soleimani, M. 2006. In vitro cardiomyogenic potential of human umbilical vein-derived mesenchymal stem cells. Biochem Biophys Res Commun 340:639-647.
46. Makino, S., Fukuda, K., Miyoshi, S., Konishi, F., Kodama, H., Pan, J., Sano, M., Takahashi, T., Hori, S., Abe, H., et al. 1999. Cardiomyocytes can be generated from marrow stromal cells in vitro. J Clin Invest 103:697-705.
47. Hakuno, D., Fukuda, K., Makino, S., Konishi, F., Tomita, Y., Manabe, T., Suzuki, Y., Umezawa, A., and Ogawa, S. 2002. Bone marrow-derived regenerated cardiomyocytes (CMG Cells) express functional adrenergic and muscarinic receptors. Circulation 105:380-386.
48. Pijnappels, D. A., Schalij, M. J., van Tuyn, J., Ypey, D. L., de Vries, A. A., van der Wall, E. E., van der Laarse, A., and Atsma, D. E. 2006. Progressive increase in conduction velocity across human mesenchymal stem cells is mediated by enhanced electrical coupling. Cardiovasc Res.
49. Wang, T., Xu, Z., Jiang, W., and Ma, A. 2006. Cell-to-cell contact induces mesenchymal stem cell to differentiate into cardiomyocyte and smooth muscle cell. Int J Cardiol 109:74-81.
50. Chang, M. G., Tung, L., Sekar, R. B., Chang, C. Y., Cysyk, J., Dong, P., Marban, E., and Abraham, M. R. 2006. Proarrhythmic potential of mesenchymal stem cell transplantation revealed in an in vitro coculture model. Circulation 113:1832-1841.
51. Petersen, B. E., Bowen, W. C., Patrene, K. D., Mars, W. M., Sullivan, A. K., Murase, N., Boggs, S. S., Greenberger, J. S., and Goff, J. P. 1999. Bone marrow as a potential source of hepatic oval cells. Science 284:1168-1170.
52. Tang, X. P., Zhang, M., Yang, X., Chen, L. M., and Zeng, Y. 2006. Differentiation of human umbilical cord blood stem cells into hepatocytes in vivo and in vitro. World J Gastroenterol 12:4014-4019.
53. Kang, X. Q., Zang, W. J., Bao, L. J., Li, D. L., Song, T. S., Xu, X. L., and Yu, X. J. 2005. Fibroblast growth factor-4 and hepatocyte growth factor induce differentiation of human umbilical cord blood-derived mesenchymal stem cells into hepatocytes. World J Gastroenterol 11:7461-7465.
54. Teramoto, K., Asahina, K., Kumashiro, Y., Kakinuma, S., Chinzei, R., Shimizu-Saito, K., Tanaka, Y., Teraoka, H., and Arii, S. 2005. Hepatocyte differentiation from embryonic stem cells and umbilical cord blood cells. J Hepatobiliary Pancreat Surg 12:196-202.
55. Yu, J., Zhang, F. T., Wan, H. J., Ye, J., Long, X., and Fang, J. Z. 2005. [Conversion of human umbilical cord blood-derived cells into hepatocyte-like cells in a culture system mimicking hepatic injury]. Beijing Da Xue Xue Bao 37:402-405.
56. Lee, K. D., Kuo, T. K., Whang-Peng, J., Chung, Y. F., Lin, C. T., Chou, S. H., Chen, J. R., Chen, Y. P., and Lee, O. K. 2004. In vitro hepatic differentiation of human mesenchymal stem cells. Hepatology 40:1275-1284.
57. Buzanska, L., Jurga, M., and Domanska-Janik, K. 2006. Neuronal differentiation of human umbilical cord blood neural stem-like cell line. Neurodegener Dis 3:19-26.
58. Buzanska, L., Jurga, M., Stachowiak, E. K., Stachowiak, M. K., and Domanska-Janik, K. 2006. Neural stem-like cell line derived from a nonhematopoietic population of human umbilical cord blood. Stem Cells Dev 15:391-406.
59. Yan, X. H., and Huang, R. B. 2006. [Differentiation of human umbilical cord blood mesenchymal stem cells toward neurons induced by baicalin in vitro]. Zhonghua Er Ke Za Zhi 44:214-219.
60. Jurga, M., Markiewicz, I., Sarnowska, A., Habich, A., Kozlowska, H., Lukomska, B., Buzanska, L., and Domanska-Janik, K. 2006. Neurogenic potential of human umbilical cord blood: neural-like stem cells depend on previous long-term culture conditions. J Neurosci Res 83:627-637.
61. Ortiz-Gonzalez, X. R., Keene, C. D., Verfullie, C. M., and Low, W. C. 2004. Neural induction of adult bone marrow and umbilical cord stem cells. Curr Neurovasc Res 1:207-213.
62. Chen, N., Hudson, J. E., Walczak, P., Misiuta, I., Garbuzova-Davis, S., Jiang, L., Sanchez-Ramos, J., Sanberg, P. R., Zigova, T., and Willing, A. E. 2005. Human umbilical cord blood progenitors: the potential of these hematopoietic cells to become neural. Stem Cells 23:1560-1570.
63. Fu, Y. S., Cheng, Y. C., Lin, M. Y., Cheng, H., Chu, P. M., Chou, S. C., Shih, Y. H., Ko, M. H., and Sung, M. S. 2006. Conversion of human umbilical cord mesenchymal stem cells in Wharton's jelly to dopaminergic neurons in vitro: potential therapeutic application for Parkinsonism. Stem Cells 24:115-124.
64. Liu, T. Y., Zhang, C., Xiao, L. L., Yao, X. L., Feng, S. W., and Zeng, Y. 2005. [Induced differentiation of human cord blood monocytes into neuron-like cells in vitro]. Di Yi Jun Yi Da Xue Xue Bao 25:152-155.
65. Walczak, P., Chen, N., Hudson, J. E., Willing, A. E., Garbuzova-Davis, S. N., Song, S., Sanberg, P. R., Sanchez-Ramos, J., Bickford, P. C., and Zigova, T. 2004. Do hematopoietic cells exposed to a neurogenic environment mimic properties of endogenous neural precursors? J Neurosci Res 76:244-254.
66. Hagiwara, H., Ohsawa, Y., Asakura, S., Murakami, T., Teshima, T., and Sunada, Y. 2006. Bone marrow transplantation improves outcome in a mouse model of congenital muscular dystrophy. FEBS Lett 580:4463-4468.
67. Feng, S. W., Zhang, C., Yao, X. L., Yu, M. J., Li, J. L., Chen, S. L., Liu, T. Y., and Lu, X. L. 2006. [Dystrophin expression in mdx mice after bone marrow stem cells transplantation]. Zhongguo Yi Xue Ke Xue Yuan Xue Bao 28:178-181.
68. Kong, K. Y., Ren, J., Kraus, M., Finklestein, S. P., and Brown, R. H., Jr. 2004. Human umbilical cord blood cells differentiate into muscle in sj1 muscular dystrophy mice. Stem Cells 22:981-993.
69. Brzoska, E., Grabowska, I., Hoser, G., Streminska, W., Wasilewska, D., Machaj, E. K., Pojda, Z., Moraczewski, J., and Kawiak, J. 2006. Participation of stem cells from human cord blood in skeletal muscle regeneration of SCID mice. Exp Hematol 34:1261-1269.
70. Ge, J., Li, Y., Qian, J., Shi, J., Wang, Q., Niu, Y., Fan, B. P., Liu, X., Zhang, S., Sun, A., et al. 2006. Efficacy of Emergent Transcatheter Transplantation of Stem Cells for Treatment of Acute Myocardial Infarction (TCT-STAMI). Heart.
71. Pudil, R., Vojadek, J., Filip, S., Mericka, P., St'asek, J., Strakova, H., Vokurkova, D., Solar, M., Mokry, J., Dominik, J., et al. 2005. Transplantation of bone marrow derived progenitor cells in acute myocardial infarction. The first results. Acta Medica (Hradec Kralove) 48:153-155.
72. Janssens, S., Theunissen, K., Boogaerts, M., and Van de Werf, F. 2006. Bone marrow cell transfer in acute myocardial infarction. Nat Clin Pract Cardiovasc Med 3 Suppl 1:S69-72.
73. Archundia, A., Aceves, J. L., Lopez-Hernandez, M., Alvarado, M., Rodriguez, E., Diaz Quiroz, G., Paez, A., Rojas, F. M., and Montano, L. F. 2005. Direct cardiac injection of G-CSF mobilized bone-marrow stem-cells improves ventricular function in old myocardial infarction. Life Sci 78:279-283.
74. Hirata, Y., Sata, M., Motomura, N., Takanashi, M., Suematsu, Y., Ono, M., and Takamoto, S. 2005. Human umbilical cord blood cells improve cardiac function after myocardial infarction. Biochem Biophys Res Commun 327:609-614.
75. Leor, J., Guetta, E., Feinberg, M. S., Galski, H., Bar, I., Holbova, R., Miller, L., Zarin, P., Castel, D., Barbash, I. M., et al. 2006. Human umbilical cord blood-derived CD133+ cells enhance function and repair of the infarcted myocardium. Stem Cells 24:772-780.
76. Ott, I., Keller, U., Knoedler, M., Gotze, K. S., Doss, K., Fischer, P., Urlbauer, K., Debus, G., von Bubnoff, N., Rudelius, M., et al. 2005. Endothelial-like cells expanded from CD34+ blood cells improve left ventricular function after experimental myocardial infarction. Faseb J 19:992-994.
77. Kim, B. O., Tian, H., Prasongsukarn, K., Wu, J., Angoulvant, D., Wnendt, S., Muhs, A., Spitkovsky, D., and Li, R. K. 2005. Cell transplantation improves ventricular function after a myocardial infarction: a preclinical study of human unrestricted somatic stem cells in a porcine model. Circulation 112:196-104.
78. Ma, N., Ladilov, Y., Moebius, J. M., Ong, L., Piechaczek, C., David, A., Kaminski, A., Choi, Y. H., Li, W., Egger, D., et al. 2006. Characterization of two populations of mesenchymal progenitor cells in umbilical cord blood. Cardiovasc Res 71:158-169.
79. Min, J. J., Ahn, Y., Moon, S., Kim, Y. S., Park, J. E., Kim, S. M., Le, U. N., Wu, J. C., Joo, S. Y., Hong, M. H., et al. 2006. In vivo bioluminescence imaging of cord blood derived mesenchymal stem cell transplantation into rat myocardium. Ann Nucl Med 20:165-170.
80. Ishikawa, F., Shimazu, H., Shultz, L. D., Fukata, M., Nakamura, R., Lyons, B., Shimoda, K., Shimoda, S., Kanemaru, T., Nakamura, K., et al. 2006. Purified human hematopoietic stem cells contribute to the generation of cardiomyocytes through cell fusion. Faseb J 20:950-952.
81. Ma, N., Stamm, C., Kaminski, A., Li, W., Kleine, H. D., Muller-Hilke, B., Zhang, L., Ladilov, Y., Egger, D., and Steinhoff, G. 2005. Human cord blood cells induce angiogenesis following myocardial infarction in NOD/scid-mice. Cardiovasc Res 66:45-54.
82. Botta, R., Gao, E., Stassi, G., Bonci, D., Pelosi, E., Zwas, D., Patti, M., Colonna, L., Baiocchi, M., Coppola, S., et al. 2004. Heart infarct in NOD-SCID mice: therapeutic vasculogenesis by transplantation of human CD34+ cells and low dose CD34+KDR+ cells. Faseb J 18:1392-1394.
83. Bogousslaysky, J., Victor, S. J., Salinas, E. O., Pallay, A., Donnan, G. A., Fieschi, C., Kaste, M., Orgogozo, J. M., Chamorro, A., and Desmet, A. 2002. Fiblast (trafermin) in acute stroke: results of the European-Australian phase II/III safety and efficacy trial. Cerebrovasc Dis 14:239-251.
84. http://www.strokecenter.org/trials/TrialDetail.aspx?tid=48.
85. Kondziolka, D., Wechsler, L., Goldstein, S., Meltzer, C., Thulborn, K. R., Gebel, J Jannetta, P., DeCesare, S., Elder, E. M., McGrogan, M., et al. 2000. Transplantation of cultured human neuronal cells for patients with stroke. Neurology 55:565-569.
86. Meltzer, C. C., Kondziolka, D., Villemagne, V. L., Wechsler, L., Goldstein, S., Thulborn, K. R., Gebel, J., Elder, E. M., DeCesare, S., and Jacobs, A. 2001. Serial [18F] fluorodeoxyglucose positron emission tomography after human neuronal implantation for stroke. Neurosurgery 49:586-591; discussion 591-582.
87. Fan, C. G., Zhang, Q. J., Tang, F. W., Han, Z. B., Wang, G. S., and Han, Z. C. 2005. Human umbilical cord blood cells express neurotrophic factors. Neurosci Lett 380:322-325.
88. Habich, A., Jurga, M., Markiewicz, I., Lukomska, B., Bany-Laszewicz, U., and Domanska-Janik, K. 2006. Early appearance of stem/progenitor cells with neural-like characteristics in human cord blood mononuclear fraction cultured in vitro. Exp Hematol 34:914-925.
89. Willing, A. E., Lixian, J., Milliken, M., Poulos, S., Zigova, T., Song, S., Hart, C., Sanchez-Ramos, J., and Sanberg, P. R. 2003. Intravenous versus intrastriatal cord blood administration in a rodent model of stroke. J Neurosci Res 73:296-307.
90. Vendrame, M., Cassady, J., Newcomb, J., Butler, T., Pennypacker, K. R., Zigova, T., Sanberg, C. D., Sanberg, P. R., and Willing, A. E. 2004. Infusion of human umbilical cord blood cells in a rat model of stroke dose-dependently rescues behavioral deficits and reduces infarct volume. Stroke 35:2390-2395.
91. Xiao, J., Nan, Z., Motooka, Y., and Low, W. C. 2005. Transplantation of a novel cell line population of umbilical cord blood stem cells ameliorates neurological deficits associated with ischemic brain injury. Stem Cells Dev 14:722-733.
92. Ereniev, S. I., Semchenko, V. V., Sysheva, E. V., Bogdashin, I. V., Shapovalova, V. V., Khizhnyak, A. S., and Gasanenko, L. N. 2005. Effect of allo- and xenotransplantation of embryonic nervous tissue and umbilical cord blood-derived stem cells on structural and functional state of cerebral cortex of albino rats in posttraumatic period. Bull Exp Biol Med 140:612-615.
93. Newman, M. B., Willing, A. E., Manresa, J. J., Davis-Sanberg, C., and Sanberg, P. R. 2005. Stroke-induced migration of human umbilical cord blood cells: time course and cytokines. Stem Cells Dev 14:576-586.
94. Chen, S. H., Chang, F. M., Tsai, Y. C., Huang, K. F., Lin, C. L., and Lin, M. T. 2006. Infusion of human umbilical cord blood cells protect against cerebral ischemia and damage during heatstroke in the rat. Exp Neurol 199:67-76.
95. Vendrame, M., Gemma, C., de Mesquita, D., Collier, L., Bickford, P. C., Sanberg, C. D., Sanberg, P. R., Pennypacker, K. R., and Willing, A. E. 2005. Anti-inflammatory effects of human cord blood cells in a rat model of stroke. Stem Cells Dev 14:595-604.
96. Naruse, K., Hamada, Y., Nakashima, E., Kato, K., Mizubayashi, R., Kamiya, H., Yuzawa, Y., Matsuo, S., Murohara, T., Matsubara, T., et al. 2005. Therapeutic neovascularization using cord blood-derived endothelial progenitor cells for diabetic neuropathy. Diabetes 54:1823-1828.
97. Taguchi, A., Soma, T., Tanaka, H., Kanda, T., Nishimura, H., Yoshikawa, H., Tsukamoto, Y., Iso, H., Fujimori, Y., Stern, D. M., et al. 2004. Administration of CD34+ cells after stroke enhances neurogenesis via angiogenesis in a mouse model. J Clin Invest 114:330-338.
98. Borlongan, C. V., Hadman, M., Sanberg, C. D., and Sanberg, P. R. 2004. Central nervous system entry of peripherally injected umbilical cord blood cells is not required for neuroprotection in stroke. Stroke 35:2385-2389.
99. Garbuzova-Davis, S., Gografe, S. J., Sanberg, C. D., Willing, A. E., Saporta, S., Cameron, D. F., Desjarlais, T., Daily, J., Kuzmin-Nichols, N., Chamizo, W., et al. 2006. Maternal transplantation of human umbilical cord blood cells provides prenatal therapy in Sanfilippo type B mouse model. Faseb J 20:485-487.
100. Garbuzova-Davis, S., Willing, A. E., Desjarlais, T., Davis Sanberg, C., and Sanberg, P. R. 2005. Transplantation of human umbilical cord blood cells benefits an animal model of Sanfilippo syndrome type B. Stem Cells Dev 14:384-394.
101. Yoshida, S., Ishikawa, F., Kawano, N., Shimoda, K., Nagafuchi, S., Shimoda, S., Yasukawa, M., Kanemaru, T., Ishibashi, H., Shultz, L. D., et al. 2005. Human cord blood—derived cells generate insulin-producing cells in vivo. Stem Cells 23:1409-1416.
102. Ende, N., Chen, R., and Reddi, A. S. 2004. Effect of human umbilical cord blood cells on glycemia and insulitis in type 1 diabetic mice. Biochem Biophys Res Commun 325:665-669.
103. Turrini, P., Monego, G., Gonzalez, J., Cicuzza, S., Bonanno, G., Zelano, G., Rosenthal, N., Paonessa, G., Laufer, R., and Padron, J. 2005. Human hepatocytes in mice receiving pre-immune injection with human cord blood cells. Biochem Biophys Res Commun 326:66-73.
104. Di Campli, C., Piscaglia, A. C., Pierelli, L., Rutella, S., Bonanno, G., Alison, M. R., Mariotti, A., Vecchio, F. M., Nestola, M., Monego, G., et al. 2004. A human umbilical cord stem cell rescue therapy in a murine model of toxic liver injury. Dig Liver Dis 36:603-613.
105. Almeida-Porada, G., Porada, C. D., Chamberlain, J., Torabi, A., and Zanjani, E. D. 2004. Formation of human hepatocytes by human hematopoietic stem cells in sheep. Blood 104:2582-2590.
106. Sharma, A. D., Cantz, T., Richter, R., Eckert, K., Henschler, R., Wilkens, L., Jochheim-Richter, A., Arseniev, L., and Ott, M. 2005. Human cord blood stem cells generate human cytokeratin 18-negative hepatocyte-like cells in injured mouse liver. Am J Pathol 167:555-564.
107. Nonome, K., Li, X. K., Takahara, T., Kitazawa, Y., Funeshima, N., Yata, Y., Xue, F., Kanayama, M., Shinno, E., Kuwae, C., et al. 2005. Human umbilical cord blood-derived cells differentiate into hepatocyte-like cells in the Fas-mediated liver injury model. Am J Physiol Gastrointest Liver Physiol 289:G1091-1099.
108. Piscaglia, A. C., Di Campli, C., Zocco, M. A., Di Gioacchino, G., Novi, M., Rutella, S., Bonanno, G., Monego, G., Vecchio, F. M., Michetti, F., et al. 2005. Human cordonal stem cell intraperitoneal injection can represent a rescue therapy after an acute hepatic damage in immunocompetent rats. Transplant Proc 37:2711-2714.
109. Ende, N., Chen, R., and Reddi, A. S. 2006. Administration of human umbilical cord blood cells delays the onset of prostate cancer and increases the lifespan of the TRAMP mouse. Cancer Lett 231:123-128.
110. http://www.clinicaltrials.gov/ct/show/NCT00305344?order=1.
111. Vaananen, H. K. 2005. Mesenchymal stem cells. Ann Med 37:469-479.
112. Knippenberg, M., Helder, M. N., Doulabi, B. Z., Semeins, C. M., Wuisman, P. I., and Klein-Nulend, J. 2005. Adipose tissue-derived mesenchymal stem cells acquire bone cell-like responsiveness to fluid shear stress on osteogenic stimulation. Tissue Eng 11:1780-1788.
113. Portmann-Lanz, C. B., Schoeberlein, A., Huber, A., Sager, R., Malek, A., Holzgreve, W., and Surbek, D. V. 2006. Placental mesenchymal stem cells as potential autologous graft for pre- and perinatal neuroregeneration. Am J Obstet Gynecol 194:664-673.
114. Zhang, X., Mitsuru, A., Igura, K., Takahashi, K., Ichinose, S., Yamaguchi, S., and Takahashi, T. A. 2006. Mesenchymal progenitor cells derived from chorionic villi of human placenta for cartilage tissue engineering. Biochem Biophys Res Commun 340:944-952.
115. Shih, D. T., Lee, D. C., Chen, S. C., Tsai, R. Y., Huang, C. T., Tsai, C. C., Shen, E. Y., and Chiu, W. T. 2005. Isolation and characterization of neurogenic mesenchymal stem cells in human scalp tissue. Stem Cells 23:1012-1020.
116. De Ugarte, D. A., Alfonso, Z., Zuk, P. A., Elbarbary, A., Zhu, M., Ashjian, P., Benhaim, P., Hedrick, M. H., and Fraser, J. K. 2003. Differential expression of stem cell mobilization-associated molecules on multi-lineage cells from adipose tissue and bone marrow. Immunol Lett 89:267-270.
117. Tondreau, T., Meuleman, N., Delforge, A., Dejeneffe, M., Leroy, R., Massy, M., Mortier, C., Bron, D., and Lagneaux, L. 2005. Mesenchymal stem cells derived from CD133-positive cells in mobilized peripheral blood and cord blood: proliferation, Oct4 expression, and plasticity. Stem Cells 23:1105-1112.
118. Jeong, J. A., Gang, E. J., Hong, S. H., Hwang, S. H., Kim, S. W., Yang, I. H., Ahn, C., Han, H., and Kim, H. 2004. Rapid neural differentiation of human cord blood-derived mesenchymal stem cells. Neuroreport 15:1731-1734.
119. Hong, S. H., Gang, E. J., Jeong, J. A., Ahn, C., Hwang, S. H., Yang, I. H., Park, H. K., Han, H., and Kim, H. 2005. In vitro differentiation of human umbilical cord blood-derived mesenchymal stem cells into hepatocyte-like cells. Biochem Biophys Res Commun 330:1153-1161.
120. Hutson, E. L., Boyer, S., and Genever, P. G. 2005. Rapid isolation, expansion, and differentiation of osteoprogenitors from full-term umbilical cord blood. Tissue Eng 11:1407-1420.
121. http://www.osiristx.com/clinical_trials.php.
122. Bensidhoum, M., Chapel, A., Francois, S., Demarquay, C., Mazurier, C., Fouillard, L., Bouchet, S., Bertho, J. M., Gourmelon, P., Aigueperse, J., et al. 2004. Homing of in vitro expanded Stro-1- or Stro-1+ human mesenchymal stem cells into the NOD/SCID mouse and their role in supporting human CD34 cell engraftment. Blood 103:3313-3319.
123. Le Blanc, K., and Ringden, 0.2006. Mesenchymal stem cells: properties and role in clinical bone marrow transplantation. Curr Opin Immunol.
124. Lazarus, H. M., Koc, O. N., Devine, S. M., Curtin, P., Maziarz, R. T., Holland, H. K., Shpall, E. J., McCarthy, P., Atkinson, K., Cooper, B. W., et al. 2005. Cotransplantation of HLA-identical sibling culture-expanded mesenchymal stem cells and hematopoietic stem cells in hematologic malignancy patients. Biol Blood Marrow Transplant 11:389-398.
125. Liu, J., Lu, X. F., Wan, L., Li, Y. P., Li, S. F., Zeng, L. Y., Zeng, Y. Z., Cheng, L. H., Lu, Y. R., and Cheng, J. Q. 2004. Suppression of human peripheral blood lymphocyte proliferation by immortalized mesenchymal stem cells derived from bone marrow of Banna Minipig inbred-line. Transplant Proc 36:3272-3275.
126. Togel, F., Hu, Z., Weiss, K., Isaac, J., Lange, C., and Westenfelder, C. 2005. Administered mesenchymal stem cells protect against ischemic acute renal failure through differentiation-independent mechanisms. Am J Physiol Renal Physiol 289:F31-42.
127. Hofmann, M., Wollert, K. C., Meyer, G. P., Menke, A., Arseniev, L., Hertenstein, B., Ganser, A., Knapp, W. H., and Drexler, H. 2005. Monitoring of bone marrow cell homing into the infarcted human myocardium. Circulation 111:2198-2202.
128. Bhattacharya, N. 2006. Spontaneous transient rise of CD34 cells in peripheral blood after 72 hours in patients suffering from advanced malignancy with anemia: effect and prognostic implications of treatment with placental umbilical cord whole blood transfusion. Eur J Gynaecol Oncol 27:286-290.
129. Corso, A., Lorenzi, A., Zappasodi, P., Invernizzi, R., Vanelli, L., and Lazzarino, M. 2003. Early changes in bone marrow morphology induced by thalidomide in refractory myeloma patients. Haematologica 88:958-960.
130. De Felice, L., Tatarelli, C., Mascolo, M. G., Gregorj, C., Agostini, F., Fiorini, R., Gelmetti, V., Pascale, S., Padula, F., Petrucci, M. T., et al. 2005. Histone deacetylase inhibitor valproic acid enhances the cytokine-induced expansion of human hematopoietic stem cells. Cancer Res 65:1505-1513.
131. Araki, H., Mahmud, N., Milhem, M., Nunez, R., Xu, M., Beam, C. A., and Hoffman, R. 2006. Expansion of human umbilical cord blood SCID-repopulating cells using chromatin-modifying agents. Exp Hematol 34:140-149.
132. Suzuki, M., Harashima, A., Okochi, A., Yamamoto, M., Nakamura, S., Motoda, R., Yamasaki, F., and Orita, K. 2004. 5-Azacytidine supports the long-term repopulating activity of cord blood CD34(+) cells. Am J Hematol 77:313-315.
133. Shyu, W. C., Lee, Y. J., Liu, D. D., Lin, S. Z., and Li, H. 2006. Homing genes, cell therapy and stroke. Front Biosci 11:899-907.
134. Fricker, S. P., Anastassov, V., Cox, J., Darkes, M. C., Grujic, O., Idzan, S. R., Labrecque, J., Lau, G., Mosi, R. M., Nelson, K. L., et al. 2006. Characterization of the molecular pharmacology of AMD3100: a specific antagonist of the G-protein coupled chemokine receptor, CXCR4. Biochem Pharmacol 72:588-596.
135. Son, B. R., Marquez-Curtis, L. A., Kucia, M., Wysoczynski, M., Turner, A. R., Ratajczak, J., Ratajczak, M. Z., and Janowska-Wieczorek, A. 2006. Migration of bone marrow and cord blood mesenchymal stem cells in vitro is regulated by stromal-derived factor-1-CXCR4 and hepatocyte growth factor-c-met axes and involves matrix metalloproteinases. Stem Cells 24:1254-1264.
136. Paczkowska, E., Larysz, B., Rzeuski, R., Karbicka, A., Jalowinski, R., Kornacewicz-Jach, Z., Ratajczak, M. Z., and Machalinski, B. 2005. Human hematopoietic stem/progenitor-enriched CD34(+) cells are mobilized into peripheral blood during stress related to ischemic stroke or acute myocardial infarction. Eur J Haematol 75:461-467.
137. http://www.clinicaltrials.gov/ct/show/NCT00362414?order=1.
138. Theunissen, K., and Verfaillie, C. M. 2005. A multifactorial analysis of umbilical cord blood, adult bone marrow and mobilized peripheral blood progenitors using the improved ML-IC assay. Exp Hematol 33:165-172.
139. Ng, Y. Y., van Kessel, B., Lokhorst, H. M., Baert, M. R., van den Burg, C. M., Bloem, A. C., and Staal, F. J. 2004. Gene-expression profiling of CD34+ cells from various hematopoietic stem-cell sources reveals functional differences in stem-cell activity. J Leukoc Biol 75:314-323.
140. Hogan, C. J., Shpall, E. J., McNulty, O., McNiece, I., Dick, J. E., Shultz, L. D., and Keller, G. 1997. Engraftment and development of human CD34(+)-enriched cells from umbilical cord blood in NOD/LtSz-scid/scid mice. Blood 90:85-96.
141. Sakabe, H., Yahata, N., Kimura, T., Zeng, Z. Z., Minamiguchi, H., Kaneko, H., Mori, K. J., Ohyashiki, K., Ohyashiki, J. H., Toyama, K., et al. 1998. Human cord blood-derived primitive progenitors are enriched in CD34+c-kit-cells: correlation between long-term culture-initiating cells and telomerase expression. Leukemia 12:728-734.
142. Yeh, E. T., Zhang, S., Wu, H. D., Korbling, M., Willerson, J. T., and Estrov, Z. 2003. Transdifferentiation of human peripheral blood CD34+-enriched cell population into cardiomyocytes, endothelial cells, and smooth muscle cells in vivo. Circulation 108:2070-2073.
143. Sigurjonsson, O. E., Perreault, M. C., Egeland, T., and Glover, J. C. 2005. Adult human hematopoietic stem cells produce neurons efficiently in the regenerating chicken embryo spinal cord. Proc Natl Acad Sci USA 102:5227-5232.
144. Ryu, K. H., Cho, S. J., Jung, Y. J., Seoh, J. Y., Kie, J. H., Koh, S. H., Kang, H. J., Ahn, H. S., and Shin, H. Y. 2004. In vitro generation of functional dendritic cells from human umbilical cord blood CD34+ cells by a 2-step culture method. Int J Hematol 80:281-286.
145. Liu, F., Pan, X., Chen, G., Jiang, D., Cong, X., Fei, R., and Wei, L. 2006. Hematopoietic stem cells mobilized by granulocyte colony-stimulating factor partly contribute to liver graft regeneration after partial orthotopic liver transplantation. Liver Transpl 12:1129-1137.
146. Zeng, F., Chen, M. J., Baldwin, D. A., Gong, Z. J., Yan, J. B., Qian, H., Wang, J., Jiang, X., Ren, Z. R., Sun, D., et al. 2006. Multiorgan engraftment and differentiation of human cord blood CD34+Lin-cells in goats assessed by gene expression profiling. Proc Natl Acad Sci USA 103:7801-7806.
147. Hess, D., Li, L., Martin, M., Sakano, S., Hill, D., Strutt, B., Thyssen, S., Gray, D. A., and Bhatia, M. 2003. Bone marrow-derived stem cells initiate pancreatic regeneration. Nat Biotechnol 21:763-770.
148. Machalinski, B., Paczkowska, E., Koziarska, D., and Ratajczak, M. Z. 2006. Mobilization of human hematopoietic stem/progenitor-enriched CD34+ cells into peripheral blood during stress related to ischemic stroke. Folia Histochem Cytobiol 44:97-101.
149. Kucia, M., Zhang, Y. P., Reca, R., Wysoczynski, M., Machalinski, B., Majka, M., Ildstad, S. T., Ratajczak, J., Shields, C. B., and Ratajczak, M. Z. 2006. Cells enriched in markers of neural tissue-committed stem cells reside in the bone marrow and are mobilized into the peripheral blood following stroke. Leukemia 20:18-28.
150. Wojakowski, W., Tendera, M., Zebzda, A., Michalowska, A., Majka, M., Kucia, M., Maslankiewicz, K., Wyderka, R., Krol, M., Ochala, A., et al. 2006. Mobilization of CD34(+), CD117(+), CXCR4(+), c-met(+) stem cells is correlated with left ventricular ejection fraction and plasma NT-proBNP levels in patients with acute myocardial infarction. Eur Heart J 27:283-289.
151. Hildbrand, P., Cirulli, V., Prinsen, R. C., Smith, K. A., Torbett, B. E., Salomon, D. R., and Crisa, L. 2004. The role of angiopoietins in the development of endothelial cells from cord blood CD34+ progenitors. Blood 104:2010-2019.
152. Salven, P., Mustjoki, S., Alitalo, R., Alitalo, K., and Rafii, S. 2003. VEGFR-3 and CD133 identify a population of CD34+ lymphatic/vascular endothelial precursor cells. Blood 101:168-172.
153. Cho, S. W., Gwak, S. J., Kang, S. W., Bhang, S. H., Song, K. W., Yang, Y. S., Choi, C. Y., and Kim, B. S. 2006. Enhancement of Angiogenic Efficacy of Human Cord Blood Cell Transplantation. Tissue Eng.
154. Le Ricousse-Roussanne, S., Barateau, V., Contreres, J. O., Boval, B., Kraus-Berthier, L., and Tobelem, G. 2004. Ex vivo differentiated endothelial and smooth muscle cells from human cord blood progenitors home to the angiogenic tumor vasculature. Cardiovasc Res 62:176-184.
155. Tomonari, A., Tojo, A., Takahashi, T., Iseki, T., Ooi, J., Takahashi, S., Nagamura, F., Uchimaru, K., and Asano, S. 2004. Resolution of Behcet's disease after HLA-mismatched unrelated cord blood transplantation for myelodysplastic syndrome. Ann Hematol 83:464-466.
156. Mayer, H., Bertram, H., Lindenmaier, W., Korff, T., Weber, H., and Weich, H. 2005. Vascular endothelial growth factor (VEGF-A) expression in human mesenchymal stem cells: autocrine and paracrine role on osteoblastic and endothelial differentiation. J Cell Biochem 95:827-839.
157. Liu, C. H., and Hwang, S. M. 2005. Cytokine interactions in mesenchymal stem cells from cord blood. Cytokine 32:270-279.
158. Gang, E. J., Jeong, J. A., Han, S., Yan, Q., Jeon, C. J., and Kim, H. 2006. In vitro endothelial potential of human UC blood-derived mesenchymal stem cells. Cytotherapy 8:215-227.
159. Zimmerman, R. A., and Bilaniuk, L. T. 2006. Neuroimaging evaluation of cerebral palsy. Clin Perinatol 33:517-544.
160. Rossignol, D. A., and Rossignol, L. W. 2006. Hyperbaric oxygen therapy may improve symptoms in autistic children. Med Hypotheses 67:216-228.
161. Arata, H., Takashima, H., Hirano, R., Tomimitsu, H., Machigashira, K., Izumi, K., Kikuno, M., Ng, A. R., Umehara, F., Arisato, T., et al. 2006. Early clinical signs and imaging findings in Gerstmann-Straussler-Scheinker syndrome (Pro102Leu). Neurology 66:1672-1678.
162. Matsumoto, R., Omura, T., Yoshiyama, M., Hayashi, T., Inamoto, S., Koh, K. R., Ohta, K., Izumi, Y., Nakamura, Y., Akioka, K., et al. 2005. Vascular endothelial growth factor-expressing mesenchymal stem cell transplantation for the treatment of acute myocardial infarction. Arterioscler Thromb Vasc Biol 25:1168-1173.
163. Klein, S., Roghani, M., and Rifkin, D. B. 1997. Fibroblast growth factors as angiogenesis factors: new insights into their mechanism of action. Exs 79:159-192.
164. Chen, C. H., Poucher, S. M., Lu, J., and Henry, P. D. 2004. Fibroblast growth factor 2: from laboratory evidence to clinical application. Curr Vasc Pharmacol 2:33-43.
165. Grines, C., Rubanyi, G. M., Kleiman, N. S., Marrott, P., and Watkins, M. W. 2003. Angiogenic gene therapy with adenovirus 5 fibroblast growth factor-4 (Ad5FGF-4): a new option for the treatment of coronary artery disease. Am J Cardiol 92:24 N-31N.
166. Dufourcq, P., Couffinhal, T., Ezan, J., Barandon, L., Moreau, C., Daret, D., and Duplaa, C. 2002. FrzA, a secreted frizzled related protein, induced angiogenic response. Circulation 106:3097-3103.
167. Morisada, T., Kubota, Y., Urano, T., Suda, T., and Oike, Y. 2006. Angiopoietins and angiopoietin-like proteins in angiogenesis. Endothelium 13:71-79.
168. Le Blanc, K., Rasmusson, I., Sundberg, B., Gotherstrom, C., Hassan, M., Uzunel, M., and Ringden, O. 2004. Treatment of severe acute graft-versus-host disease with third party haploidentical mesenchymal stem cells. Lancet 363:1439-1441.
169. Liu, L., Sun, Z., Chen, B., Han, Q., Liao, L., Jia, M., Cao, Y., Ma, J., Sun, Q., Guo, M., et al. 2006. Ex vivo expansion and in vivo infusion of bone marrow-derived Flk-1+CD31-CD34-mesenchymal stem cells: feasibility and safety from monkey to human. Stem Cells Dev 15:349-357.
170. Taupin, P. 2006. OTI-010 Osiris Therapeutics/JCR Pharmaceuticals. Curr Opin Investig Drugs 7:473-481.
171. http://www.clinicaltrials.gov/ct/show/NCT00366145?order=7.
172. http://www.clinicaltrials.gov/ct/show/NCT00114452?order=5.
173. Kern, S., Eichler, H., Stoeve, J., Kluter, H., and Bieback, K. 2006. Comparative Analysis of Mesenchymal Stem Cells from Bone Marrow, Umbilical Cord Blood or Adipose Tissue. Stem Cells.
174. Motomura, H., Ohashi, N., Harada, T., Muraoka, M., and Ishii, M. 2006. Aggressive conservative therapy for refractory ulcer with diabetes and/or arteriosclerosis. J Dermatol 33:353-359.
175. Zhao, Y., Wang, H., and Mazzone, T. 2006. Identification of stem cells from human umbilical cord blood with embryonic and hematopoietic characteristics. Exp Cell Res 312:2454-2464.
176. Kogler, G., Sensken, S., Airey, J. A., Trapp, T., Muschen, M., Feldhahn, N., Liedtke, S., Sorg, R. V., Fischer, J., Rosenbaum, C., et al. 2004. A new human somatic stem cell from placental cord blood with intrinsic pluripotent differentiation potential. J Exp Med 200:123-135.
177. Jansen, J. H., Fibbe, W. E., Willemze, R., and Kluin-Nelemans, J. C. 1990. Interleukin-4. A regulatory protein. Blut 60:269-274.
178. Zhou, X., Schmidtke, P., Zepp, F., and Meyer, C. U. 2005. Boosting interleukin-10 production: therapeutic effects and mechanisms. Curr Drug Targets Immune Endocr Metabol Disord 5:465-475.
179. Mentink-Kane, M. M., and Wynn, T. A. 2004. Opposing roles for IL-13 and IL-13 receptor alpha 2 in health and disease. Immunol Rev 202:191-202.
180. Kriegel, M. A., Li, M. O., Sanjabi, S., Wan, Y. Y., and Flavell, R. A. 2006. Transforming growth factor-beta: recent advances on its role in immune tolerance. Curr Rheumatol Rep 8:138-144.
181. Fernandez-Botran, R., Crespo, F. A., and Sun, X. 2002. Soluble cytokine receptors in biological therapy. Expert Opin Biol Ther 2:585-605.
182. Dayer, J. M. 2002. Evidence for the biological modulation of IL-1 activity: the role of IL-1Ra. Clin Exp Rheumatol 20:S14-20.
183. Rouas-Freiss, N., Moreau, P., Ferrone, S., and Carosella, E. D. 2005. HLA-G proteins in cancer: do they provide tumor cells with an escape mechanism? Cancer Res 65:10139-10144.
184. Bohana-Kashtan, O., and Civin, C. I. 2004. Fas ligand as a tool for immunosuppression and generation of immune tolerance. Stem Cells 22:908-924.
185. Okazaki, T., and Honjo, T. 2006. The PD-1-PD-L pathway in immunological tolerance. Trends Immunol 27:195-201.
186. Longhi, M. P., Harris, C. L., Morgan, B. P., and Gallimore, A. 2006. Holding T cells in check—a new role for complement regulators? Trends Immunol 27:102-108.
187. Wahl, S. M., Orenstein, J. M., and Chen, W. 2000. TGF-beta influences the life and death decisions of T lymphocytes. Cytokine Growth Factor Rev 11:71-79.
188. Mellor, A. L., and Munn, D. H. 2004. IDO expression by dendritic cells: tolerance and tryptophan catabolism. Nat Rev Immunol 4:762-774.
189. Serafini, P., Borrello, I., and Bronte, V. 2006. Myeloid suppressor cells in cancer: recruitment, phenotype, properties, and mechanisms of immune suppression. Semin Cancer Biol 16:53-65′.
190. Borras, F. E., Matthews, N. C., Lowdell, M. W., and Navarrete, C. V. 2001. Identification of both myeloid CD11c+ and lymphoid CD11c-dendritic cell subsets in cord blood. Br J Haematol 113:925-931.
191. Kawano, Y., Noma, T., and Yata, J. 1984. Analysis of decreased autologous mixed lymphocyte reaction of cord blood lymphocytes: with special reference to production of and response to interleukin-2 (IL-2). Asian Pac J Allergy Immunol 2:49-55.
192. Petty, R. E., and Hunt, D. W. 1998. Neonatal dendritic cells. Vaccine 16:1378-1382.
193. Sorg, R. V., Kogler, G., and Wernet, P. 1999. Identification of cord blood dendritic cells as an immature CD11c-population. Blood 93:2302-2307.
194. Han, P., McDonald, T., and Hodge, G. 2004. Potential immaturity of the T-cell and antigen-presenting cell interaction in cord blood with particular emphasis on the CD40-CD40 ligand costimulatory pathway. Immunology 113:26-34.
195. Drohan, L., Harding, J. J., Holm, B., Cordoba-Tongson, E., Dekker, C. L., Holmes, T., Maecker, H., and Mellins, E. D. 2004. Selective developmental defects of cord blood antigen-presenting cell subsets. Hum Immunol 65:1356-1369.
196. De Wit, D., Tonon, S., Olislagers, V., Goriely, S., Boutriaux, M., Goldman, M., and Willems, F. 2003. Impaired responses to toll-like receptor 4 and toll-like receptor 3 ligands in human cord blood. J Autoimmun 21:277-281.
197. Mainali, E. S., and Tew, J. G. 2004. Dexamethasone selectively inhibits differentiation of cord blood stem cell derived-dendritic cell (DC) precursors into immature DCs. Cell Immunol 232:127-136.
198. Wong, O. H., Huang, F. P., and Chiang, A. K. 2005. Differential responses of cord and adult blood-derived dendritic cells to dying cells. Immunology 116:13-20.
199. Navarro, V., Herrine, S., Katopes, C., Colombe, B., and Spain, C. V. 2006. The effect of HLA class I (A and B) and class II (DR) compatibility on liver transplantation outcomes: an analysis of the OPTN database. Liver Transpl 12:652-658.
200. Li, G., Kim, Y. J., and Broxmeyer, H. E. 2005. Macrophage colony-stimulating factor drives cord blood monocyte differentiation into IL-10(high)IL-12 absent dendritic cells with tolerogenic potential. J Immunol 174:4706-4717.
201. Murphy, E., Imahashi, K., and Steenbergen, C. 2005. Bcl-2 regulation of mitochondrial energetics. Trends Cardiovasc Med 15:283-290.
202. Harada, H., and Grant, S. 2003. Apoptosis regulators. Rev Clin Exp Hematol 7:117-138. 138.
203. Guegan, C., Braudeau, J., Couriaud, C., Dietz, G. P., Lacombe, P., Bahr, M., Nosten-Bertrand, M., and Onteniente, B. 2006. PTD-XIAP protects against cerebral ischemia by anti-apoptotic and transcriptional regulatory mechanisms. Neurobiol Dis 22:177-186.
204. Gansuvd, B., Hagihara, M., Higuchi, A., Ueda, Y., Tazume, K., Tsuchiya, T., Munkhtuvshin, N., Kato, S., and Hotta, T. 2003. Umbilical cord blood dendritic cells are a rich source of soluble HLA-DR: synergistic effect of exosomes and dendritic cells on autologous or allogeneic T-Cell proliferation. Hum Immunol 64:427-439.
205. Kim, S. H., Lechman, E. R., Bianco, N., Menon, R., Keravala, A., Nash, J., Mi, Z., Watkins, S. C., Gambotto, A., and Robbins, P. D. 2005. Exosomes derived from IL-10-treated dendritic cells can suppress inflammation and collagen-induced arthritis. J Immunol 174:6440-6448.
206. Martinez-Lorenzo, M. J., Anel, A., Gamen, S., Monle n, I., Lasierra, P., Larrad, L., Pineiro, A., Alava, M. A., and Naval, J. 1999. Activated human T cells release bioactive Fas ligand and APO2 ligand in microvesicles. J Immunol 163:1274-1281.
207. Gur, H., Krauthgamer, R., Berrebi, A., Klein, T., Nagler, A., Tabilio, A., Martelli, M. F., and Reisner, Y. 2002. Tolerance induction by megadose hematopoietic progenitor cells: expansion of veto cells by short-term culture of purified human CD34(+) cells. Blood 99:4174-4181.
208. Reisner, Y., Gur, H., Reich-Zeliger, S., Martelli, M. F., and Bachar-Lustig, E. 2003. Hematopoietic stem cell transplantation across major genetic barriers: tolerance induction by megadose CD34 cells and other veto cells. Ann N Y Acad Sci 996:72-79.
209. Donckier, V., Troisi, R., Toungouz, M., Colle, I., Van Vlierberghe, H., Jacquy, C., Martiat, P., Stordeur, P., Zhou, L., Boon, N., et al. 2004. Donor stem cell infusion after non-myeloablative conditioning for tolerance induction to HLA mismatched adult living-donor liver graft. Transpl Immunol 13:139-146.
210. George, J. F., Sweeney, S. D., Kirklin, J. K., Simpson, E. M., Goldstein, D. R., and Thomas, J. M. 1998. An essential role for Fas ligand in transplantation tolerance induced by donor bone marrow. Nat Med 4:333-335.
211. Reisner, Y., Gur, H., Reich-Zeliger, S., Martelli, M. F., and Bachar-Lustig, E. 2004. Crossing the HLA barriers. Blood Cells Mol Dis 33:206-210.
212. Deng, W., Han, Q., Liao, L., Li, C., Ge, W., Zhao, Z., You, S., Deng, H., and Zhao, R. C. 2004. Allogeneic bone marrow-derived flk-1+Sca-1-mesenchymal stem cells leads to stable mixed chimerism and donor-specific tolerance. Exp Hematol 32:861-867.
213. Kadri, T., Lataillade, J. J., Doucet, C., Marie, A., Ernou, I., Bourin, P., Joubert-Caron, R., Caron, M., and Lutomski, D. 2005. Proteomic study of Galectin-1 expression in human mesenchymal stem cells. Stem Cells Dev 14:204-212.
214. Ryan, J. M., Barry, F. P., Murphy, J. M., and Mahon, B. P. 2005. Mesenchymal stem cells avoid allogeneic rejection. J Inflamm (Lond) 2:8.
215. Beyth, S., Borovsky, Z., Mevorach, D., Liebergall, M., Gazit, Z., Aslan, H., Galun, E., and Rachmilewitz, J. 2005. Human mesenchymal stem cells alter antigen-presenting cell maturation and induce T-cell unresponsiveness. Blood 105:2214-2219.
216. Aggarwal, S., and Pittenger, M. F. 2005. Human mesenchymal stem cells modulate allogeneic immune cell responses. Blood 105:1815-1822.
217. Plumas, J., Chaperot, L., Richard, M. J., Molens, J. P., Bensa, J. C., and Favrot, M. C. 2005. Mesenchymal stem cells induce apoptosis of activated T cells. Leukemia 19:1597-1604.
218. Maccario, R., Podesta, M., Moretta, A., Cometa, A., Comoli, P., Montagna, D., Daudt, L., Ibatici, A., Piaggio, G., Pozzi, S., et al. 2005. Interaction of human mesenchymal stem cells with cells involved in alloantigen-specific immune response favors the differentiation of CD4+ T-cell subsets expressing a regulatory/suppressive phenotype. Haematologica 90:516-525.
219. Zappia, E., Casazza, S., Pedemonte, E., Benvenuto, F., Bonanni, I., Gerdoni, E., Giunti, D., Ceravolo, A., Cazzanti, F., Frassoni, F., et al. 2005. Mesenchymal stem cells ameliorate experimental autoimmune encephalomyelitis inducing T-cell anergy. Blood 106:1755-1761.
220. Frey, O., and Brauer, R. 2006. Regulatory T cells: magic bullets for immunotherapy? Arch Immunol Ther Exp (Warsz) 54:33-43.
221. Satwani, P., Ayello, J., Ven, C., O'Neill, A. F., Simpson, L. L., Baxi, L., and Cairo, M. S. 2005. Immaturity of IL-18 gene expression and protein production in cord blood (CB) versus peripheral blood (PB) mononuclear cells and differential effects in natural killer (NK) cell development and function. Br J Haematol 130:284-292.
222. Wei, Y. M., Cao, Q., Zhou, H. Y., Xia, R., Lan, J. C., Meng, F. Y., and Bai, H. 2005. Ex vivo expansion of T, NK and CD34+ cells from umbilical cord blood. Zhongguo Shi Yan Xue Ye Xue Za Zhi 13:1076-1081.
223. Okada, H., Nagamura-Inoue, T., Mori, Y., and Takahashi, T. A. 2006. Expansion of Valpha24(+)Vbeta 11(+) NKT cells from cord blood mononuclear cells using IL-15, IL-7 and Flt3-L depends on monocytes. Eur J Immunol 36:236-244.
224. Kadowaki, N., Antonenko, S., Ho, S., Rissoan, M. C., Soumelis, V., Porcelli, S. A., Lanier, L. L., and Liu, Y. J. 2001. Distinct cytokine profiles of neonatal natural killer T cells after expansion with subsets of dendritic cells. J Exp Med 193:1221-1226.
225. Subauste, C. S., Chung, J. Y., Do, D., Koniaris, A. H., Hunter, C. A., Montoya, J. G., Porcelli, S., and Remington, J. S. 1995. Preferential activation and expansion of human peripheral blood gamma delta T cells in response to Toxoplasma gondii in vitro and their cytokine production and cytotoxic activity against T. gondii-infected cells. J Clin Invest 96:610-619.
226. Liu, E., Law, H. K., and Lau, Y. L. 2004. Tolerance associated with cord blood transplantation may depend on the state of host dendritic cells. Br J Haematol 126:517-526.
227. Papadogiannakis, N., Johnsen, S. A., and Olding, L. B. 1986. Monocyte-regulated hyporesponsiveness of human cord blood lymphocytes to OKT3-monoclonal-antibody-induced mitogenesis. Scand J Immunol 23:91-99.
228. Chen, L., Cohen, A. C., and Lewis, D. B. 2006. Impaired allogeneic activation and T-helper 1 differentiation of human cord blood naive CD4 T cells. Biol Blood Marrow Transplant 12:160-171.
229. Hodge, S., Hodge, G., Flower, R., and Han, P. 2001. Cord blood leucocyte expression of functionally significant molecules involved in the regulation of cellular immunity. Scand J Immunol 53:72-78.
230. Canto, E., Rodriguez-Sanchez, J. L., and Vidal, S. 2005. Naive CD4+ cells from cord blood can generate competent Th effector cells. Transplantation 80:850-858.
231. Marleau, A. M., and Sarvetnick, N. 2005. T cell homeostasis in tolerance and immunity. J Leukoc Biol 78:575-584.
232. Hickman, S. P., and Turka, L. A. 2005. Homeostatic T cell proliferation as a barrier to T cell tolerance. Philos Trans R Soc Lond B Biol Sci 360:1713-1721.
233. Rosenberg, S. A., and Dudley, M. E. 2004. Cancer regression in patients with metastatic melanoma after the transfer of autologous antitumor lymphocytes. Proc Natl Acad Sci USA 101 Suppl 2:14639-14645.
234. Ichim, T. E., Zhong, R., and Min, W. P. 2003. Prevention of allograft rejection by in vitro generated tolerogenic dendritic cells. Transpl Immunol 11:295-306.
235. Zenclussen, A. C. 2006. Regulatory T cells in pregnancy. Springer Semin Immunopathol 28:31-39.
236. Fritzsching, B., Oberle, N., Pauly, E., Geffers, R., Buer, J., Poschl, J., Krammer, P., Linderkamp, O., and Suri-Payer, E. 2006. Naive regulatory T cells: a novel subpopulation defined by resistance towards CD95L-mediated cell death. Blood.
237. Godfrey, W. R., Spoden, D. J., Ge, Y. G., Baker, S. R., Liu, B., Levine, B. L., June, C. H., Blazar, B. R., and Porter, S. B. 2005. Cord blood CD4(+)CD25(+)-derived T regulatory cell lines express FoxP3 protein and manifest potent suppressor function. Blood 105:750-758.
238. Takahata, Y., Nomura, A., Takada, H., Ohga, S., Furuno, K., Hikino, S., Nakayama, H., Sakaguchi, S., and Hara, T. 2004. CD25+CD4+ T cells in human cord blood: an immunoregulatory subset with naive phenotype and specific expression of forkhead box p3 (Foxp3) gene. Exp Hematol 32:622-629.
239. Sakaguchi, S., Ono, M., Setoguchi, R., Yagi, H., Hori, S., Fehervari, Z., Shimizu, J., Takahashi, T., and Nomura, T. 2006. Foxp3CD25CD4 natural regulatory T cells in dominant self-tolerance and autoimmune disease. Immunol Rev 212:8-27.
240. Torgerson, T. R. 2006. Regulatory T cells in human autoimmune diseases. Springer Semin Immunopathol 28:63-76.
241. Hassall, O., Bedu-Addo, G., Adarkwa, M., Danso, K., and Bates, I. 2003. Umbilical-cord blood for transfusion in children with severe anaemia in under-resourced countries. Lancet 361:678-679.
242. Bhattacharya, N. 2005. Placental umbilical cord whole blood transfusion: a safe and genuine blood substitute for patients of the under-resourced world at emergency. J Am Coll Surg 200:557-563.
243. Bhattacharya, N. 2006. Placental umbilical cord whole blood transfusion to combat anemia in the background of tuberculosis and emaciation and its potential role as an immuno-adjuvant therapy for the under-resourced people of the world. Clin Exp Obstet Gynecol 33:99-104.
244. Bhattacharya, N. 2006. Placental umbilical cord blood transfusion: A novel method of treatment of patients with malaria in the background of anemia. Clin Exp Obstet Gynecol 33:39-43.
245. Bhattacharya, N. 2006. Placental umbilical cord whole blood transfusion to combat anemia in the background of advanced rheumatoid arthritis and emaciation and its potential role as immunoadjuvant therapy. Clin Exp Obstet Gynecol 33:28-33.
246. Bhattacharya, N. 2006. A preliminary study of placental umbilical cord whole blood transfusion in under resourced patients with malaria in the background of anaemia. Malar J 5:20.
247. Bhattacharya, N. 2006. A preliminary report of 123 units of placental umbilical cord whole blood transfusion in HIV-positive patients with anemia and emaciation. Clin Exp Obstet Gynecol 33:117-121.
248. Ito, K., Tanaka, T., Tsutsumi, N., Obata, F., and Kashiwagi, N. 1999. Possible mechanisms of immunotherapy for maintaining pregnancy in recurrent spontaneous aborters: analysis of anti-idiotypic antibodies directed against autologous T-cell receptors. Hum Reprod 14:650-655.
249. Smith, J. B., Cowchock, F. S., Lata, J. A., and Hankinson, B. T. 1992. The number of cells used for immunotherapy of repeated spontaneous abortion influences pregnancy outcome. J Reprod Immunol 22:217-224.
250. Porter, D., and Levine, J. E. 2006. Graft-versus-host disease and graft-versus-leukemia after donor leukocyte infusion. Semin Hematol 43:53-61.
251. Szpakowski, A., Malinowski, A., Glowacka, E., Wilczynski, J. R., Kolasa, D., Dynski, M., Tchorzewski, H., Zeman, K., and Szpakowski, M. 2000. [The influence of paternal lymphocyte immunization on the balance of Th1/Th2 type reactivity in women with unexplained recurrent spontaneous abortion]. Ginekol Pol 71:586-592.
252. Hayakawa, S., Karasaki-Suzuki, M., Itoh, T., Ishii, M., Kanaeda, T., Nagai, N., Takahashi-Yamamoto, N., Tochigi, M., Chishima, F., Fujii, T. K., et al. 2000. Effects of paternal lymphocyte immunization on peripheral Th1/Th2 balance and TCR V beta and V gamma repertoire usage of patients with recurrent spontaneous abortions. Am J Reprod Immunol 43:107-115.
253. Starzl, T. E., Murase, N., Demetris, A., Trucco, M., and Fung, J. 2000. The mystique of hepatic tolerogenicity. Semin Liver Dis 20:497-510.
254. Nierhoff, D., Horvath, H. C., Mytilineos, J., Golling, M., Bud, O., Klar, E., Opelz, G., Voso, M. T., Ho, A. D., Haas, R., et al. 2000. Microchimerism in bone marrow-derived CD34(+) cells of patients after liver transplantation. Blood 96:763-767.
255. Lo, Y. M., Lo, E. S., Watson, N., Noakes, L., Sargent, I. L., Thilaganathan, B., and Wainscoat, J. S. 1996. Two-way cell traffic between mother and fetus: biologic and clinical implications. Blood 88:4390-4395.
256. Bianchi, D. W., Zickwolf, G. K., Weil, G. J., Sylvester, S., and DeMaria, M. A. 1996. Male fetal progenitor cells persist in maternal blood for as long as 27 years postpartum. Proc Natl Acad Sci USA 93:705-708.
257. O'Donoghue, K., Chan, J., de la Fuente, J., Kennea, N., Sandison, A., Anderson, J. R., Roberts, I. A., and Fisk, N. M. 2004. Microchimerism in female bone marrow and bone decades after fetal mesenchymal stem-cell trafficking in pregnancy. Lancet 364:179-182.
258. Khosrotehrani, K., and Bianchi, D. W. 2005. Multi-lineage potential of fetal cells in maternal tissue: a legacy in reverse. J Cell Sci 118:1559-1563.
259. Johnson, K. L., Samura, O., Nelson, J. L., McDonnell, M.d. W. M., and Bianchi, D. W. 2002. Significant fetal cell microchimerism in a nontransfused woman with hepatitis C: Evidence of long-term survival and expansion. Hepatology 36:1295-1297.
260. Srivatsa, B., Srivatsa, S., Johnson, K. L., Samura, O., Lee, S. L., and Bianchi, D. W. 2001. Microchimerism of presumed fetal origin in thyroid specimens from women: a case-control study. Lancet 358:2034-2038.
261. Khosrotehrani, K., Johnson, K. L., Cha, D. H., Salomon, R. N., and Bianchi, D. W. 2004. Transfer of fetal cells with multilineage potential to maternal tissue. Jama 292:75-80.
262. Khosrotehrani, K., Stroh, H., Bianchi, D. W., and Johnson, K. L. 2003. Combined FISH and immunolabeling on paraffin-embedded tissue sections for the study of microchimerism. Biotechniques 34:242-244.
263. Khosrotehrani, K., and Bianchi, D. W. 2003. Fetal cell microchimerism: helpful or harmful to the parous woman? Curr Opin Obstet Gynecol 15:195-199.
264. Wang, Y., Iwatani, H., Ito, T., Horimoto, N., Yamato, M., Matsui, I., Imai, E., and Hori, M. 2004. Fetal cells in mother rats contribute to the remodeling of liver and kidney after injury. Biochem Biophys Res Commun 325:961-967.
265. Tan, X. W., Liao, H., Sun, L., Okabe, M., Xiao, Z. C., and Dawe, G. S. 2005. Fetal microchimerism in the maternal mouse brain: a novel population of fetal progenitor or stem cells able to cross the blood-brain barrier? Stem Cells 23:1443-1452.
266. Williams, R. J., Clarke, E., Blair, A., Evely, R., Hale, G., Waldmann, H., Brookes, S., and Pamphilon, D. H. 2000. Impact on T-cell depletion and CD34+ cell recovery using humanised CD52 monoclonal antibody (CAMPATH-1H) in BM and PSBC collections; comparison with CAMPATH-1M and CAMPATH-1G. Cytotherapy 2:5-14.
267. Gennery, A. R., Dickinson, A. M., Brigham, K., Barge, D., Spickett, G. P., Curtis, A., Spencer, V., Jackson, A., Cavanagh, G., Carter, V., et al. 2001. CAMPATH-1M T-cell depleted BMT for SCID: long-term follow-up of 19 children treated 1987-98 in a single center. Cytotherapy 3:221-232.
268. Klangsinsirikul, P., Carter, G. I., Byrne, J. L., Hale, G., and Russell, N. H. 2002. Campath-1G causes rapid depletion of circulating host dendritic cells (DCs) before allogeneic transplantation but does not delay donor DC reconstitution. Blood 99:2586-2591.
269. Ratzinger, G., Reagan, J. L., Heller, G., Busam, K. J., and Young, J. W. 2003. Differential CD52 expression by distinct myeloid dendritic cell subsets: implications for alemtuzumab activity at the level of antigen presentation in allogeneic graft-host interactions in transplantation. Blood 101:1422-1429.
270. Coulombe, M., Yang, H., Wolf, L. A., and Gill, R. G. 1999. Tolerance to antigen-presenting cell-depleted islet allografts is CD4 T cell dependent. J Immunol 162:2503-2510.
271. Bossolasco, P., Montemurro, T., Cova, L., Zangrossi, S., Calzarossa, C., Buiatiotis, S., Soligo, D., Bosari, S., Silani, V., Deliliers, G. L., et al. 2006. Molecular and phenotypic characterization of human amniotic fluid cells and their differentiation potential. Cell Res 16:329-336.
272. Sartore, S., Lenzi, M., Angelini, A., Chiavegato, A., Gasparotto, L., De Coppi, P., Bianco, R., and Gerosa, G. 2005. Amniotic mesenchymal cells autotransplanted in a porcine model of cardiac ischemia do not differentiate to cardiogenic phenotypes. Eur J Cardiothorac Surg 28:677-684.
273. Prusa, A. R., Marton, E., Rosner, M., Bettelheim, D., Lubec, G., Pollack, A., Bernaschek, G., and Hengstschlager, M. 2004. Neurogenic cells in human amniotic fluid. Am J Obstet Gynecol 191:309-314.
274. Tsai, M. S., Hwang, S. M., Tsai, Y. L., Cheng, F. C., Lee, J. L., and Chang, Y. J. 2006. Clonal amniotic fluid-derived stem cells express characteristics of both mesenchymal and neural stem cells. Biol Reprod 74:545-551.
275. Vrana, K. E., Hipp, J. D., Goss, A. M., McCool, B. A., Riddle, D. R., Walker, S. J., Wettstein, P. J., Studer, L. P., Tabar, V., Cunniff, K., et al. 2003. Nonhuman primate parthenogenetic stem cells. Proc Natl Acad Sci USA 100 Suppl 1:11911-11916.
276. Forbes, S. J., and Alison, M. R. 2006. Side population (SP) cells: taking center stage in regeneration and liver cancer? Hepatology 44:23-26.
277. Meissner, K., Heydrich, B., Jedlitschky, G., Meyer Zu Schwabedissen, H., Mosyagin, I., Dazert, P., Eckel, L., Vogelgesang, S., Warzok, R. W., Bohm, M., et al. 2006. The ATP-binding cassette transporter ABCG2 (BCRP), a marker for side population stem cells, is expressed in human heart. J Histochem Cytochem 54:215-221.
278. Asakura, A., and Rudnicki, M. A. 2002. Side population cells from diverse adult tissues are capable of in vitro hematopoietic differentiation. Exp Hematol 30:1339-1345.
279. Hierlihy, A. M., Seale, P., Lobe, C. G., Rudnicki, M. A., and Megeney, L. A. 2002. The post-natal heart contains a myocardial stem cell population. FEBS Lett 530:239-243.
280. Rubinstein, P., Dobrila, L., Rosenfield, R. E., Adamson, J. W., Migliaccio, G., Migliaccio, A. R., Taylor, P. E., and Stevens, C. E. 1995. Processing and cryopreservation of placental/umbilical cord blood for unrelated bone marrow reconstitution. Proc Natl Acad Sci USA 92:10119-10122.
281. Montuoro, A., De Rosa, L., Del Monte, C., Blandino, F., Pandolfi, A., Lanti, T., and De Laurenzi, A. 1991. A technique for isolation of bone marrow cells using hydroxyethyl starch (HES) sedimentation agent. Haematologica 76 Suppl 1:7-9.

1. A method of allogeneic stem cell therapy without preconditioning of the recipient comprising:
a) matching a patient with a stem cell source
b) manipulating the stem cell source; and
c) administering said stem cell source.

2. A method of treating a disease using allogeneic stem cell therapy without preconditioning of the recipient comprising:
a) matching a patient with a stem cell source
b) manipulating the stem cell source; and
c) administering said stem cell source.

3. A method of treating a disease using allogeneic stem cell therapy without preconditioning of the recipient comprising:
a) selecting a patient that has not been preconditioned; and
b) administering a stem cell source.

4. The method of claim 2, wherein said disease is selected from a group consisting of: inflammatory, neurological, gastrointestinal, dermatological, urological, respiratory, and cardiac diseases.

5. The method of claim 4, wherein said disease is neural degeneration.

6. The method of claim 5 wherein said neurological disease is selected from a group consisting of: autism, Asperger syndrome, acute stroke, chronic stroke, transient ischemic episodes, Rett syndrome, autism spectrum disorder, childhood disintegrative disorder, amyotrophic lateral sclerosis, Huntington's disease, Parkinson's disease, Alzheimer's disease, bipolar disorder, depression, disruptive behavior disorder, dyslexia, fragile X syndrome, learning disabilities, obsessive-compulsive disorder, oppositional defiant disorder, pervasive developmental disorder, reactive attachment disorder, Rett syndrome, separation anxiety disorder, Tourette's syndrome, amyotrophic lateral sclerosis Lewy Body dementia, AIDS dementia, mild cognitive impairments, age-associated memory impairments, cognitive impairments and/or dementia associated with neurologic and/or psychiatric conditions, including epilepsy, brain tumors, brain lesions, multiple sclerosis, Down's syndrome, progressive supranuclear palsy, frontal lobe syndrome, and schizophrenia and related psychiatric disorders, cognitive impairments caused by traumatic brain injury, post coronary artery by-pass graft surgery, electroconvulsive shock therapy, and chemotherapy; and to novel methods for treating and preventing delirium, myasthenia gravis, dyslexia, mania, depression, apathy, myopathy associated with diabetes, Juvenile Huntington's Disease, also known as the Westphal variant, cerebral palsy, Spinocerebellar ataxia, Sensory ataxia, and Friedreich's ataxia.

7. The method of claim 4 wherein said inflammatory disease is selected from a group consisting of asthma (including allergen-induced asthmatic reactions), cystic fibrosis, bronchitis (including chronic bronchitis), chronic obstructive pulmonary disease (COPD), adult respiratory distress syndrome (ARDS), chronic pulmonary inflammation, rhinitis and upper respiratory tract inflammatory disorders (URID), ventilator induced lung injury, silicosis, pulmonary sarcoidosis, idiopathic pulmonary fibrosis, bronchopulmonary dysplasia, arthritis, e.g. rheumatoid arthritis, osteoarthritis, infectious arthritis, psoriatic arthritis, traumatic arthritis, rubella arthritis, Reiter's syndrome, valve diseases, tuberous sclerosis, scleroderma, obesity, metabolic disturbances associated with obesity, transplantation rejection, osteoarthritis, rheumatoid arthritis, neoplasm; adenocarcinoma, lymphoma, uterus cancer, fertility, glomerulonephritis, hemophilia, hypercoagulation, idiopathic thrombocytopenic purpura, graft versus host disease, AIDS, bronchial asthma, lupus, multiple sclerosis, gouty arthritis and prosthetic joint failure, gout, acute synovitis, spondylitis and non-articular inflammatory conditions, e.g. herniated/ruptured/prolapsed intervertebral disk syndrome, bursitis, tendonitis, tenosynovitic, fibromyalgic syndrome and other inflammatory conditions associated with ligamentous sprain and regional musculoskeletal strain, inflammatory disorders of the gastrointestinal tract, e.g. ulcerative colitis, diverticulitis, cardiomyopathy, atherosclerosis, stenosis, vascular calcification, fibrosis, pulmonary stenosis, subaortic stenosis, Crohn's disease; inflammatory bowel disease, ulcerative colitis, multiple sclerosis, treatment of Albright Hereditary, infectious disease, anorexia, cancer-associated cachexia, cancer, Crohn's disease, inflammatory bowel diseases, irritable bowel syndrome and gastritis, multiple sclerosis, systemic lupus erythematosus, scleroderma, autoimmune exocrinopathy, autoimmune encephalomyelitis, diabetes, tumor angiogenesis and metastasis, cancer including carcinoma of the breast, colon, rectum, lung, kidney, ovary, stomach, uterus, pancreas, liver, oral, laryngeal and prosiate, meianoma, acute and chronic leukemia, periodontal disease, neurodegenerative disease, Alzheimer's disease, Parkinson's disease, epilepsy, muscle degeneration, inguinal hernia, retinal degeneration, diabetic retinopathy, macular degeneration, ocular inflammation, bone resorption diseases, osteoporosis, osteopetrosis, graft vs. host reaction, allograft rejections, sepsis, endotoxemia, toxic shock syndrome, tuberculosis, usual interstitial and cryptogenic organizing pneumonia, bacterial meningitis, systemic cachexia, cachexia secondary to infection or malignancy, cachexia secondary to acquired immune deficiency syndrome (AIDS), malaria, leprosy, leishmaniasis, Lyme disease, glomerulonephritis, glomerulosclerosis, renal fibrosis, liver fibrosis, pancreatitis, hepatitis, endometriosis, pain, e.g. that associated with inflammation and/or trauma, inflammatory diseases of the skin, e.g. dermatitis, dermatosis, skin ulcers, psoriasis, eczema, systemic vasculitis, vascular dementia, thrombosis, atherosclerosis, restenosis, reperfusion injury, plaque calcification, myocarditis, aneurysm, stroke, pulmonary hypertension, left ventricular remodeling and heart failure.

8. The method of claim 1 wherein said allogeneic stem cell therapy consists of cord blood.

9. The method of claim 1, wherein said stem cell therapy consists of administration of cells selected from a group comprising of stem cells, committed progenitor cells, and differentiated cells.

10. The method of claim 9, wherein said stem cells are selected from a group consisting of: embryonic stem cells, cord blood stem cells, placental stem cells, bone marrow stem cells, amniotic fluid stem cells, neuronal stem cells, circulating peripheral blood stem cells, mesenchymal stem cells, germinal stem cells, adipose tissue derived stem cells, exfoliated teeth derived stem cells, hair follicle stem cells, dermal stem cells, parthenogenically derived stem cells, reprogrammed stem cells and side population stem cells.

11. The method of claim 10, wherein said embryonic stem cells are totipotent.

12. The method of claim 11, wherein said embryonic stem cells express one or more antigens selected from a group consisting of: stage-specific embryonic antigens (SSEA) 3, SSEA 4, Tra-1-60 and Tra-1-81, Oct-3/4, Cripto, gastrin-releasing peptide (GRP) receptor, podocalyxin-like protein (PODXL), Rex-1, GCTM-2, Nanog, and human telomerase reverse transcriptase (hTERT).

13. The method of claim 10, wherein said cord blood stem cells are multipotent and capable of differentiating into endothelial, muscle, and neuronal cells.

14. The method of claim 4, wherein said cord blood stem cells are identified based on expression of one or more antigens selected from a group comprising: SSEA-3, SSEA-4, CD9, CD34, c-kit, OCT-4, Nanog, and CXCR-4.

15. The method of claim 10, wherein said cord blood stem cells are unrestricted somatic stem cells.

16. The method of claim 14, wherein said cord blood stem cells do not express one or more markers selected from a group consisting of: CD3, CD45, and CD11b.

17. The method of claim 10, wherein said placental stem cells are isolated from the placental structure.

18. The method of claim 17, wherein said placental stem cells are identified based on expression of one or more antigens selected from a group comprising: Oct-4, Rex-1, CD9, CD13, CD29, CD44, CD166, CD90, CD105, SH-3, SH-4, TRA-1-60, TRA-1-81, SSEA-4 and Sox-2.

19. The method of claim 10, wherein said bone marrow stem cells consist of bone marrow mononuclear cells.

20. The method of claim 19, wherein said bone marrow stem cells are selected based on the ability to differentiate into one or more of the following cell types: endothelial cells, muscle cells, and neuronal cells.

21-149. (canceled)
